(19) United States
(12) Patent Application Publication
(10) Pub. No.: US 2001/0056395 A1
(43) Pub. Date: Dec. 27, 2001

(54) Internet bargaining system

(76) Inventor: Saadat H. Khan, Chatham, NJ (US)

Correspondence Address: Ernest D. Buff, Ernest D. Buff & Associates, LLC, 245 South Street, Morristown, NJ, 07960, US

(21) Appl. No.: 09/864,043

(22) Filed: May 23, 2001

Related U.S. Application Data
(60) Provisional application No. 60/210,860, filed on Jun. 9, 2000.
(60) Provisional application No. 60/244,341, filed on Oct. 30, 2000.

(51) Int. Cl. G06F 17/60

(52) U.S. Cl. 705/37; 705/14; 705/39

(57) ABSTRACT

An electronic bargaining system enables buyers to bargain with the system in order to negotiate an optimum bargain price; and enables sellers to sell or list their products by bargaining with the system to negotiate the best-offered price. The system permits purchase and sale of goods to be transacted at a bargained for price that represents the best bargain obtained by the parties. A bargained for price for transactions consummated by the electronic bargaining system is reached by the parties in a highly reliable manner. Principal attributes of that bargained for price are those captured by the characterization: “Our Best Bargain, Your Best Bargain”.

### BACKGROUND OF THE INVENTION

1. Field of the Invention

The present invention relates to electronic commerce applications that utilize digital and analog networks; and, more particularly, to a method and system for conducting electronic commerce over the Internet.

2. Description of the Prior Art

Computerized marketplaces are enjoying widespread use. These marketplaces have been successfully run domestically and in many foreign countries. Computerized markets range from simple classified ad, bulletin boards to complex mainframe-based market systems, such as NASDAQ, which provides a real-time market-making system for tens of thousands of securities brokers. Modern stock, bond and commodity exchanges are supported by computerized databases and related background systems that enable them to function.

Typically, electronic Exchanges are designed to facilitate commercial transactions involving tokens of ownership, such as shares of stock or physical objects such as cars, gold and the like. Other Exchanges specialize in the sale of information stored on databases that require payment of access fees to content providers for proscribed content downloaded by the user. Still other Exchanges provide matching services for parties seeking an efficient way to find each other. An example of matching services provided by an Exchange of this kind are the services afforded by a dating service or a job bank.

Exchanges can also function to support a market place for the buying and selling of consulting services. These types of Exchanges support a form of activity that is appointed to take place in the future. The Exchange serves as a structured meeting ground for the negotiation of the service to be provided. During operation of these types of systems, both parties must disclose their identities to each other. When trading is imminent, one party simply contacts the other directly and privately, without the Exchange's knowledge, thereby avoiding any costs, which might otherwise have been assessed by the Exchange.

Working expert exchange marketplaces, whether they are physical or electronic, require a complete and highly specialized set of conditions in order to function and thrive. Certain ingredients or features of service, if missing, can result in a shortage of either buyer or seller or lead to the collapse of the Exchange. Sufficient qualification of each is clearly needed for continued operation. At the same time, the Exchange must be able to ensure that income derived from the commerce of its activities is sufficient to cover operating costs and sustain profitability.

Exchanges should also provide sufficient motivation to ensure that significant numbers of buyers and sellers use the exchange in lieu of other available market place alternatives. Several factors, if present, would motivate buyers and sellers to use an exchange: (i) there must exist a high expectation of the usefulness of the Exchange that makes the user willing to take the time and effort to learn the rules of the exchange; (ii) buyers and sellers should be able to locate each other on the exchange at exactly the right time and place; (iii) a buyer and a seller should be able to quickly and easily negotiate transaction terms; (iv) buyers and sellers must reach a complete and final agreement in which the expectations of the parities are well defined; (v) there must exist an arrangement for acceptable credit terms; (vi) a mechanism should be provided for delivery of the goods or services called for by the agreement; (vii) there must exist a mechanism to deliver payment when the agreement is fulfilled; (viii) buyers and sellers must be able to rely on the Exchange to enforce agreements made on the Exchange with certainty of payment and legal recourse; transaction fees must be reasonable in comparison to alternatives; buyers and sellers should enjoy ready access to the market without levels of knowledge and cost of hardware commensurate with the value of the goods or services sold on the Exchange.

Traditional real world commerce in expertise or consulting services strongly favors circumstances where both parties are in the same place at the same time and can see one another. When there is no face-to-face contact and the parties instead rely on mail, phone, faxes etc., significant burdens and costs are imposed. These burdens and costs reduce the likelihood that expert commerce will take place. This is especially true if the parties are located in countries with different languages, customs, legal systems, currencies etc. Each added burden dramatically reduces the chances for agreement and makes it more difficult to satisfy all of the previously noted infrastructure conditions. If one or both of the parties in an online transaction is a private-party with no established organization or commercial resources, the difficulties heretofore discussed tend to increase.

Notwithstanding the problems faced in this field, the twenty-first century demand for worldwide commerce and Exchange services is expected to increase dramatically. A myriad of businessmen, government officials, academics and ordinary consumers now interact with each other via online networks. Consequently, the demand for worldwide commerce and Exchange services is growing dramatically.

To exploit this potential growth, there is needed a universally accessible facilitating system. Such a system should be especially designed to process the purchase and sale of goods and services in an effective, smartly structured manner. It must be thorough and cover aspects of an arms-length bargain not present when goods and services are electronically purchased or sold in the conventional way.

Computerized stock markets seamlessly and effortlessly process transactions of billions of shares of equities, bonds and financial instruments every day. In like manner, there exists a need for a mechanism that facilitates purchase and sale of goods at an optimum price. Especially needed is a system wherein the buyer and seller need not see or meet each other; but can deal effectively through use of a structured, organized system that facilitates and supports the infrastructure needed for commercial transactions involving purchase and sale of goods.

### SUMMARY OF THE INVENTION

The present invention provides an electronic bargaining system that: (i) enables buyers to bargain with the system in order to negotiate an optimum bargain price; and (ii) enables sellers to sell or list their products by bargaining with the system to negotiate the best offered price. Advantageously, the system permits purchase and sale of goods to be transacted at a bargained for price that represents the best bargain obtained by the parties. That is to say, a bargained for price for transactions consummated by the electronic bargaining system is reached by the parties in a highly reliable manner. Principal attributes of that bargained for price are those captured by the characterization: “Our Best Bargain, Your Best Bargain”. Generally stated, the system apparatus comprises:

(i) a Business Controller unit adapted to process buyer requests and to initiate a bargain process structured to provide an optimum price for each of the buyer and the system, the Business Controller unit being further adapted to process seller requests and to initiate a bargain process structured to provide an optimum price offered to the seller by the system, said controller unit being connected with a database unit that searches the database to generate a search result, and processes the search results according to the buyer and seller request;

1. a database controller unit having all required databases such as payment database, billing database, buyer database, seller database, and product database; and

(iii) a transceiver disposed in communication with the Business Controller unit, for transmitting Business Controller generated responses to buyers and the sellers and receiving buyer and seller requests to initiate a bargain process.

### BRIEF DESCRIPTION OF DRAWINGS

The invention will be more fully understood and further advantages will become apparent when reference is had to the following detailed description and the accompanying drawings, in which:

FIG. 1 is a block diagram illustrating the functional components of the present Internet bargaining system, including Business Controller 2.0, database controller 3.0, buyer interface 5.0, and seller interface 6.0;

FIG. 2 is a block diagram illustrating the functional components of Business Controller 2.0;

FIG. 3 is a block diagram illustrating the functional components of database controller 3.0;

FIG. 4 is a block diagram illustrating the functional components of the network interface 4.1;

FIG. 5 is a block diagram illustrating the functional components of the buyer interface 5.0;

FIG. 6 is a block diagram illustrating the functional components of the seller interface 6.0;

FIG. BF1 is a flowchart illustrating a process by which buyer formulates buyer request 1.2;

FIG. BF2 is a flowchart illustrating a process wherein the initial processing of buyer request 1.2 and first response generation by Business Controller 2.0 is intentional;

FIG. BF3 is a flowchart illustrating an alternate process for buyer request processing;

FIG. BF4 is a flowchart illustrating a process for offline bargaining in which Business Controller 2.0 bargains with more than one buyer;

FIG. BF5 is a flowchart illustrating a bargain price generation process by Business Controller 2.0 during bargain negotiations with buyer;

FIG. SF1 is a flowchart illustrating a method wherein the seller registers himself with the Business Controller 2.0;

FIG. SF2 is a block diagram illustrating a process by which the seller submits product details;

FIG. SF3 is a flowchart illustrating a process by which Business Controller 2.0 performs the creation and initial processing of the seller request 1.4;

FIG. SF4 is a flowchart illustrating a process wherein the seller wishes to sell a product to Business Controller 2.0, or the seller wishes Business Controller 2.0 to place seller's product on sale;

FIG. SF5 is a block diagram illustrating the inquiry process used by the seller to inquire about the sale of a product;

FIG. BN1 is a block diagram illustrating a process by which buyer creates a profile and registers with the system online;

FIG. BN2 is a block diagram illustrating a process by which the buyer selects a product and creates a buyer request;

FIG. BN3 is a flowchart illustrating a process used by buyer to make his request to Business Controller 2.0 after selecting the product online, and a process by way of which Business Controller 2.0 initiates the bargain process;

FIG. BN4 is a flow chart illustrating the initial processing of buyer request 1.2 and first response generation by Business Controller 2.0;

FIG. BN5 is a flow chart illustrating the process of online bargaining between buyer and Business Controller 2.0;

FIG. BN6 is a flow chart illustrating a process of online bargaining in which Business Controller 2.0 bargains with more than one buyer;

FIG. BN7 is a flow chart illustrating a process wherein a continuous communications channel is established between the buyer and Business Controller 2.0 using a message window;

FIG. SN1 is a flow chart illustrating a method by which the seller registers himself with Business Controller 2.0;

FIG. SN2 is a flow chart illustrating a method by which the seller registers himself with Business Controller 2.0;

FIG. SN3 is a flow chart illustrating a process in which Business Controller 2.0 does the initial processing of the seller request 1.4;

FIG. SN4 is a flow chart illustrating the transactions involved when the seller wishes his product to be opened for sale;

FIG. SN5 is a flow chart illustrating the process by which the seller bargains with Business Controller 2.0 to get the best bargain price for the product, sells it to Business Controller 2.0 at step SN5.1, and provides the ID number for authorization at step SN5.2;

FIG. SN6 is a block diagram illustrating an embodiment in which the seller can inquire about the sale status of the product;

FIG. BB1 is a flowchart illustrating a bidding process in which the buyer bids for a product;

FIG. BB2 is a flowchart illustrating a method for processing a request created by the buyer;

FIG. BB3 is a flowchart illustrating an alternate form of bidding procedure;

FIG. BP1 is a block diagram depicting an embodiment of the billing and payment system in which the billing process is initiated;

FIG. BP2 is a block diagram depicting a process for paying the seller or vendor;

FIG. BP3 is a block diagram depicting a billing procedure using credit cards as a primary transaction tool;

FIG. BP4 is a block diagram depicting a billing procedure utilized when the amount to be paid to the seller has been calculated;

FIG. BP5 is a block diagram illustrating a payment procedure for billing buyer using standard bank checks;

FIG. BP6 is a block diagram illustrating a payment procedure for transmitting payment to seller involving standard bank checks;

FIG. BP7 is a block diagram illustrating a procedure in which funds are transferred via “EFT”;

FIG. BP8 is a block diagram illustrating a procedure in which funds are transferred to the seller via “EFT”;

FIG. BP9 is a block diagram depicting a procedure for billing the buyer using digital cash;

FIG. BP10 is a block diagram depicting a process for sending payment to the seller using digital cash;

FIG. CS1 is a flowchart illustrating a customer satisfaction embodiment, the elements of which include buyer complaint reviewing and follow-up procedures; and

FIG. CS2 is a flowchart illustrating the handling and processing of comments concerning the quality of products received by the buyer.

### DESCRIPTION OF THE PREFERRED EMBODIMENTS

The term “bargaining” as used herein means a process used by two or more parties to arrive at an agreement, which governs certain rights and duties between them. During the bargaining process, the negotiating parties give reasoning and incentives to convince the other party to come to terms. This whole process is referred to herein as bargaining. The end result is an agreement on which the parties execute accordingly.

Advantageously, the Internet bargaining system of the present invention affords new features and value-added services to the customers that have not heretofore been available. It fulfills a longstanding need for a buyer-driven bargaining system that enables the buyer to bargain for the price he wants. In addition, the system provides a seller-driven bargaining system that avoids sellers concerns about publicity and price of their product. That is to say, the system provides a unique Internet bargaining structure that proceeds on the basis of “our bargain price, your bargain price”.

In general, the Internet bargaining system provides the following services and features for the buyers and sellers.

The buyer is able to find bargains at a price most suitable to him. In use of the Internet bargaining system described above, it is unnecessary for the buyer or seller to see or meet each other. The system provides substantially all information about the product, and questions concerning the product are addressed. Buyers can contact the system at a convenient time using a variety of communication modes. Preferably a buyer uses a communication mode selected from the group consisting of on-line, off-line and real-time. Each of these communication modes will be described hereinafter in further detail. At the request of the Buyer, the system can provide assistance via prompts, pop-up messages and icons, thereby enabling Buyer to proceed with the bargaining process on his own. Assistance from a system consultant is also provided, upon Buyer request.

Sellers obtain a negotiated and best available price for their products. Substantially all bargains are negotiated by the buyers to obtain an optimum price for seller goods or services. In one embodiment, the system processes all the financial matters of the deal for the buyer and the seller. Sellers do not have to engage in the troublesome task of bargaining with single or multiple buyers. The system operates as an optimized and expert middleman between the buyer and the seller. Transactions can be negotiated and consummated on a real time basis or off line, on the basis of bargained for, mutually agreeable terms.

These features, in combination, provide an Internet bargaining system that is easy to use and enables bargaining to be carried out and bargains reached in an effective, cost efficient manner.

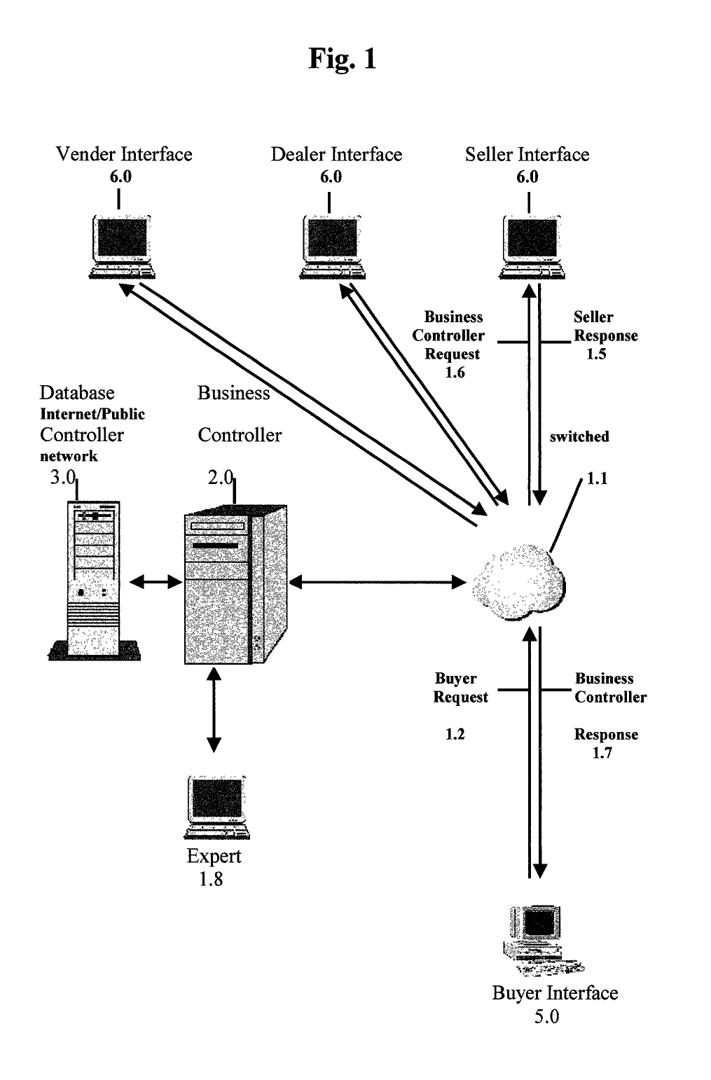

Referring to FIGS. 1-6 of the drawings, there is shown the method and apparatus of the present invention. In a preferred structure the system of the invention comprises: buyer interface 5.0, database controller 3.0 and an associated database. The system identifies the appropriate mode of bargain, supervises the bargain requests by the user, and processes those requests to produce appropriate bargain responses. Advantageously, in operation of the system, the buyer and seller can arrive at a suitable bargain price in a simple cost and time effective manner. The term “user” is herein intended to mean a buyer or seller that accesses the system to participate in a bargaining process, bench mark a product or service, or otherwise obtain information concerning products or services offered by the system.

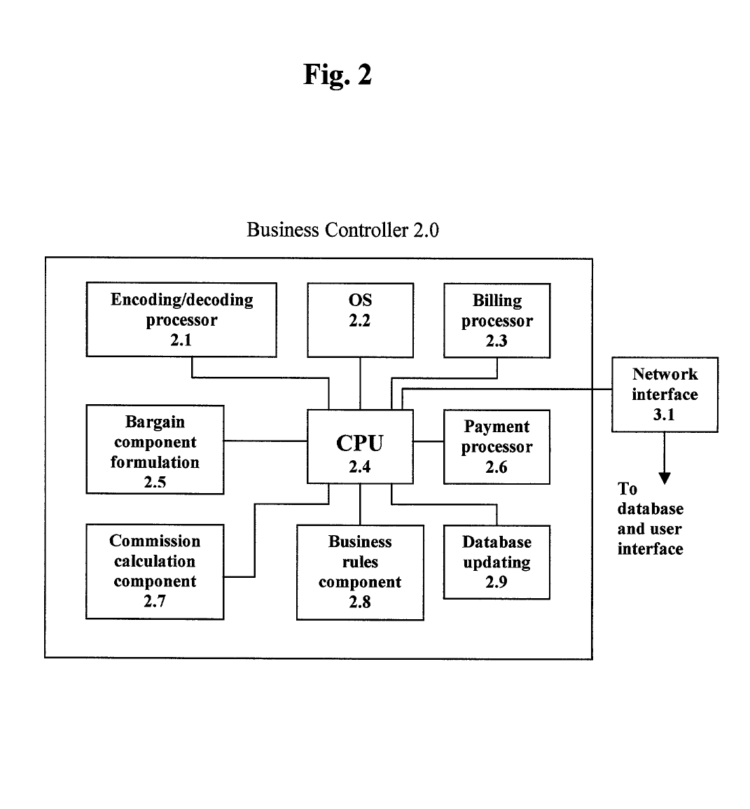

The system architecture for the preferred structure of the present Internet bargaining system is illustrated in FIGS. 2, 3, 5, and 6. Referring again to FIG. 1, the apparatus comprises Business Controller 2.0, database controller 3.0, buyer interface 5.0, seller interface 6.0, (collectively, the “nodes”) Each node is connected via an Internet connection using a public switched phone network 1.1, such as those provided by a local or regional telephone operating company. Connection can also be provided by dedicated Data lines, cellular phones, “personal communication system (PCS)”, wireless computer and hand-held devices, and microwave or satellite networks. Buyer interface 5.0 and seller interface 6.0 are used both as inputs and as output gateways for communications with Business Controller 2.0.

The method and apparatus of the invention utilizes these components to implement a unique bargaining system in which buyers and sellers can interact with a Business Controller 2.0 assigned expert to arrive at a price that optimally suits their demands. The assigned expert can comprise a system generated assistant, referred to herein as a “Bargain Guru”. It can also comprise a consultant, available on an on-line or off-line basis, to provide assistance or otherwise facilitate the bargaining process.

As illustrated by FIG. 2 of the drawings, Business Controller 2.0 includes central processor (CPU) 2.4, encoding/Decoding process 2.1, payment processor 2.6, Bargain formulation processor 2.5, Commission formulation processor 2.7, Business rules component 2.8, Operating system 2.2, and network interface 3.1. A conventional personal computer or workstation with sufficient memory and processing capability may be used as Business Controller 2.0. Alternatively, the Business Controller 2.0 can comprise a hand held wireless communication device such as a Palm Pilot®, WordPad® or the like.

In one embodiment, Business Controller 2.0 operates as a Web server, both receiving and transmitting data inquiries generated by buyers and sellers. Business Controller 2.0 must be capable of processing high volume transaction, performing a significant number of mathematical calculations in processing communications. A Pentium-II 300 MHz microprocessor commonly manufactured by Intel Inc. may be used for CPU 2.4. This processor employs a 32-bit architecture. Other processors suitable for use as CPU 2.4 include Motorola 120 MHZ PowerPC or Sun Microsystems SOLARIS.

Each of billing processor 2.3 and payment processor 2.6 can comprise a conventional microprocessor (such as Intel Pentium) supporting the transfer and exchange of payments, charges, or debits attending transactions processed. These processors may also be configured as part of CPU 2.4.

Processing of credit card transactions may be supported with commercially available software, such as the Secure Web server manufactured by Open Market Inc. This server software transmits credit card numbers electronically to the Open Market headquarters for card-processing verification. An Integrated Commerce Service at the Open Markert headquarters provides back-office services necessary to run Web-based businesses. The back-office services include online account statements, order-taking and credit card payment authorization, credit card settlement, automated sales tax calculations, digital receipt generation, and account based purchase tracking and payment aggregation for low priced services.

The bargain formulation processor 2.5 and the commission calculation processor 2.7 can comprise conventional microprocessors (such as Intel Pentium) that support mathematical processing of different bargain prices and calculation of commissions. A business rules component 2.8 can use this type of microprocessor for its functionality.

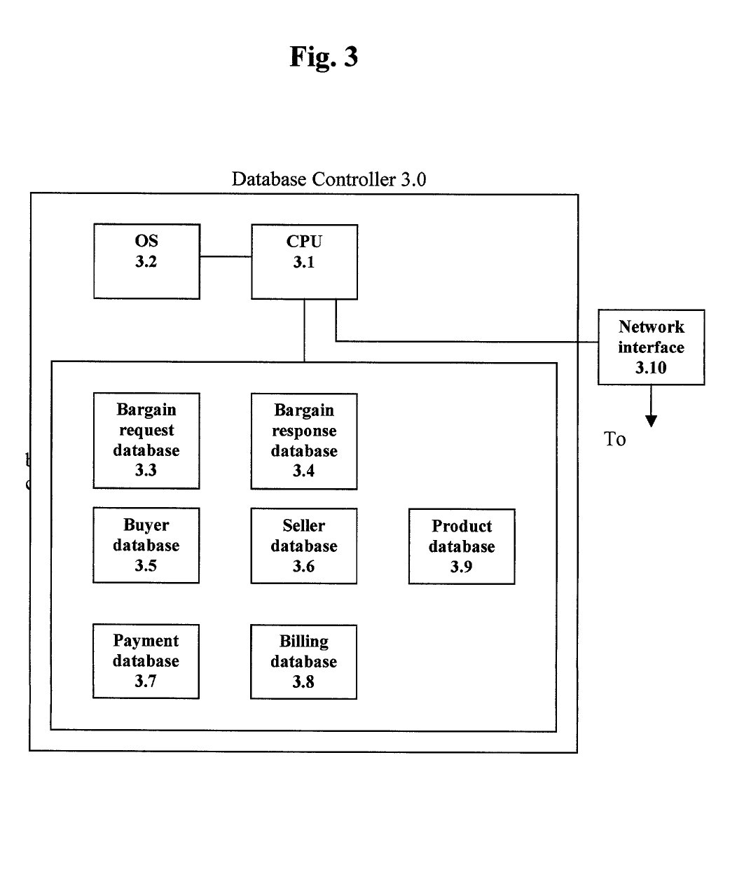

A database controller 3.0, shown in FIG. 3, comprises a conventional personal computer or computer workstation having sufficient memory and processing capability. In one embodiment, database controller 3.0 operates as a Database Server, both receiving and transmitting data inquiries generated by the Business Controller 2.0.

Fulfilling the high volume transaction processing and data queries required during operation of the Internet bargaining system requires a powerful microprocessor. A Pentium II 300 MHz microprocessor commonly manufactured by Intel Inc. can comprise CPU 3.1. Other equivalent microprocessors may also be used.

A data storage device of the type suitable for use with the invention generally includes magnetic storage devices such as fixed discs, and the like. These storage devices will be used for housing the databases used in the processing of transactions by the system. These databases include buyer database 3.5, seller database 3.6, product database 3.9, request database 3.3, response database 3.4, payment database 3.7, billing database 3.8, and audit database 3.10. In a preferred embodiment database software such as Oracle 8, manufactured by Oracle Corporation, is used to create and manage these databases.

Buyer database 3.5 maintains data on each buyer, including name, address, phone, E-mail, payment preference, language preference, product preference and the like. Seller database 3.6 maintains data on each seller such as name, address, phone, E-mail, language preference, past selling record, product ID, price range preference for sale of the product either as a single item or in bulk, or as a package deal, availability of the product, condition of the product, picture, if available, and the like. In addition, seller database 3.6 contains information about the product ID, and any advertising data of the product to be sold. The seller database 3.6 also holds information about bargain bids and the response generation by the system.

The Bargain request database 3.3 includes all buyer requests 1.2 received by Business Controller 2.0, indexed by product ID. A unique tracking number is also stored for each buyer request 3.3.

The bargain response database 3.4 contains all bargain responses issued by Business Controller 2.0. This database is indexed by the request tracking number. Bargain response database 3.4 also contains all the bargain prices issued by the Business Controller 2.0 in the bargaining process of a product.

Payment database 3.7 and billing database 3.8 track all commercial transactions, as well as payment and billing preferences and, optionally, shipping details and product tracking information. These databases are valuable in the event of inquiries by both buyer and seller so that an audit trail can be produced. Product database 3.9 maintains product ID and other details about the product.

Audit database 3.10 stores transactional information that may be retrieved for later analysis; for example, the buyers and sellers negotiations proceedings from chat rooms, or audit trails by the Business Controller 2.0 might be stored in this database so that buyer or seller inquiries concerning service or price, or the transaction history can be independently verified.

Network interface 4.1 provides a gateway for communication with buyers and sellers through a buyer interface and a seller interface, respectively. Conventional internal or external modems serve to provide the network interface. The modem is supported at a baud rate ranging from 28800 upwards, but may combine such inputs into a t1 or t3 line, if more bandwidth is required.

In a preferred embodiment, network interface 4.1 is connected with the Internet and/or any of the commercial Internet service providers, such as AOL, CompuServe, IBM, and the like. This allows both buyers and sellers to access the system from a wide range of online connections. As used herein, the term “connection” means a conventional wired connection as would be provided by a modem and telephone line or, alternatively, a wireless connection, such as that provided by a wireless modem, cell phone or the like. Several commercial e-mail servers include the above functionality. Outlook Express, an electronic mail software package manufactured by Microsoft Corporation, is designed to link people and information over enterprise networks and the Internet. Any other plat-independent e-mail, secure server-based software that uses open standards based on Internet protocols can be used. Buyers and sellers can exchange messages with files, graphics, video and audio. The system should support multiple languages.

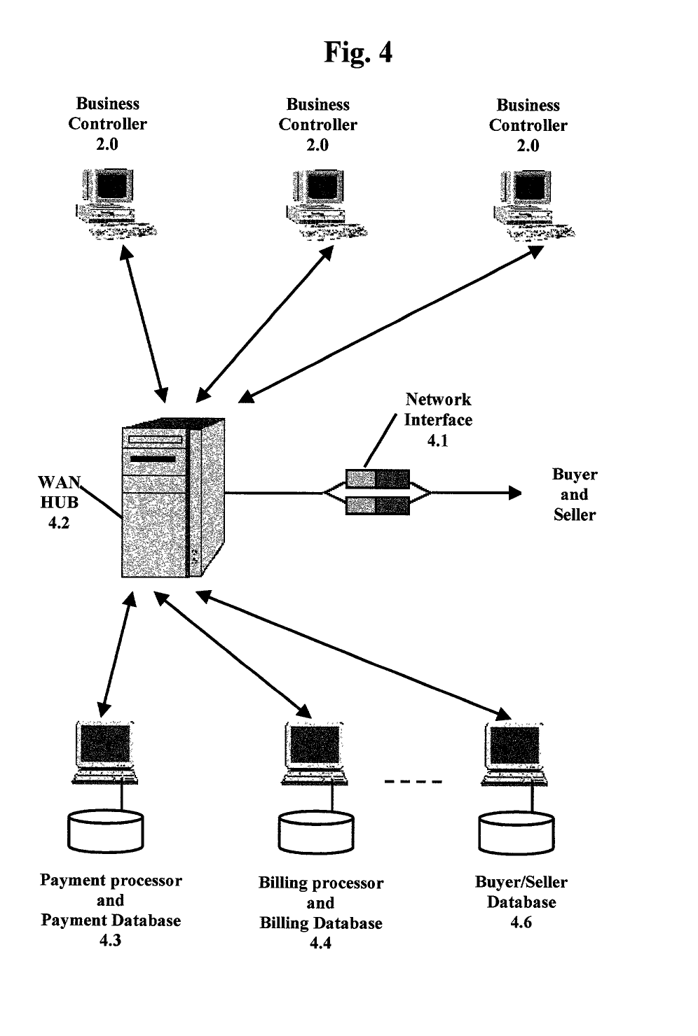

Although the foregoing embodiment describes a single computer acting as the Business Controller, it will be readily appreciated by those skilled in the art that the functionality can be distributed over a plurality of computers. In another embodiment the Business Controller 2.0 and the database controller 3.0 are configured in a distributed architecture, shown by FIG. 4, wherein the database and processor components are housed in separate units or locations. Business Controller 2.0 components perform the primary processing functions and contain at a minimum RAM, ROM and a general processor. Each of these controllers is attached to WAN HUB 4.2 that serves as the primary communication link with the other devices WAN hub 4.2 may have minimal processing capability itself, serving primarily as a communications router.

Although a limited number of controllers are shown in this embodiment those skilled in the art will appreciate that an almost unlimited number of controllers may be supported. In such configuration, each controller is in communication with its constituent port, but standalone units perform the processor and/or data storage functions.

Payment processor and database 4.3, billing processor and database 4.4, and buyer/seller database 4.6 communicate through WAN Hub 4.2 with controllers 4.7 through 4.9. With this arrangement, the system is more flexible and dynamic, and less vulnerable to catastrophic hardware failures.

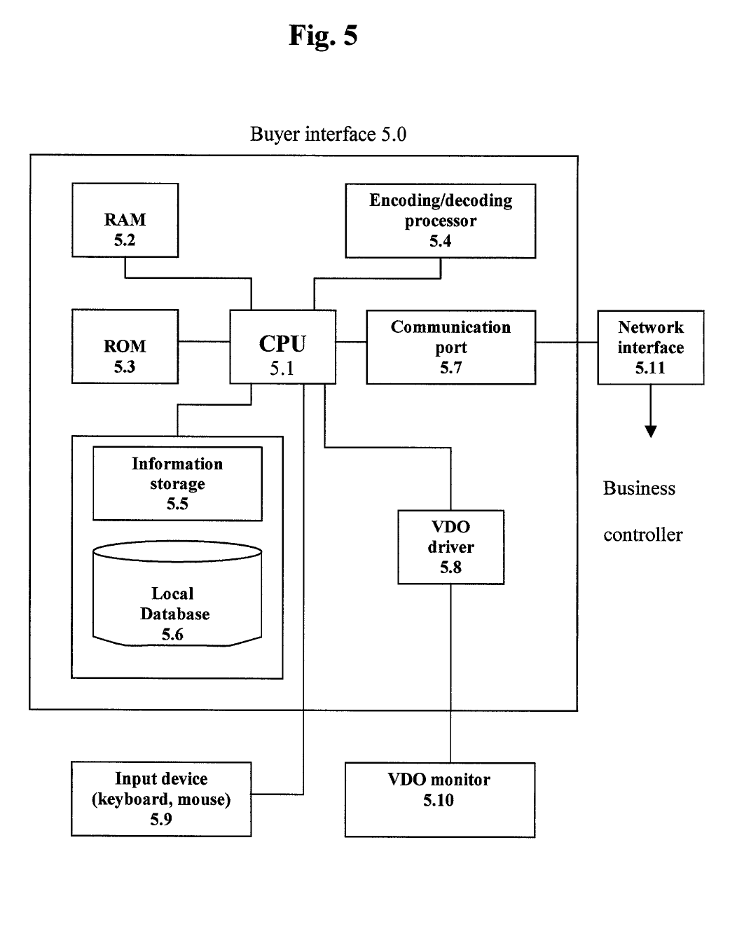

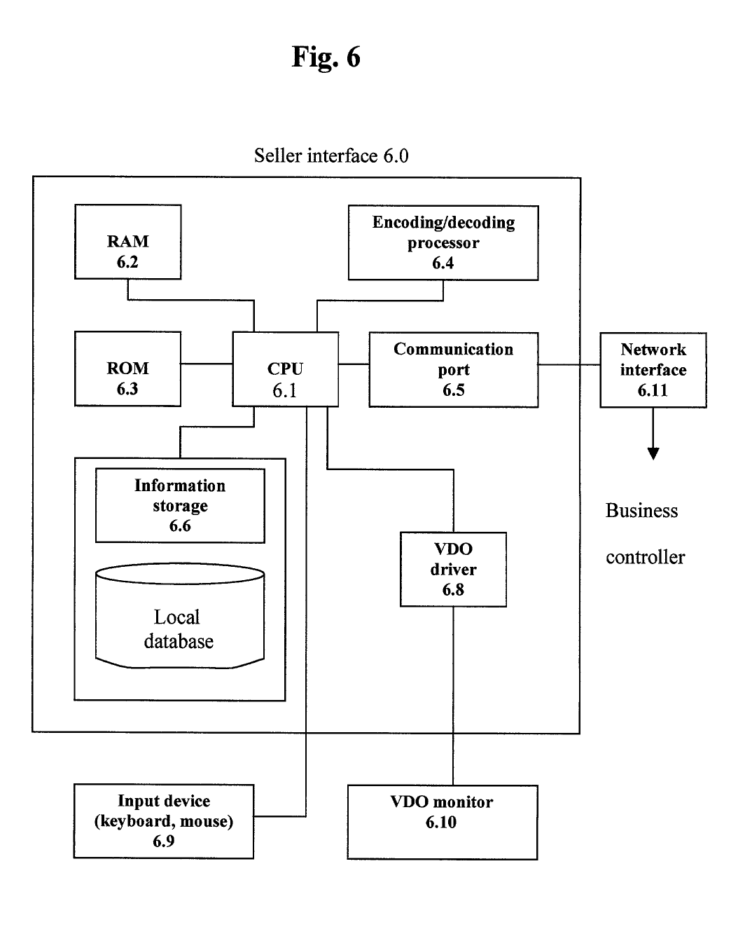

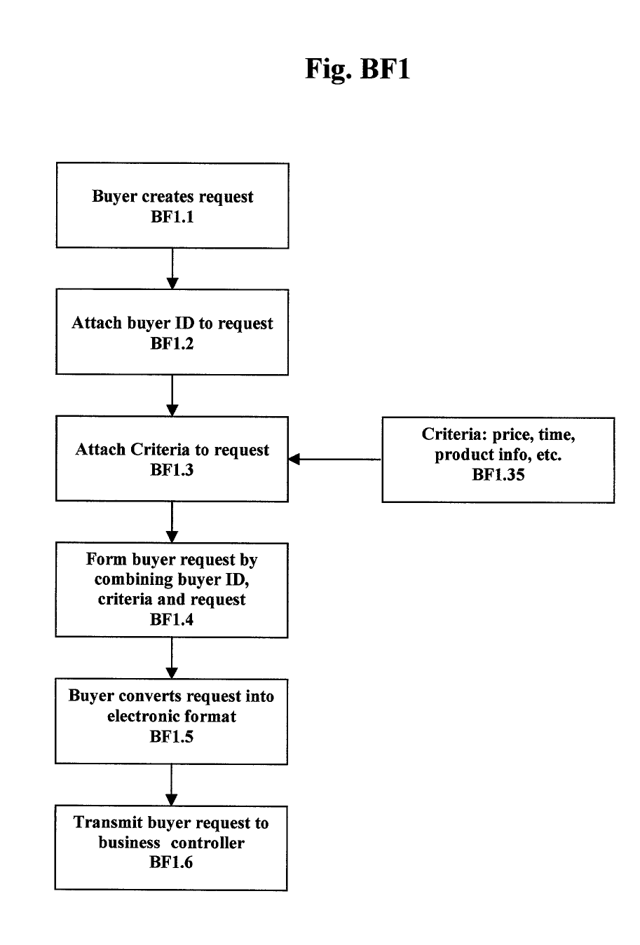

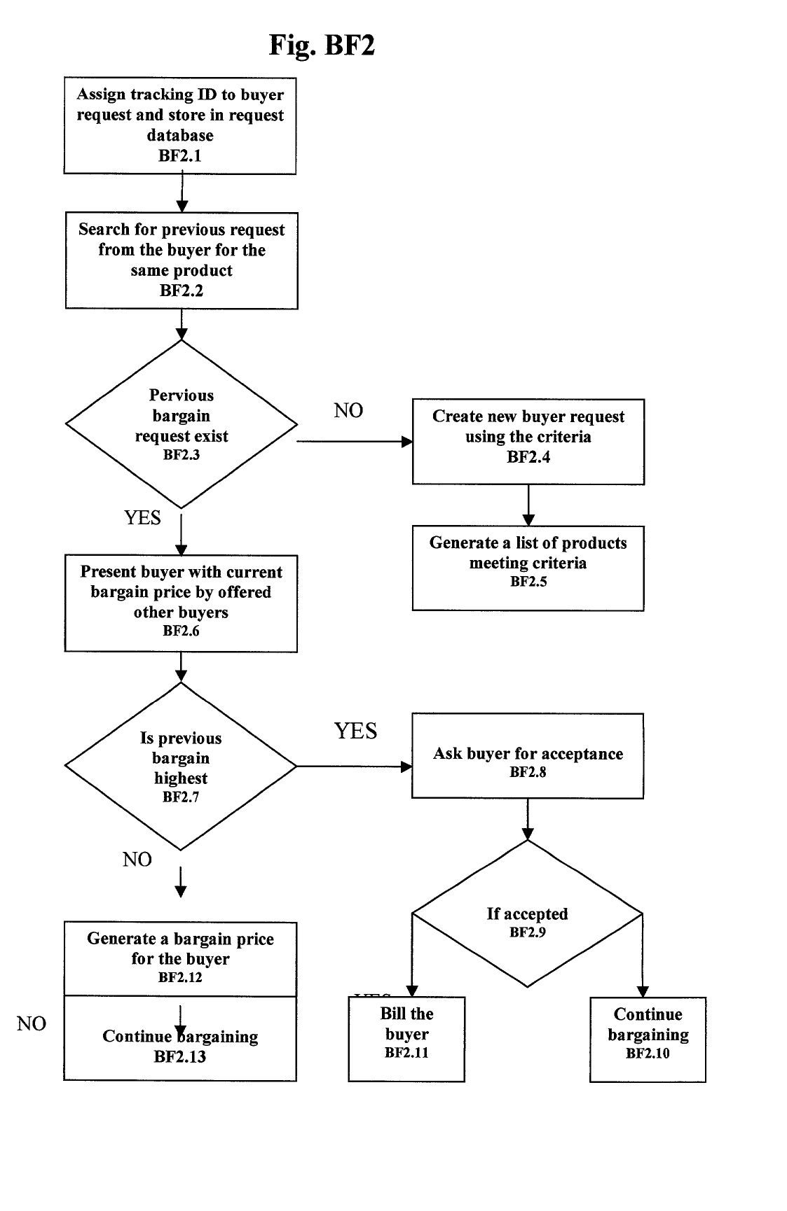

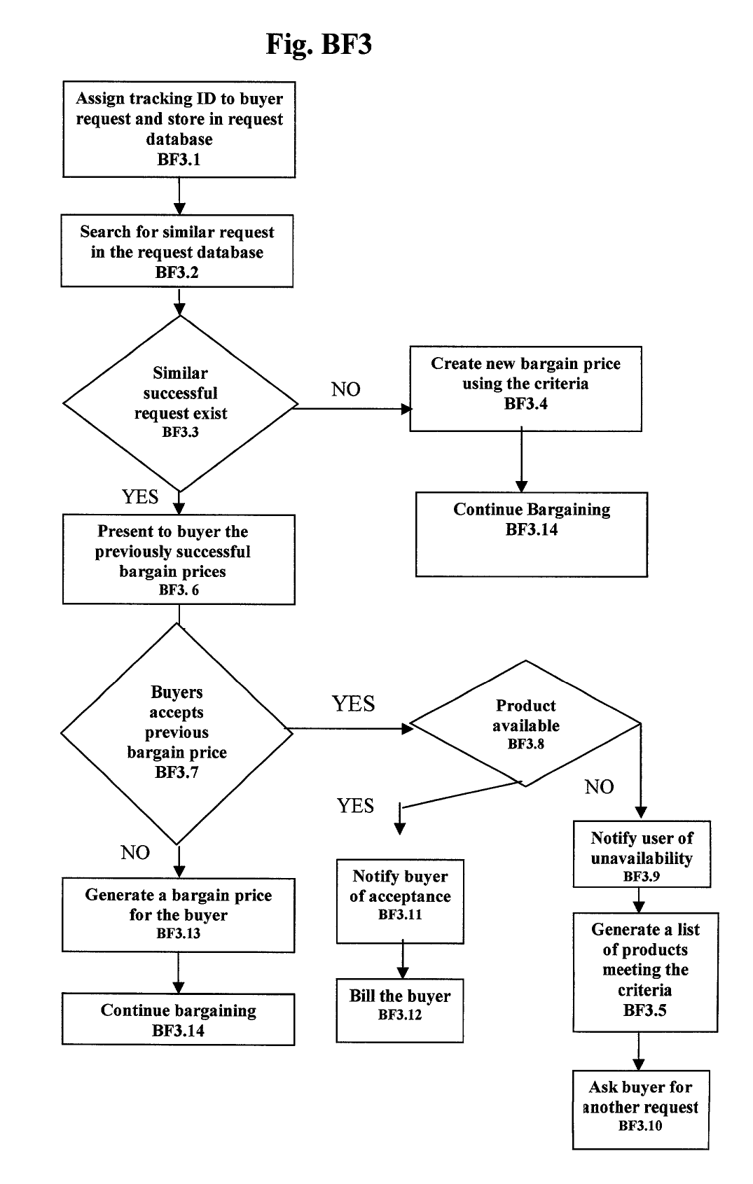

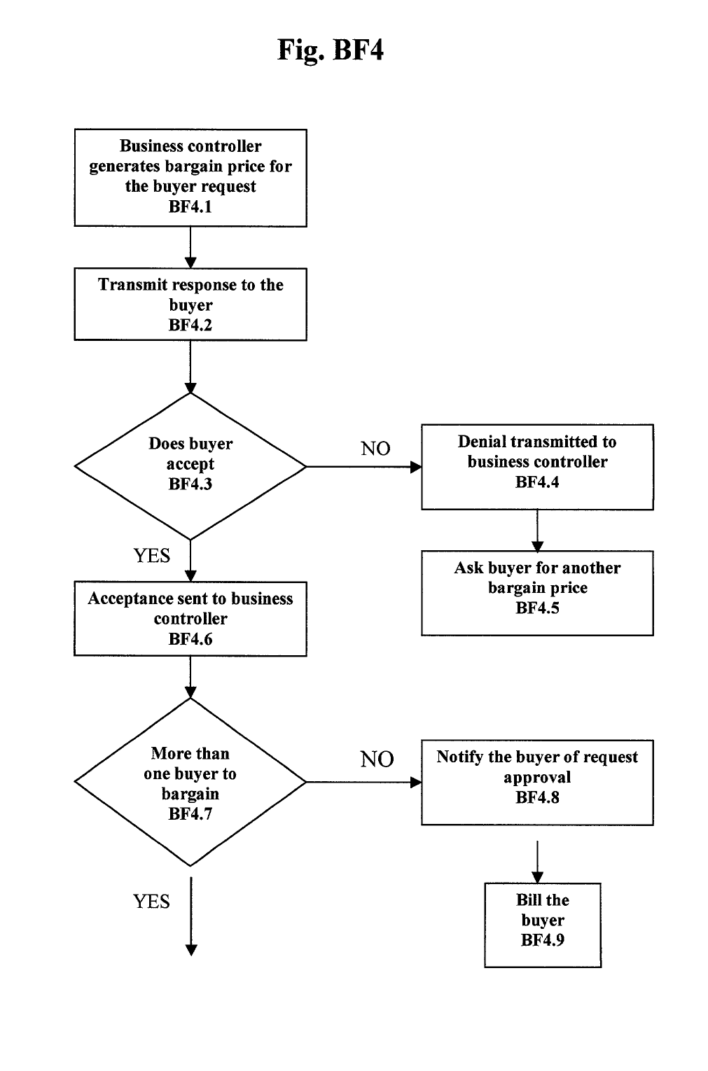

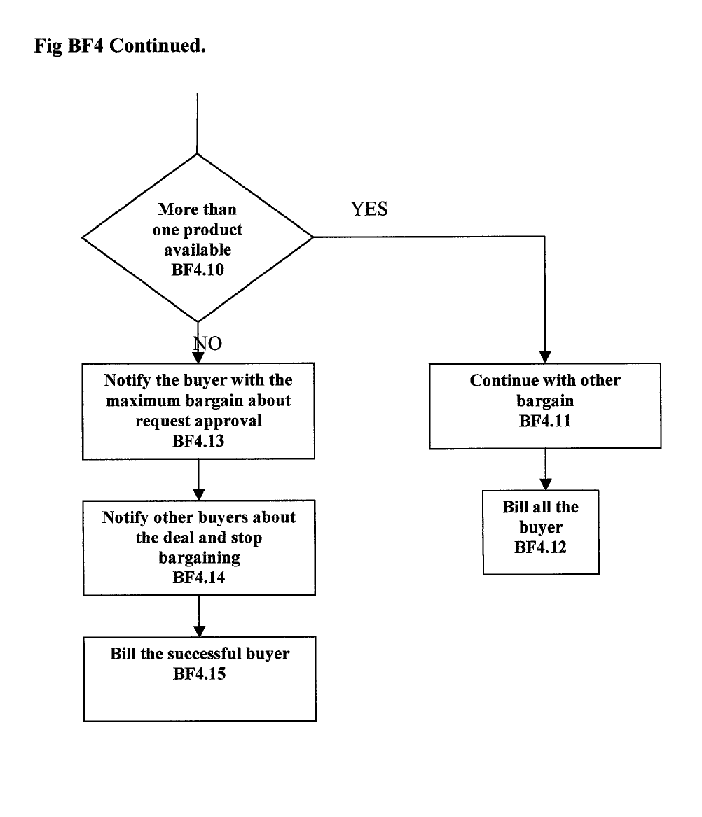

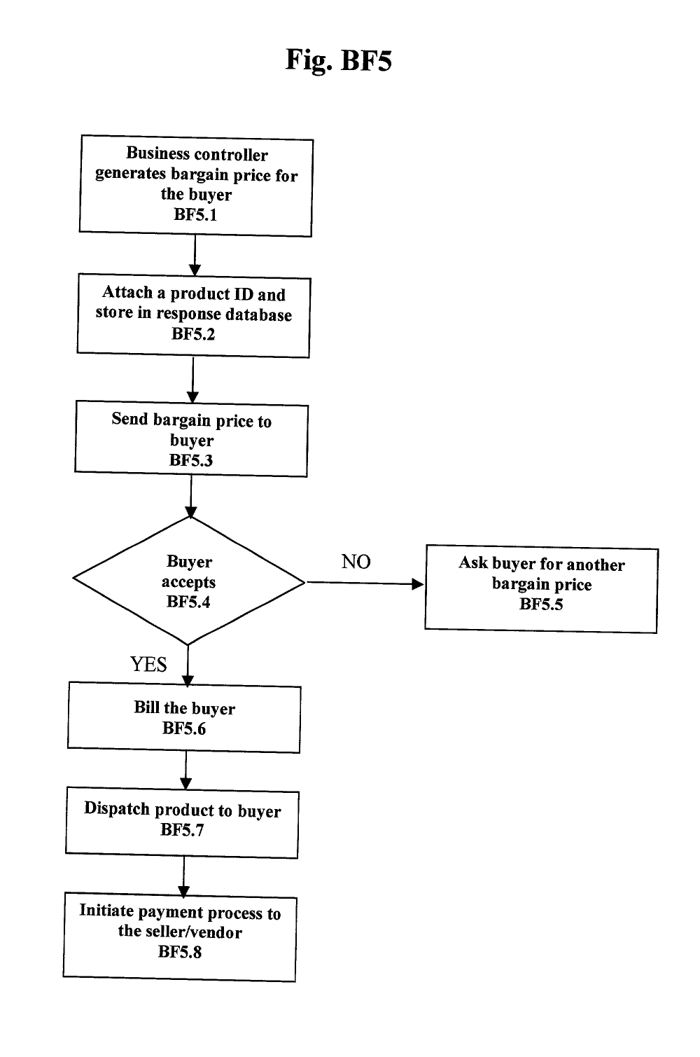

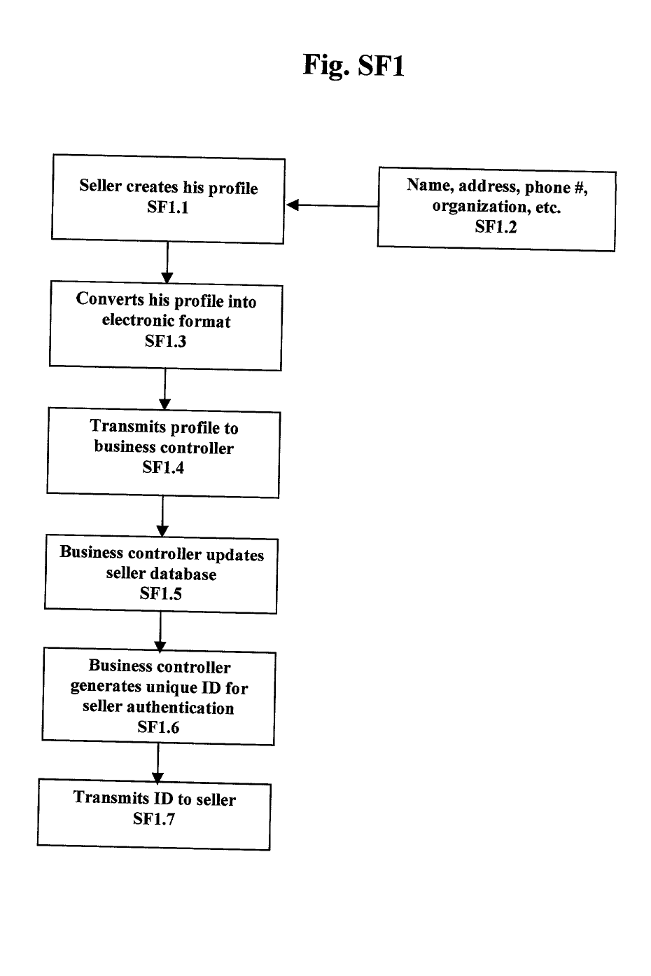

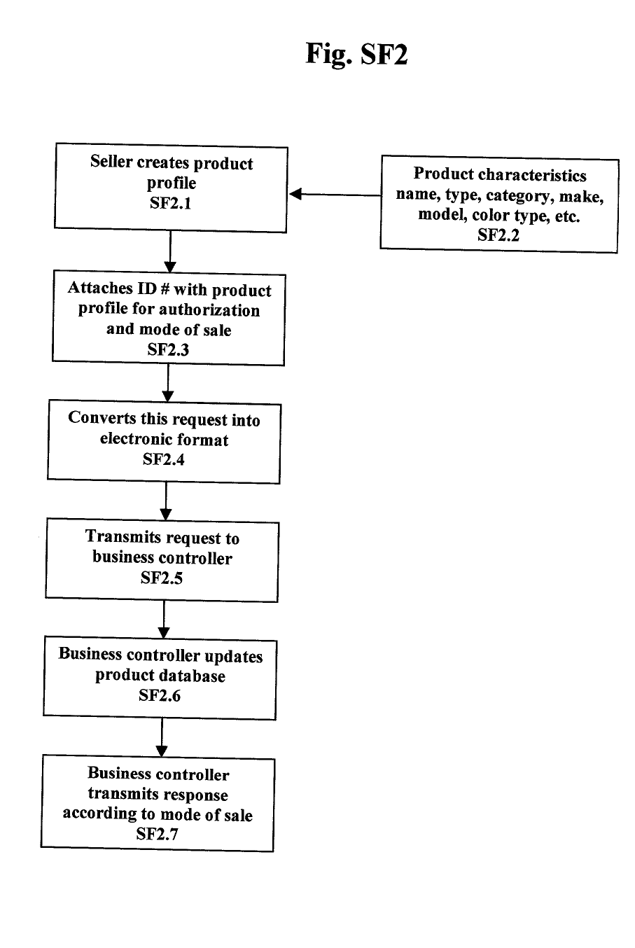

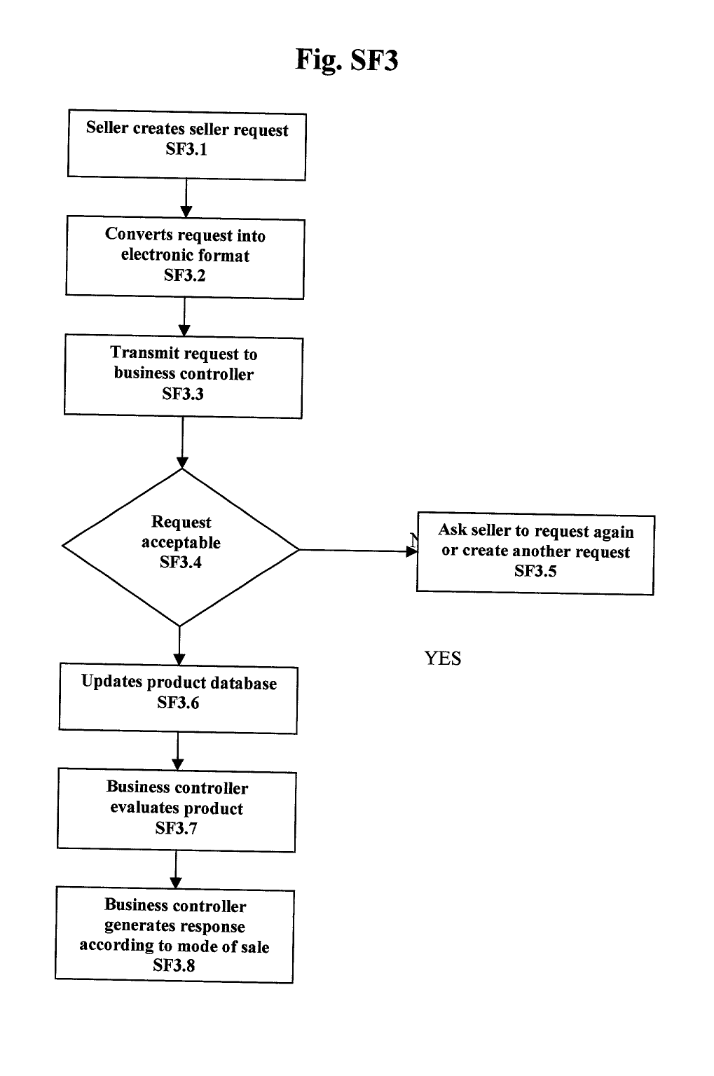

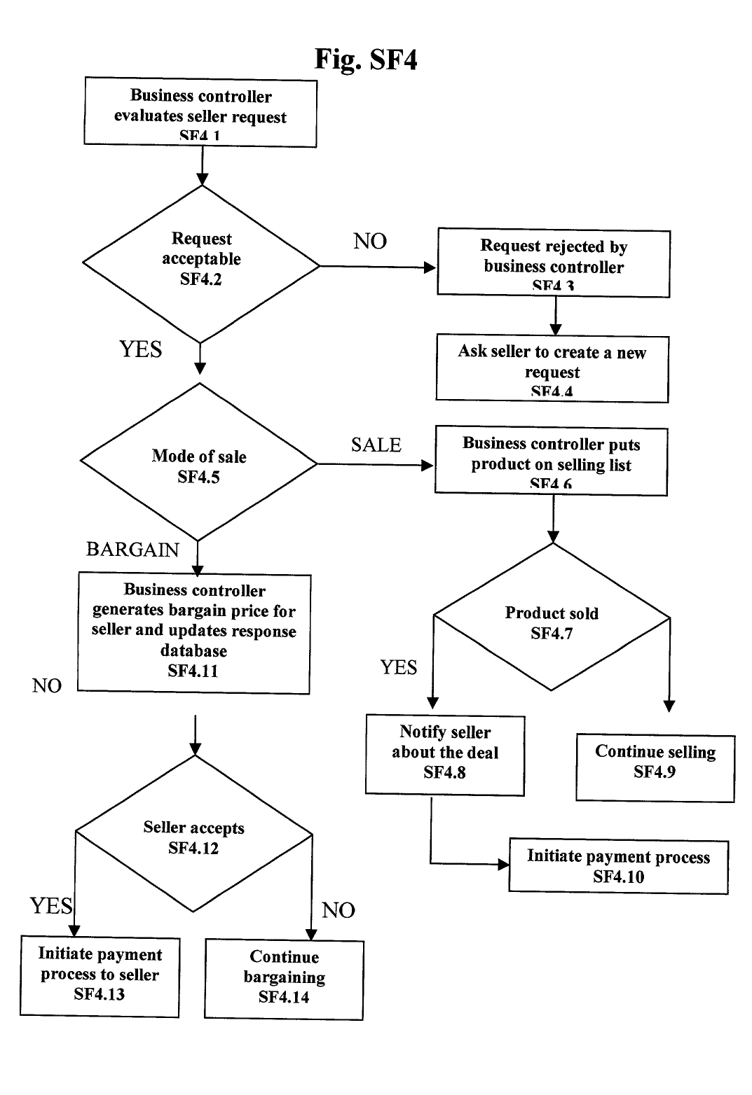

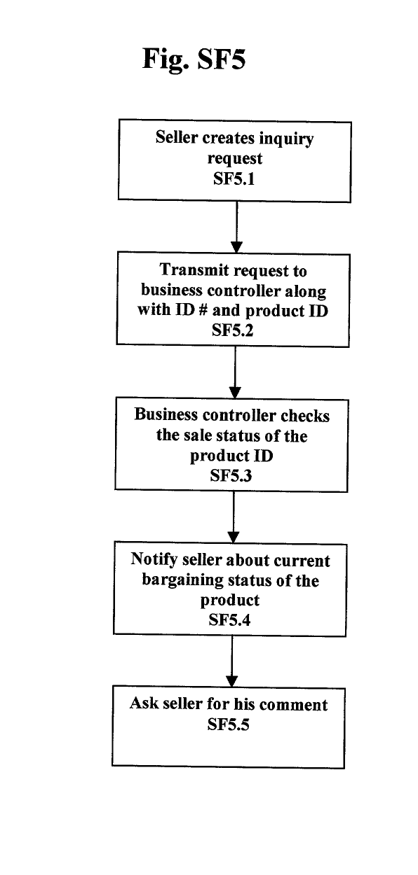

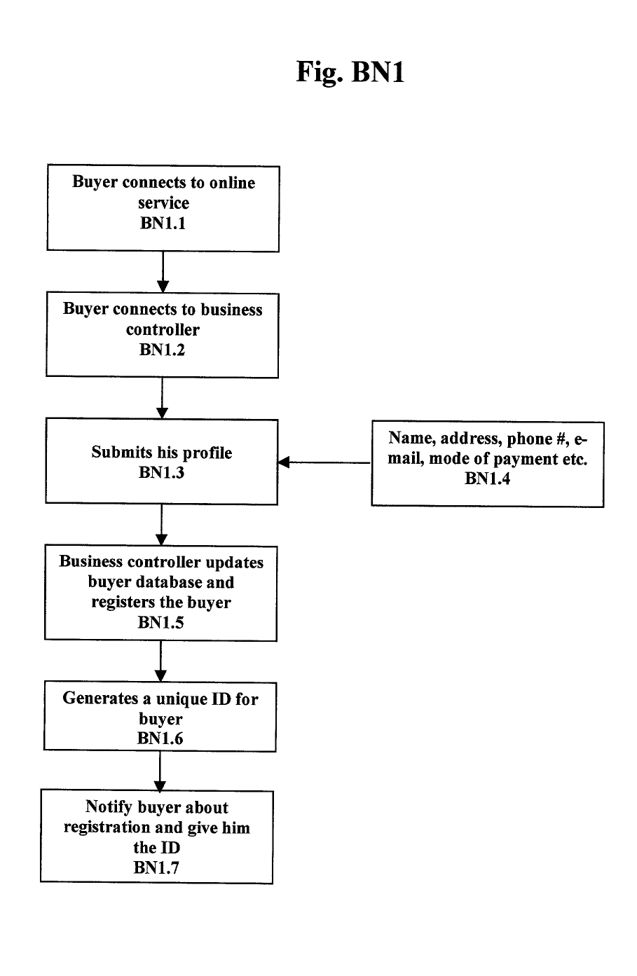

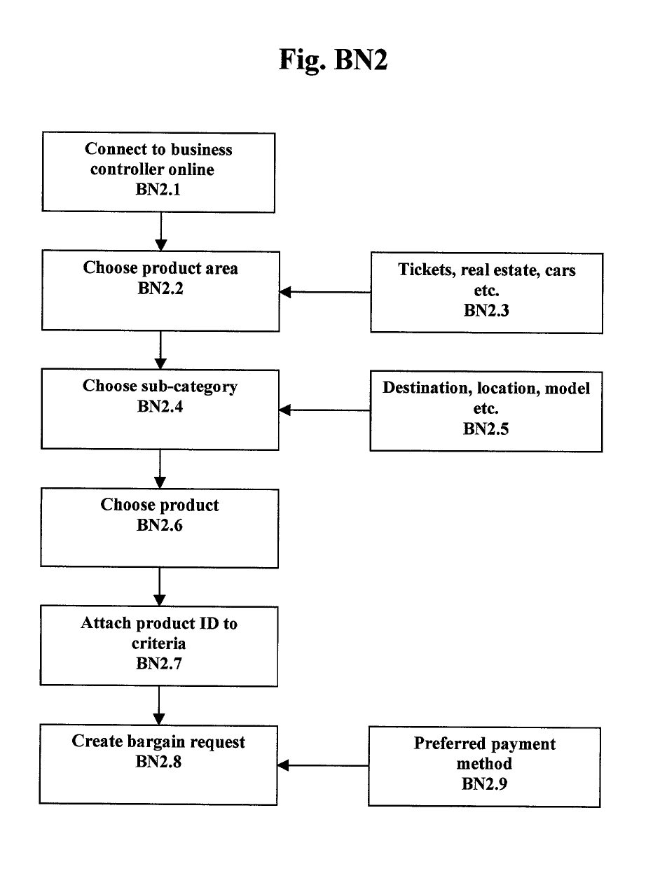

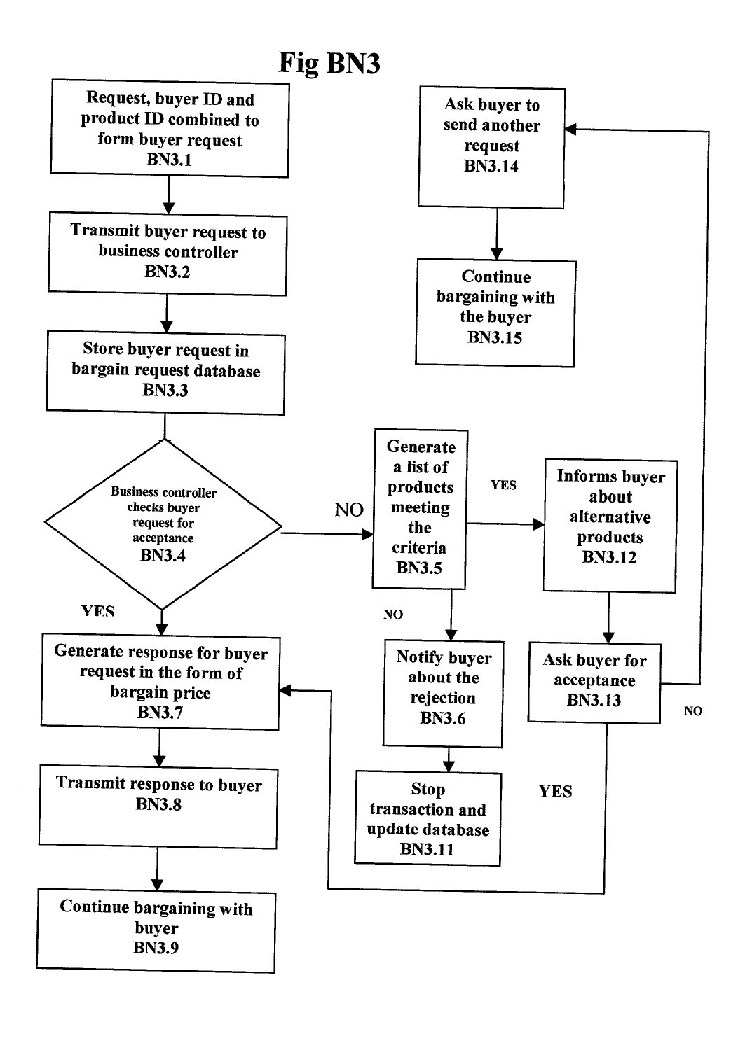

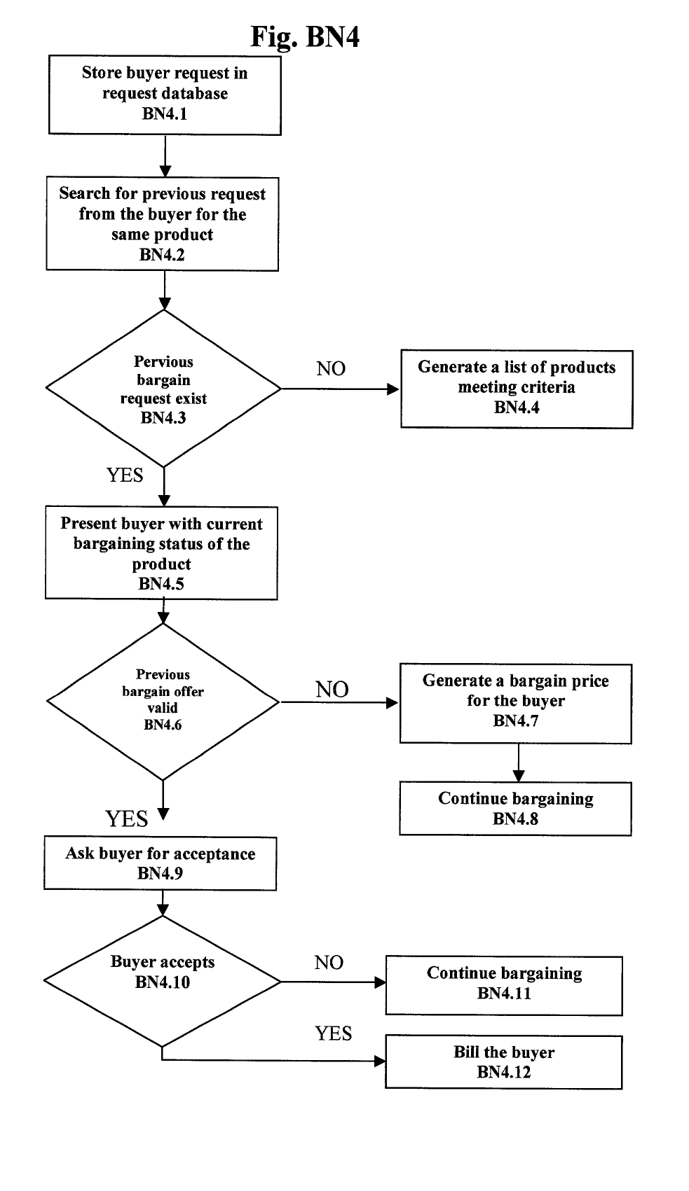

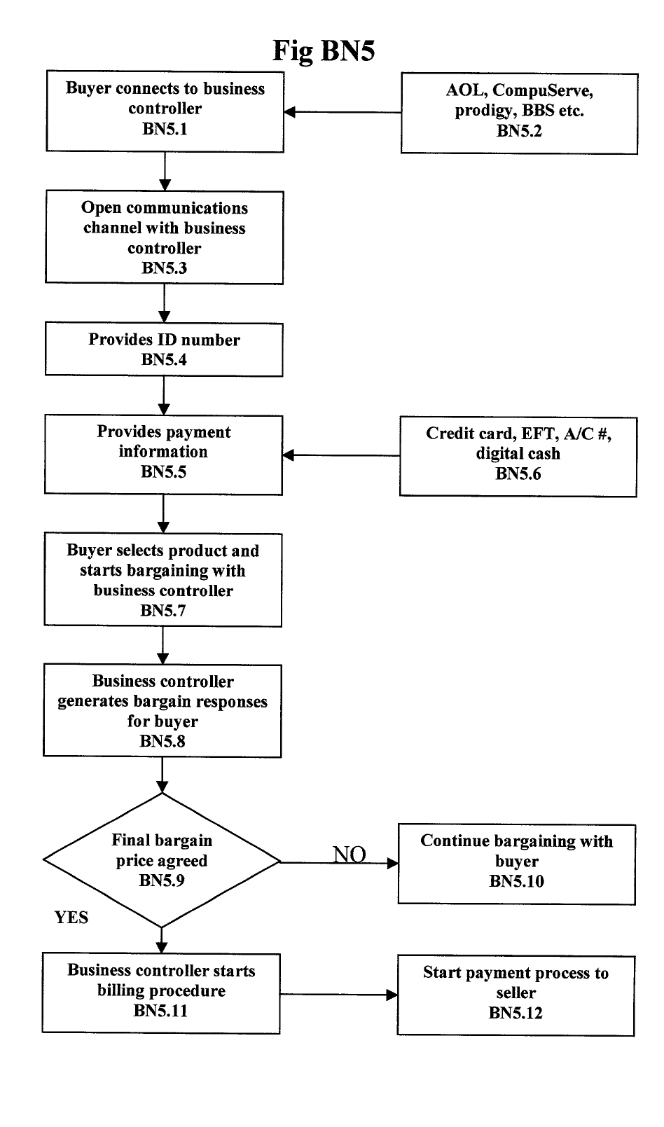

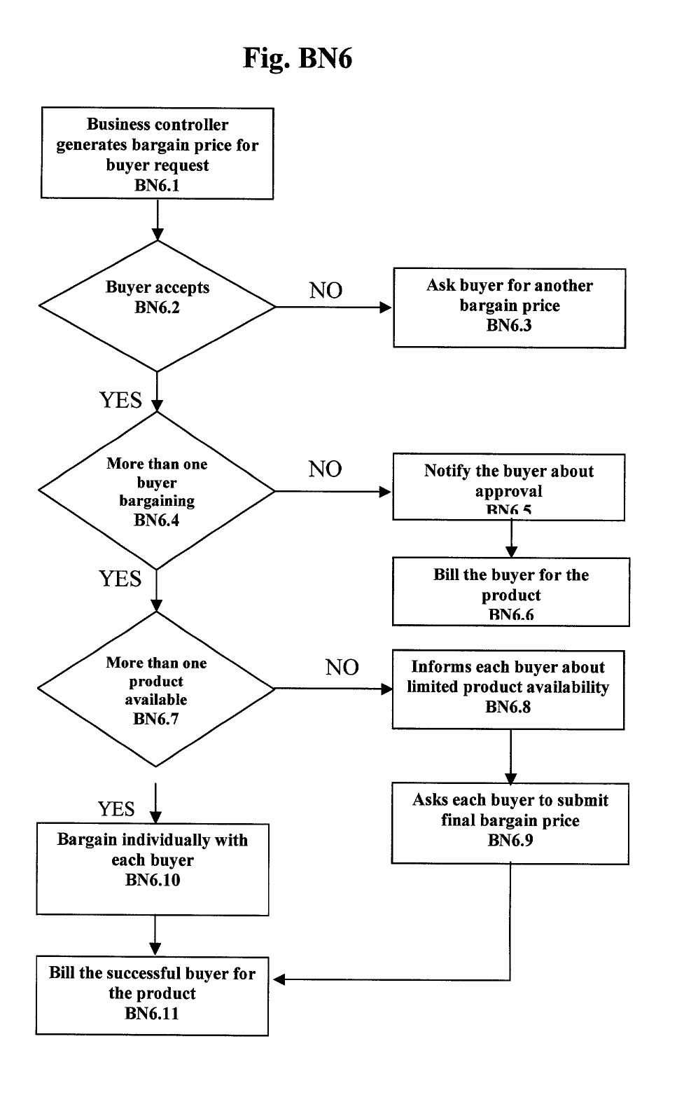

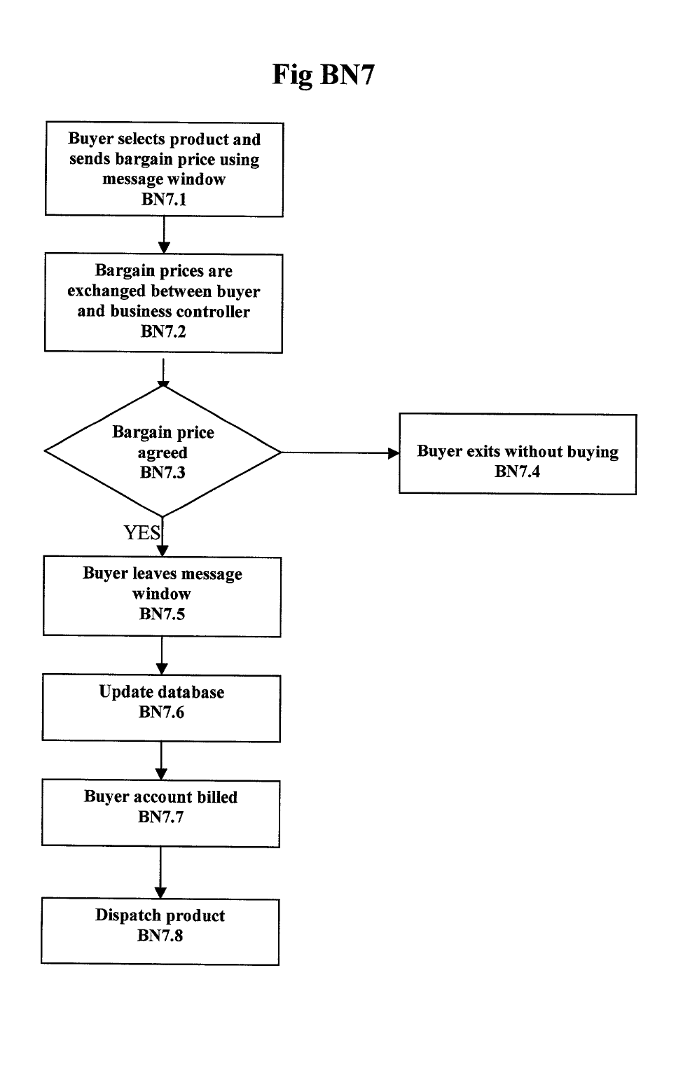

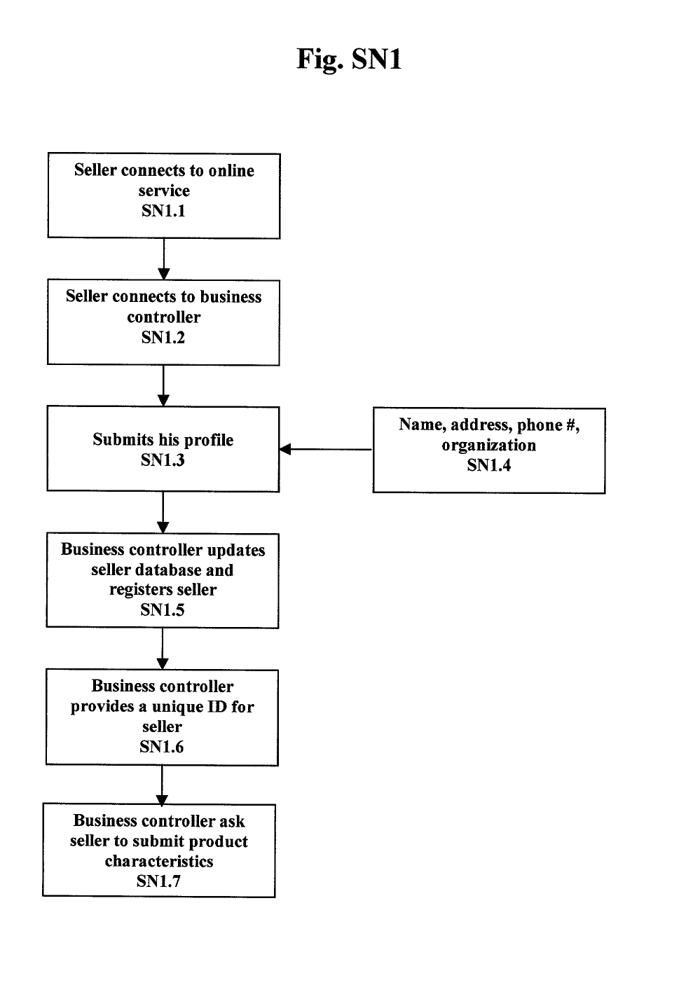

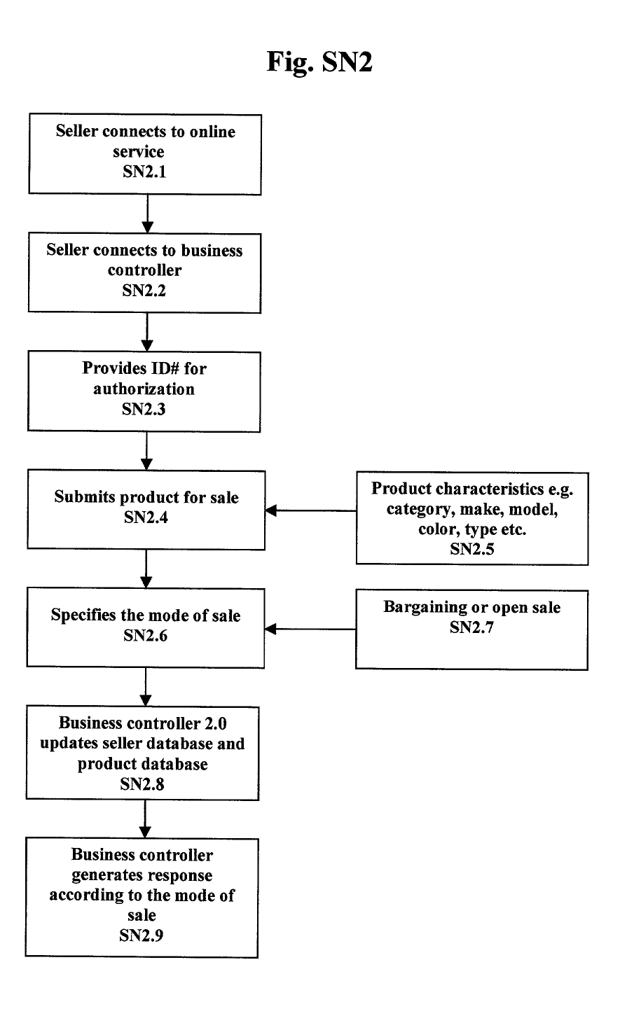

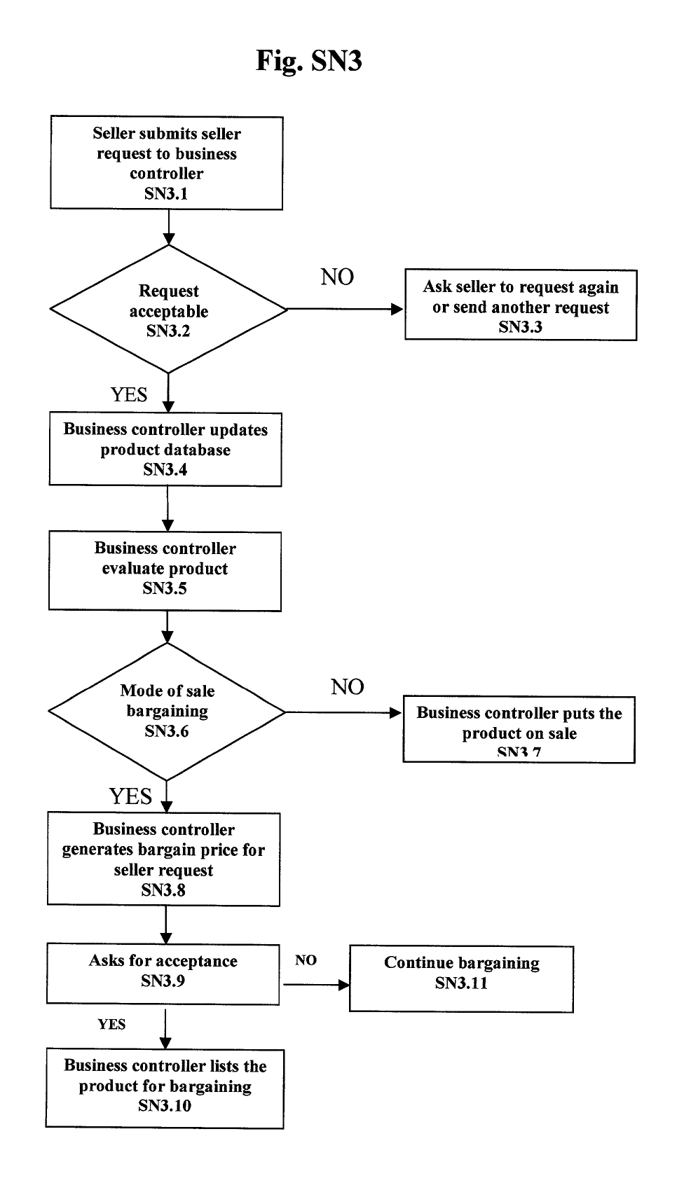

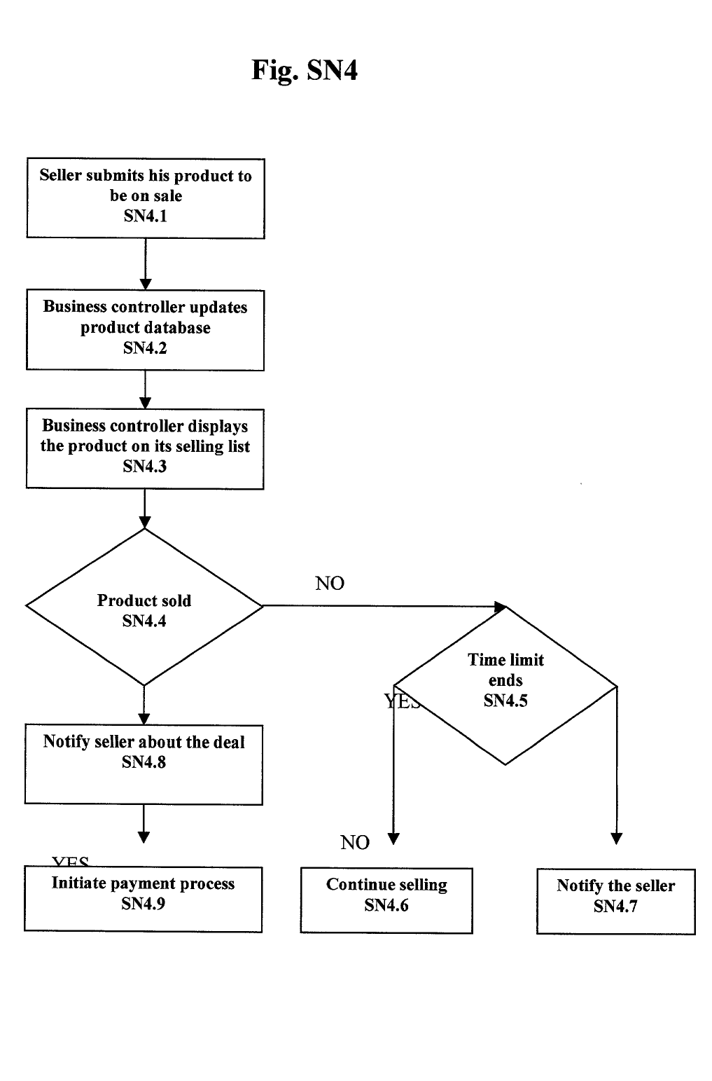

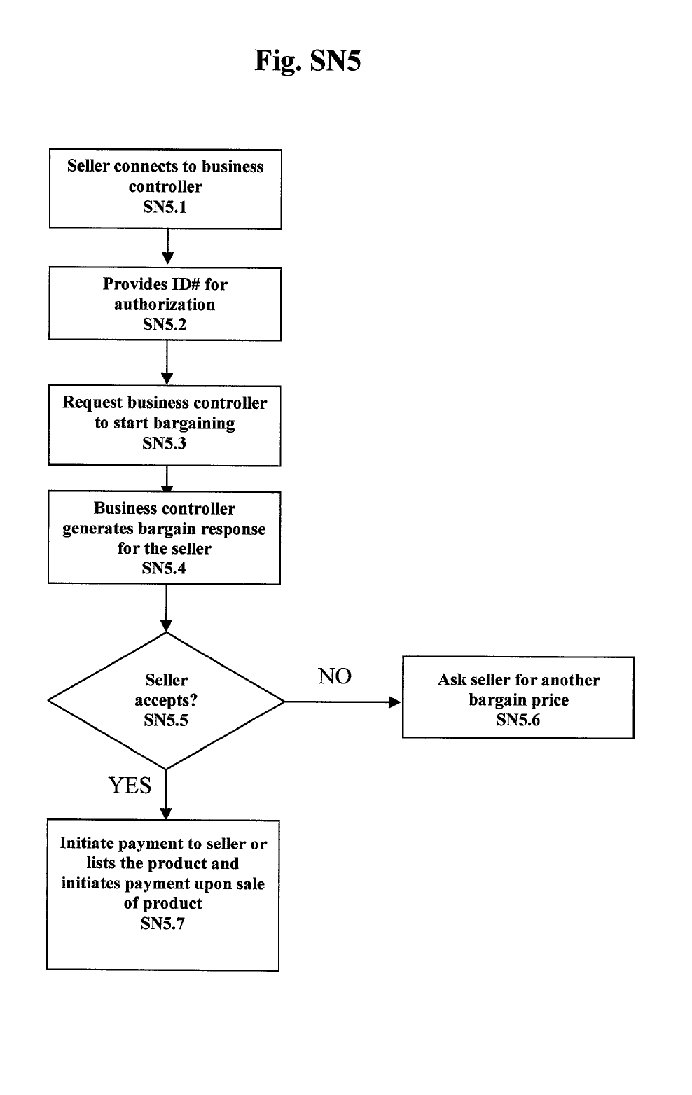

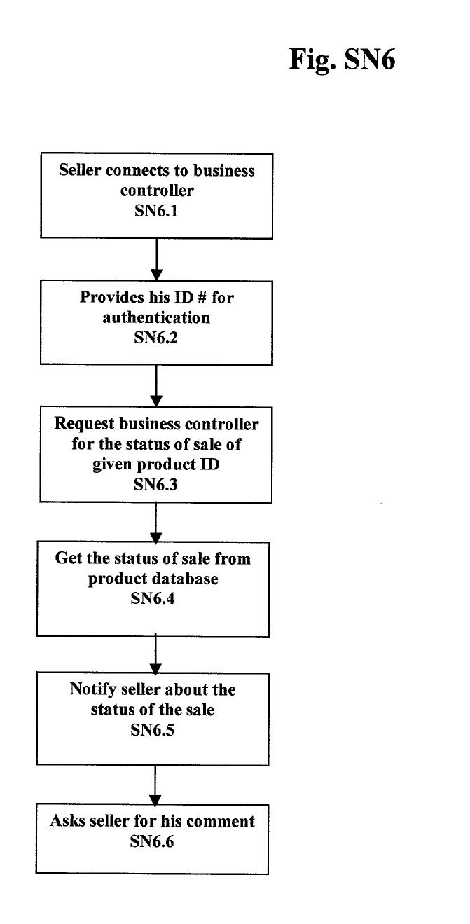

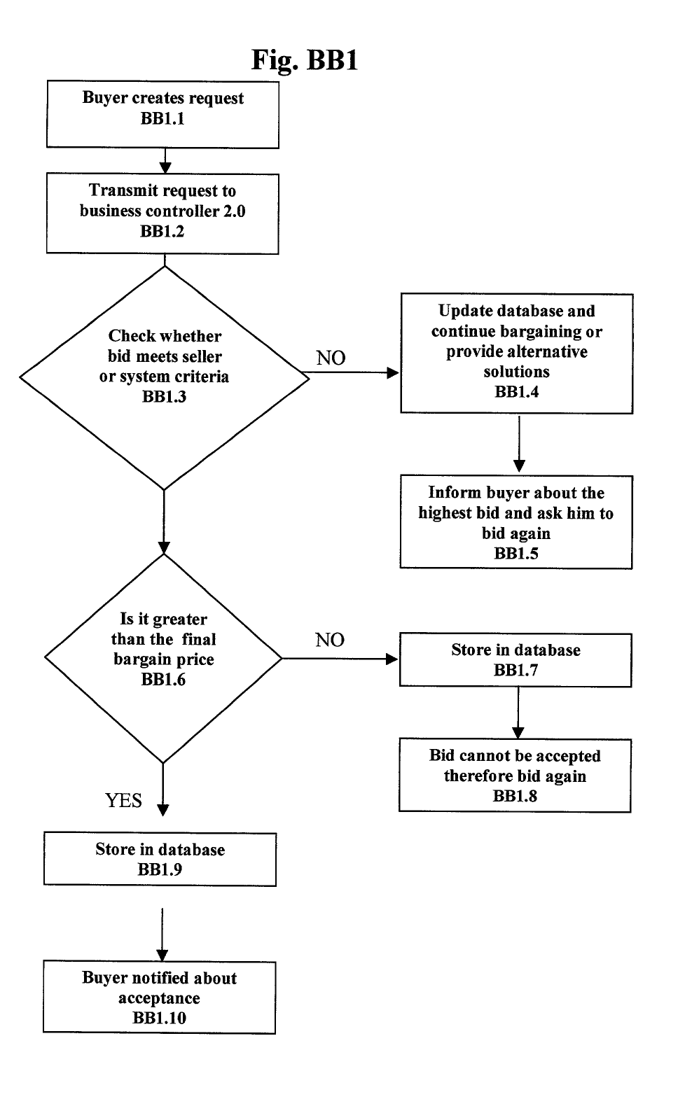

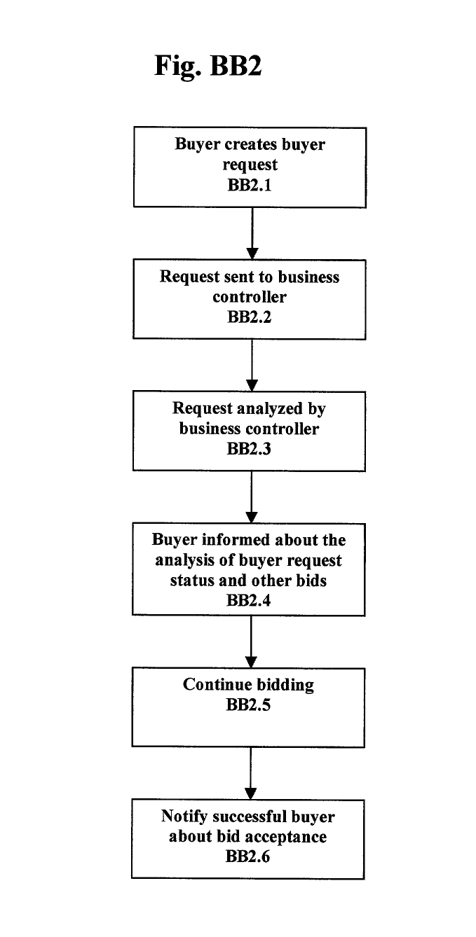

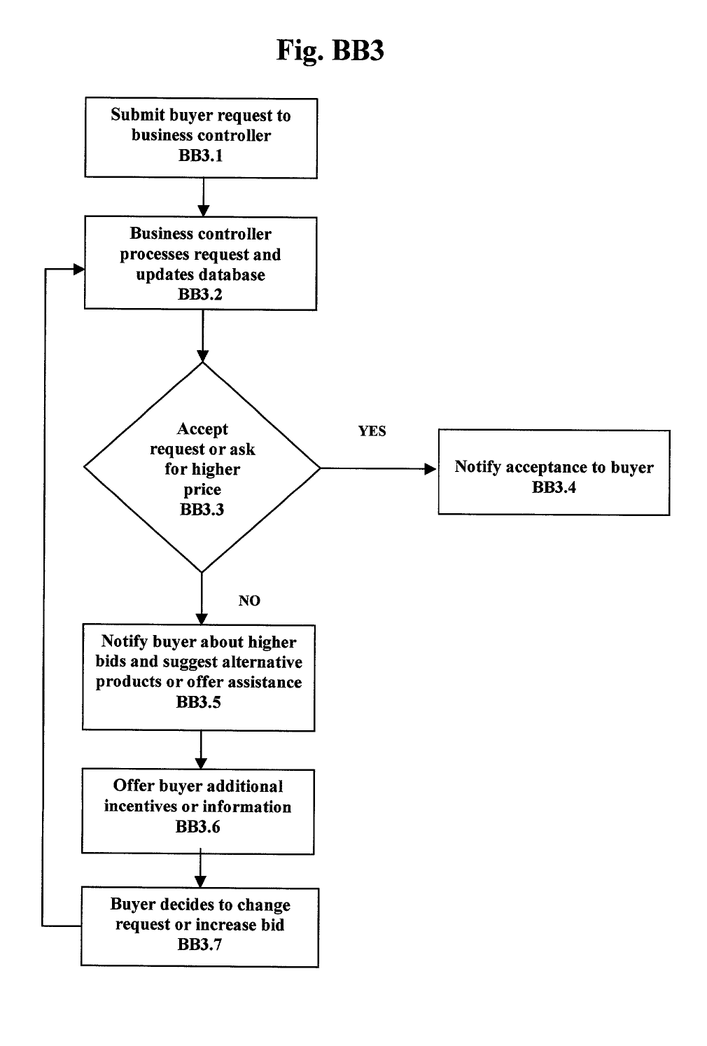

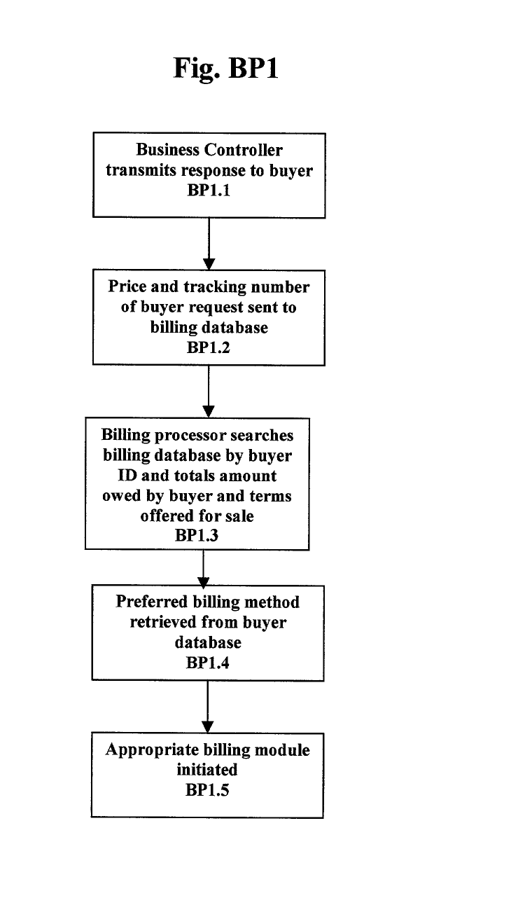

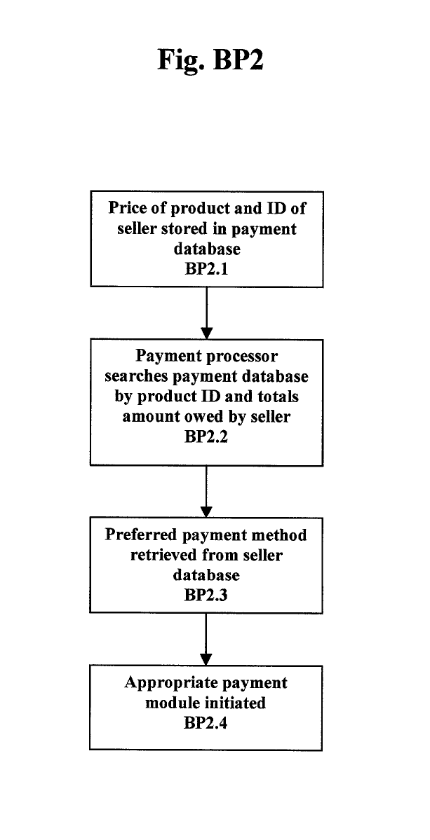

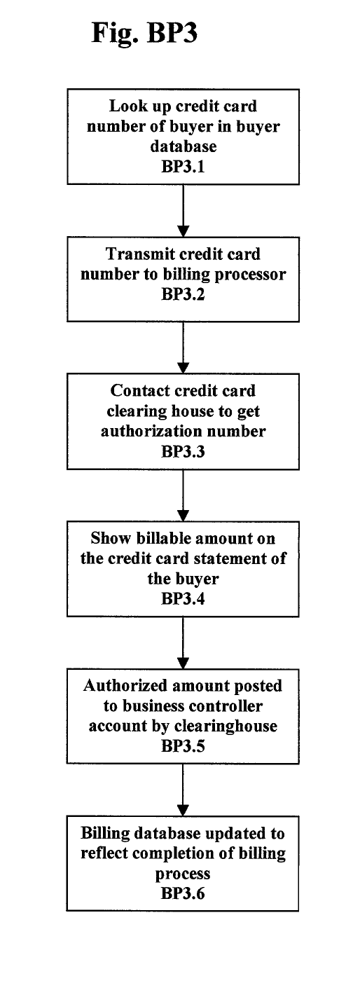

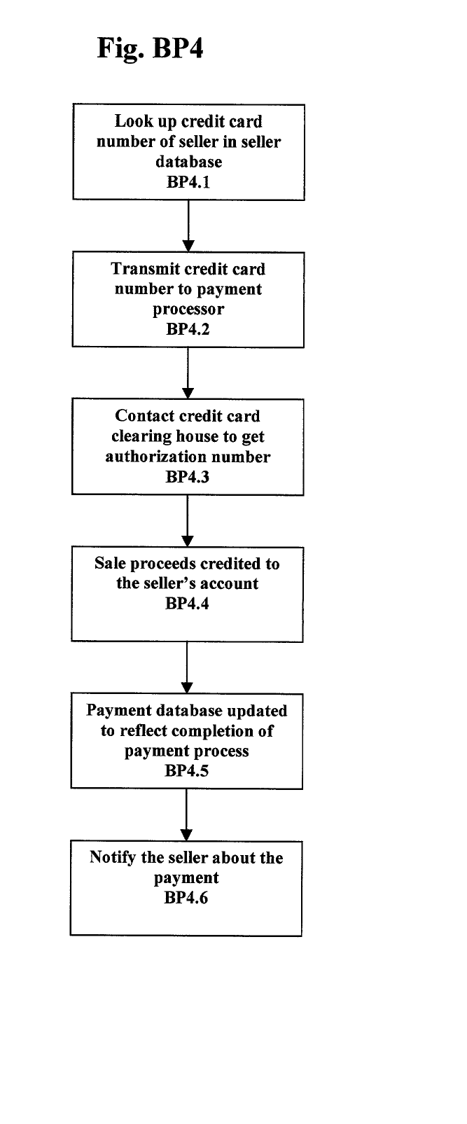

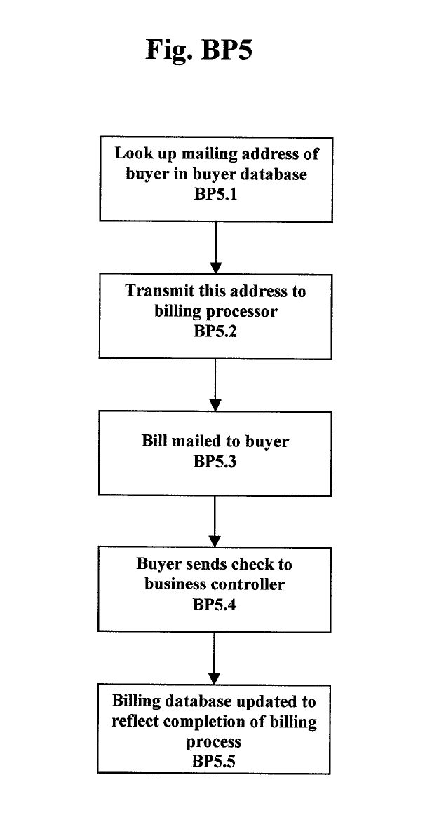

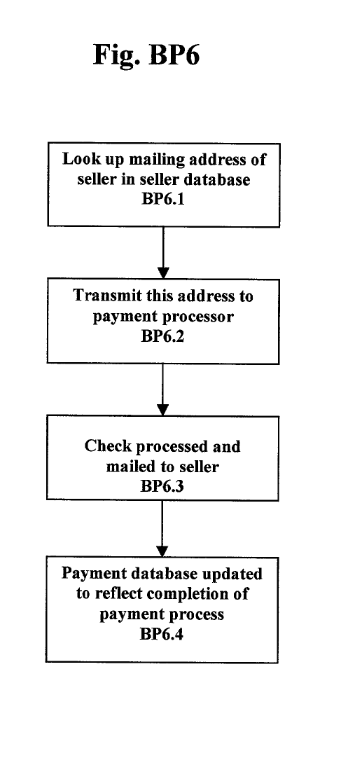

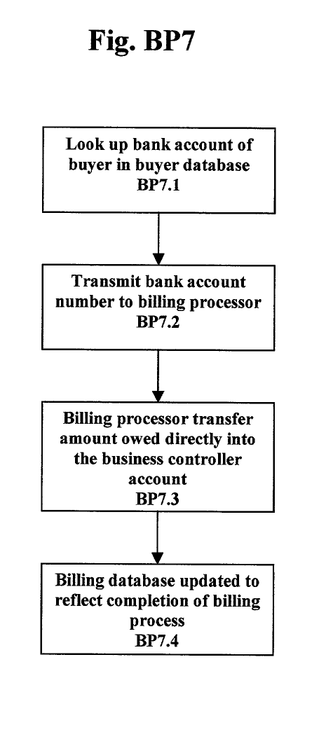

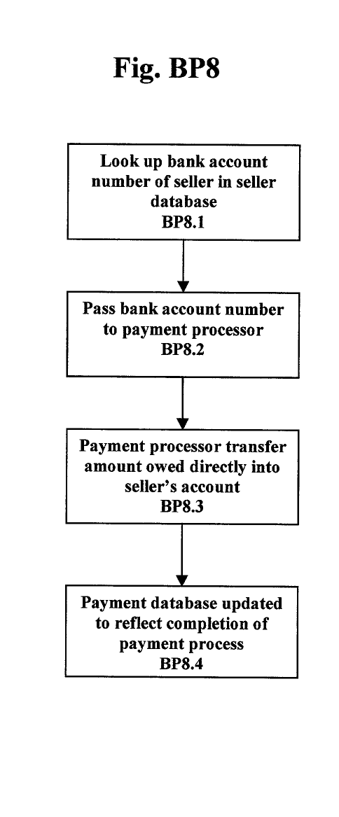

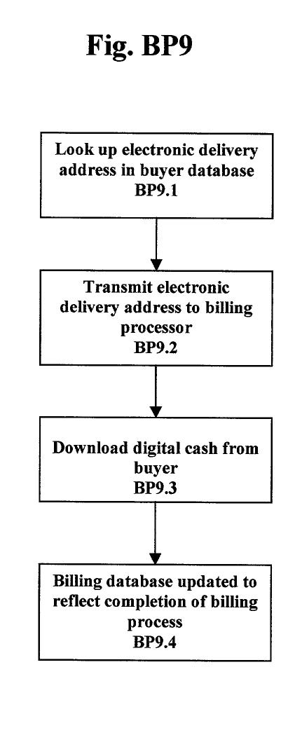

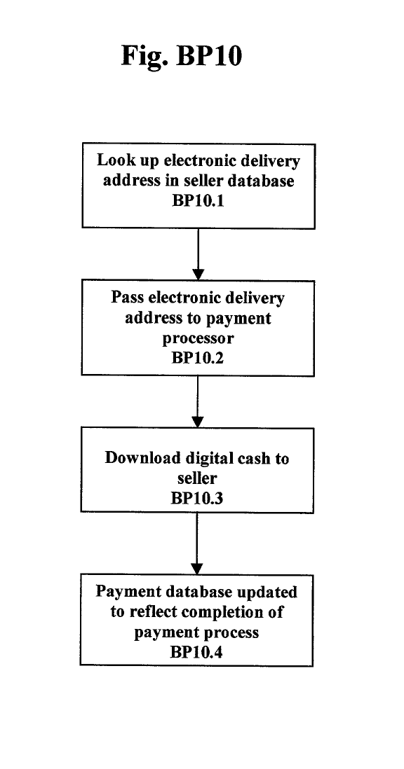

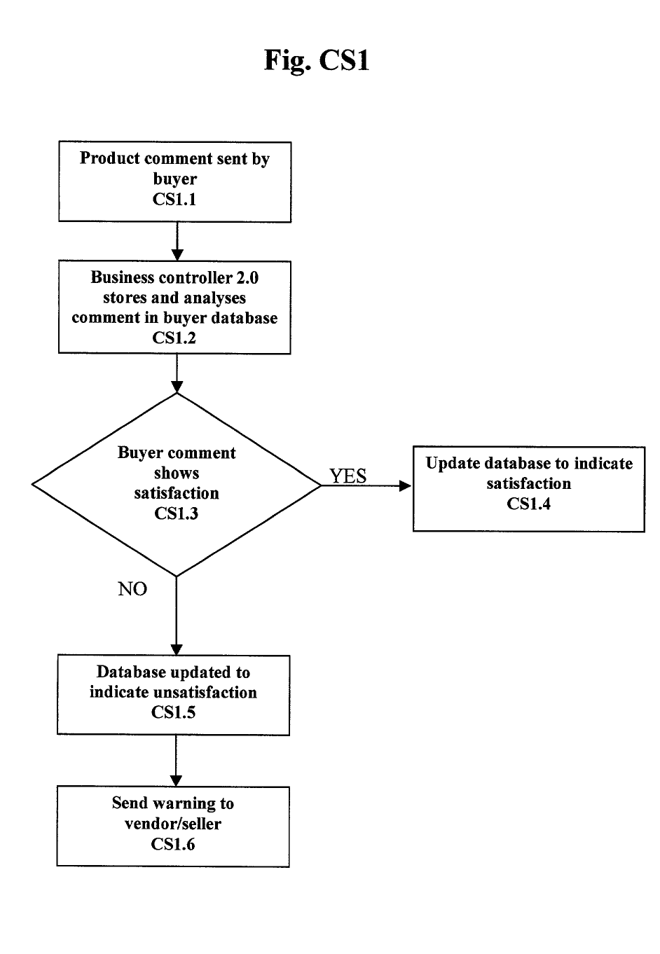

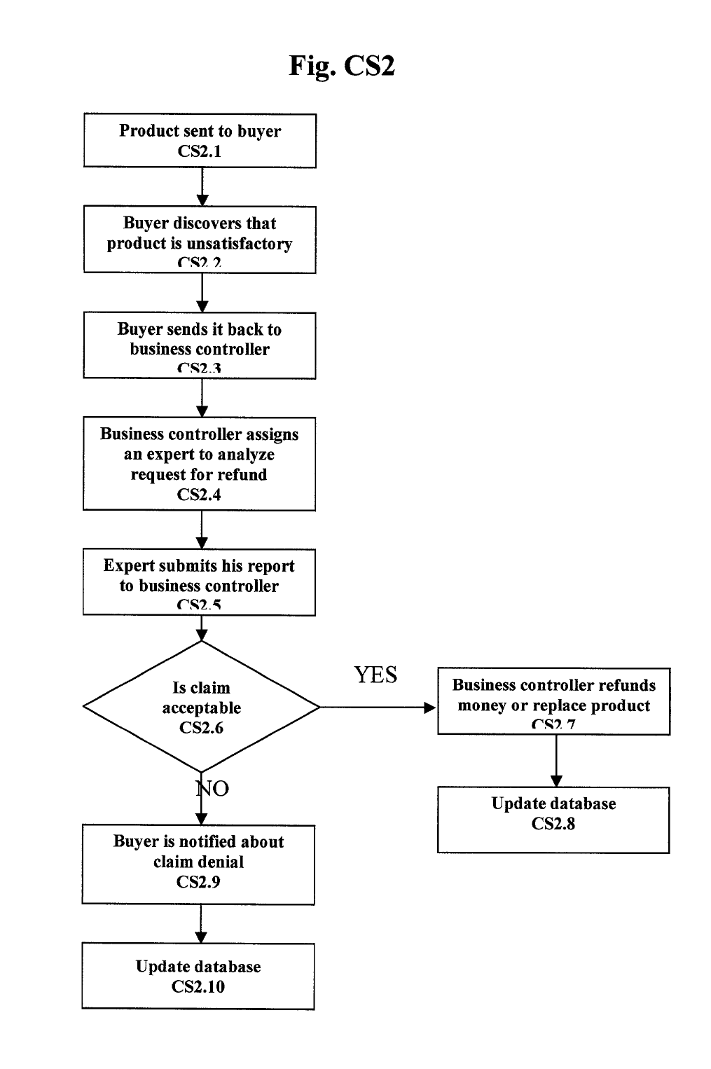

In FIGS. 5 and 6 there is illustrated a buyer interface and a seller interface, respectively. Typically, each of these interfaces is provided by a personal computer having an input device such as keyboard, mouse, or conventional voice recognition software package. Each of the buyer and seller interfaces also has a display device such as a video monitor, a processing device such as a CPU, and a network interface such as a combination of modem and an ISP connection. Alternatively, the buyer interface 5.0 and seller interface 6.0 may also be voice mail system, or other electronic or voice communication system. Devices such as fax machines or pagers are also suitable interfaces. Buyer and seller interfaces other than on-line via the Internet will be managed through the phone system and the bargaining process will be facilitated by customer service agents.

Referring to FIG. 5, the buyer interface is described which includes central processor (CPU) 5.1, RAM 5.2, ROM 5.3, video driver 5.8, video monitor 5.10, communications port 5.7, input device 5.9, network interface 4.1 and a data storage device. Each of these components is substantially identical to those described in FIG. 6.

The primary functions of the seller interface 6.0 and the buyer interface 5.0 are message creation and transmission. Numerous commercial software applications can enable the communications required by seller interface 6.0 and buyer interface 5.0. MS Outlook Express, manufactured by Microsoft, for example, provides editing tools for the creation of messages as well as communication tools to route the message to the appropriate electronic address.

Referring to FIG. 6 there is shown seller interface 6.0. The seller interface includes central processor (CPU) 6.1, RAM 6.2, ROM 6.3, video driver 6.8, video monitor 6.10, communication port 6.5, input device 6.9, network interface 4.1, and data storage device 6.6. CPU 6.1 can be comprised of a Pentium microprocessor such as 100 MHz P54C. CPU 6.1 has a standard chip-based clock, which is used to timestamp the seller request produced with seller interface 6.0. A modem is required to transmit data to Business Controller 2.0 for further processing so that the seller's product may be advertised open for bargain and given a starting bargain price. The encoding and decoding processor 6.4 is required to encode and decode data transferred to and from Business Controller 2.0. Data and decoding processor will be discussed at a later stage. Data storage device 6.6 is a conventional magnetic based hard disk storage unit, such as those manufactured by Western Digital. Information database 6.6 is used for archiving seller requests and the bargain details, payment records and shipping details are recorded at local database 6.7.

Asynchronous Bargaining Embodiment

In one embodiment of the current invention, the communication between buyers and the sellers takes place asynchronously through Business Controller 2.0. The buyer creates buyer request 1.2, transmits it to the Business Controller 2.0 and then disconnects from the network. The Business Controller 2.0 generates a buyer response 1.3, accepting the request. In the event that the buyer request is not acceptable, the Business Controller 2.0 generates a new bargain price for the buyer and sends it to the buyer for consideration. The buyer then generates a new buyer request based on the new bargain price received from Business Controller 2.0. This process is continued until (i) an acceptable price is arrived at, or (ii) one of the parties to the transaction discontinues the bargaining process, or (iii) the product or service becomes unavailable, or (iv) buyer runs out of chances or does not request additional chances, or (v) the predetermined time period allotted for bargaining has expired.

Alternatively in the case of seller, the seller sends a seller request containing a seller's offered price and details about his product to the Business Controller 2.0 and disconnects from the network. Business Controller 2.0 then generates a response having the form of (i) disapproval of seller's request or (ii) request for more details, or (iii) acceptance of the seller request, or (iv) provisional acceptance of seller request based on a modified bargain price or modified product or service offering suggested by the Business Controller 2.0. In the event that the seller request is not accepted by the Business Controller 2.0, the seller generates a seller request based on the response received from Business Controller 2.0. This process is continued until (i) an acceptable seller request is arrived at, or (ii) one of the parties to the transaction discontinues the bargaining process, or (iii) the seller decides to list the product on open sale, as described herein, or (iv) the seller runs out of chances or declines to purchase additional bargaining chances, or (v) the predetermined time for bargaining has expired. In either case the buyer or seller does not communicate with the Business Controller in real time.

Offline Communications with Buyer

With reference to FIG BF1, there is described the process by which buyer formulates buyer request 1.2.

The buyer first creates a request at step BF1.1, by choosing a product from the given list of (i) products, which include airline tickets, new and used cars, electronic components, computer peripherals, groceries, furniture, antiques, and the like; and/or (ii) services, which include legal services, consulting services, babysitting services, maid services, medical services, and the like. It will be appreciated by those skilled in the art that the list of products and services includes a myriad of products and services, that is to say, virtually any product or service which is required by a consumer or business entity and can be readily valued and priced for sale, and which is susceptible for purchase and sale in a bargaining context. The term “product”, as used herein is intended to include any product and/or service that constitutes subject matter adapted to be priced and sold for a bargained for consideration.

The buyer attaches his ID number to the request at step BF1.2. This ID number is received from the Business Controller 2.0 when buyer registers for the service and submits his profile (as illustrated below in FIG. BN1).

Business Controller 2.0 maintains a database of buyer ID numbers in buyer database 3.5, and issues or allows only unique numbers. At step BF1.3, the buyer attaches criteria to request as shown in step BF1.35 in the figure. Criteria typically includes the type, size, time, model, make, model number, and the like.

At step BF1.4, both the buyer ID and criteria are combined with request, producing a complete buyer request 1.2. The information given in buyer request 1.2 is used by Business Controller 2.0 to generate bargain price for the products meeting criteria as shown in box BF1.35. Criteria used in BF1.35 is searchable. Business Controller 2.0 searches product database 3.9 to get appropriate products for the buyer request 1.2 based on the criteria. The criteria in BF1.35 typically describes the required product, as well as the specific details of the product that the buyer wants to buy. The products typically include airline tickets, new and used cars, real estate, furniture, computer equipment, electronic equipment, tools, books, magazines, and the like. There may be a specific format for the criteria, requesting the buyer to use a given set words and symbols such as “model99”, “No. Of seats==5”, “Mileage<=2000”, “make=Cadillac” and the like for used cars, or it can be “capacity>=8GB”, “manufacturer=Seagate”, “price<=10000” and the like for a buyer interest in buying a new hard disk. The buyer can also designate response time, payment mode and type of service as criteria of buyer request 1.2.

Referring back to FIG. BF1, the buyer then converts buyer request 1.2 into electronic format at step BF1.5 and is transmitted to Business Controller 2.0 at step BF1.6. This transfer occurs via electronic mail, the system also supports voice mail, facsimile or postal mail transmissions of buyer request 1.2. Buyer request can also be posted to bulletin boards or web pages operated by Business Controller 2.0. In a web-based embodiment, buyers may fill out an electronic form built into the web pages of Business Controller 2.0.

It should be noted that the generation and transmission of buyer request 1.2 does not require the use of proprietary software. Conventional electronic mail software such as Outlook Express, for example, is capable of providing editing tools for the creation of messages as well as the communication tools to route the message to the appropriate electronic mail address. As long as the message conforms to standards established by the Business Controller 2.0, an email program is capable of generating and transmitting buyer request.

The standard would specify the message address, the information to be contained in the subject heading, and the processing order of the body of the message. The first line of the body of the electronic mail, for e.g. may contain the ID of the buyer. The second line is the product, third line the model and the fourth line the price buyer is willing to pay. Standard forms could also be electronically mailed to the buyer, allowing him to simply fill in the blanks and return buyer request 1.2 to Business Controller 2.0. Similar forms and standards could be applied to fax and postal mail transmission.

Referring to FIG. BF2, there is shown a flow chart for the case where the initial processing of buyer request 1.2 and first response generation by Business Controller 2.0 is intentional. Buyer request 1.2 is received, stored and processed by Business Controller 2.0 before generating a response. At step BF2.1, buyer request 1.2 is received from the buyer. Business Controller 2.0 supports all transmission methods allowing for a wide variety of formats of incoming buyer request. Some formats may be changed before further processing by Business Controller 2.0. Buyer request 1.2 transmitted by mail in paper form, for example, is scanned and digitized, using optional character recognition software to create digital text. Once buyer request 1.2 has been received, it is stored in request database 3.5 where it is assigned a unique tracking number.

After being stored at step BF2. 1, buyer request may go through a series of processing steps. One step, if necessary, is language translation. There are two forms of language translation. With the first form, a standard language is created in which all buyer request 1.2 must be written. Business Controller 2.0 extracts data from the buyer requests. The second form requires translation to the language most appropriate for the buyers and sellers and Business Controller 2.0. This translation is provided by language experts associated with the system, or by automatic translation software such as Systran Professional, manufactured by “Systran” software. Twelve bidirectional language combinations are available, including English to/from French, Italian, German, Spanish, Portuguese and Japanese.

Another processing step, if necessary, involves a check for spelling or typographical errors. Buyer request 1.2 is reviewed for clarity. Errors detected in Buyer request 1.2 are returned to the buyer for clarification and error removal.

One processing step comprises a search for criteria. If no criteria have been included, the buyer request is returned to the buyer for resubmission. The buyer can alternatively provide criteria by selecting the buyer request product directly via online connection as described hereinafter in the Synchronous Bargaining embodiment.

If the buyer does not want to provide criteria, buyer request 1.2 may be classified by searching (i) the request for predetermined key words, or (ii) a list stored in product database 3.9. Key words thereby developed are then used to generate criteria. Product database 3.9 includes a list of keywords associated with the products. The presence of one or more of those key words in the request triggers a classification of the request as the appropriate product.

One commercially available software package, which performs these types of searches, is Semantic Networks by Excalibur Technologies Corporation. The software provides the ability to retrieve approximations of search queries and has a natural tolerance for errors in both input data and query terms. Such software also provides a high level of confidence that searches will be successful regardless of errors in spelling of the data being searched. Excalibur's baseline semantic network supports multi-layered dictionary, structures that enable integration of specialized reference works for legal, medical, finance, engineering and other fields.

Excalibur Retrieval Ware enables developers to build information retrieval solutions for the full spectrum of digital information, including text, document images and multimedia data types. It allows for indexing and retrieval of digital images based on their objective context. These components enable pattern recognition based image retrieval applications that automatically recognize certain types of visual information and provide extensive image management capabilities.

Before searching for the product meeting the criteria in product database 3.9, Business Controller 2.0 searches for previous requests from the buyer for the same product number at step BF2.2, so that unnecessary bargaining is not performed. At step BF2.3, if the Business Controller 2.0 had accepted a buyer suggested bargain price earlier, but the buyer did not proceed to purchase the product at that time, and now wants to continue, there is generally no need to repeat the initial phase of the bargaining process. The buyer can, instead, be allowed to hold his bargain price for a limited time, or for an indefinite time, or until the product is purchased by another buyer.

If there exists a system accepted, buyer requested bargain price for a product, and the buyer has not yet purchased the product, and has placed his bargain price on hold, then at step BF2.6, if buyer signals his intent to purchase the product, Business Controller 2.0 will present the buyer with higher bargain prices then extant, which have been offered by other buyers, to allow buyer to match or better the extant higher bargain prices. In the event there exist no higher bargain prices, Business Controller 2.0 will process the payment and ship the product to the buyer. In the event that the product has been purchased at a higher bargain price, Business Controller 2.0 creates a bargain price 1.2 at step BF2.4 provided the product is still available. If the product requested is no longer available, or buyer is not willing to match or better the higher bargain prices, then at step BF2.5, Business Controller 2.0 generates from product database 3.9 a list of product closely meeting the criteria in buyer request but differing in certain respects, such as brand name, quality, color, features and the like. The list generated from product database 3.9 is then presented to the buyer for consideration, and the process is continued, as described herein, with buyer selecting a product from the list presented by Business Controller 2.0.

After presenting the buyer with the higher bargain offers by other buyers, Business Controller 2.0 checks at step BF2.7 whether or not the buyer's bargain price revised in light of such higher bargain offers, is successful. If it is, then Business Controller 2.0 asks the buyer to accept the bargain at step BF2.8. When the buyer accepts the offer at step BF2.9, Business Controller 2.0 finalizes the deal by billing the buyer and dispatching the product to the given address at step BF2.11. If buyer does not accept, then Business Controller 2.0 continues with the bargain process at step BF2.10 until a successful bargain is arrived at. In the event that the buyer's revised bargain price is not successful, then Business Controller 2.0 generates a new bargain price for the buyer and proceeds with the bargaining at step BF2.12 and BF2.13, and the process is continued as described herein.

In FIG. BF3 there is illustrated another method of buyer request processing. Business Controller 2.0 assigns a tracking ID to each buyer request and, after receiving the request, stores it in request database 3.3 at step BF3.1. Upon receiving a buyer request, the Business Controller searches at step BF3.2, Business Controller 2.0 to determine whether there exists in request database 3.3 a similar request by the same buyer for the same product and whether the request was successful. In the event that a similar bargain request exists at step BF3.3, the buyer is notified about the bargain prices submitted by previous requests and whether such previous requests were successful at step BF3.6. If no similar requests exist at step BF3.3, then Business Controller 2.0 creates a bargain price in the form of a new bargain request using the criteria at step BF3.4. At step BF3.7, buyer has the option of either accepting the old bargain price or continue bargaining. If buyer chooses to accept the old bargain price, the Business Controller 2.0 checks at step BF3.8 to determine whether or not the product is available. If the product is available, buyer is notified about bargain request acceptance at step BF3.11, and billed at step BF3.12. If the product is not available, or a price has not been agreed upon, then Business Controller 2.0 generates a list of products closely meeting the criteria but differing therefrom in some minor respect, such as brand name, quality, color, features and the like, by searching through the product database 3.9 at step BF3.5. Business Controller 2.0 so informs buyer at step BF3.9 and asks him to send another request at step BF3.10.

In the event that the buyer refuses to accept the previous bargain price at step BF3.7 and the product requested or a product closely meeting the criteria, as described above, is available, Business Controller 2.0 (i) offers to accept the previous bargain price, as applied to purchase of product having closely matched but slightly dissimilar attributes, such as different brand name, quality, color, features and the like, or (ii) generates a new bargain price for purchase of the same product and proceeds with the bargaining process at steps BF3.13 and BF3.14.

Referring to FIG. BF4 of the drawings, there is illustrated a process for offline bargaining in which Business Controller 2.0 bargains with more than one buyer. At step BF4.1, Business Controller 2.0 generates a bargain price for buyer request. This bargain price response is transmitted to the buyer at step BF4.2. If the buyer does not accept the bargain price at step BF4.3 then, at step BF4.4, Business Controller 2.0 is notified about the denial. Business Controller 2.0 asks buyer for another bargain price of his choice at step BF4.5. If the buyer accepts the bargain price at step BF4.3 then, at step BF4.6, acceptance is sent to Business Controller 2.0. At step BF4.7, Business Controller 2.0 checks the presence of more than one buyer bargaining for the same product. If only one buyer exists then he is informed about the request approval at step BF4.8 and then the buyer is billed at step BF4.9.

If at step BF4.7 there is more than one buyer bargaining, then Business Controller 2.0 checks for the availability of that product at step BF4.10. In the event that there is available sufficient quantity of product requested, Business Controller 2.0 continues bargaining at step BF4.11 and, at step BF4.12, bills the buyer.

If the condition arises that only one piece of the requested product is available at step BF4.10, Business Controller 2.0 notifies the buyer offering the maximum bargain price that his bargain request has been approved at step BF4.13. Thereafter, at step BF4.14, Business Controller 2.0 notifies other buyers about the deal, stops running bargain process with them and, at step BF4.15, initiates the billing process for the successful buyer.

In FIG. BF5 there is illustrated the bargain price generation process by Business Controller 2.0 during bargain negotiations with buyer. After generating bargain price for the buyer at step BF5.1, Business Controller 2.0 attaches a product ID and stores it in response database 3.4 at step BF5.2, before sending this bargain price to the buyer at step BF5.3. If the buyer accepts the bargain price at step BF5.4, Business Controller 2.0 initiates the billing process at step BF5.6 and dispatches the product to the buyer at step BF5.7. Business Controller 2.0 initiates the payment process for the seller or vendor or manufacturer of the product at step BF5.8. In the event of buyer refusal at step BF5.4, Business Controller 2.0 asks buyer for his next best bargain price at step BF5.5, and the process is continued, as described herein.

Offline Communications with Seller

Another feature of the Internet Bargaining System is the ability to provide for offline bargaining and communications between the seller and Business Controller 2.0. In FIG. SF1 there is shown a method wherein the seller registers himself with the Business Controller 2.0. At step SF1.1 seller creates his profile, and at step SF1.2, specifies his name, address, phone number and the like. Seller converts his profile and, preferably, details about mode of payment into electronic format at step SF1.3. This data is then transmitted to Business Controller 2.0 at step SF1.4. As described earlier, this transfer occurs via electronic mail, voice mail, facsimile or postal mail transmissions.

Generation and transmission of seller profile data does not require proprietary software. Conventional e-mail software such as “Outlook Express”, for example, provides editing tools for creation of messages, and communications tool to route these messages to the appropriate e-mail address. As long as a message conforms to the standards established by Business Controller 2.0, any e-mail program can perform the required function. The standard specifies the address to send messages to, as well as the format of information contained in the subject and the body of the message. Standard forms can be electronically mailed to the seller, allowing the seller to complete the forms by filling in the blanks and returning the forms to Business Controller 2.0. Business Controller 2.0 updates seller database at step SF1.5 and generates a unique ID at step SF1.6 for seller authentication in future. This ID number can contain a login name and password. The generated ID is then transmitted back to seller at Step SF1.7. Seller can use the ID number (i) to get authorization from the system for sale of the product (or to sell another product at some other time), or (ii) for present or future correspondence.

FIG. SF2 illustrates an embodiment in which the seller submits product details. At step SF2.1 the seller creates a product profile giving specific details about his product, for example, category, type, make, model, color, type and the like, as shown in SF2.2. The seller attaches his ID number with the product profile for authorization at step SF2.3. Thereafter, at step SF2.4, the seller converts the product profile into electronic format and transmits his request to Business Controller 2.0, at step SF2.5. Transmission of the request at step SF2.5 can, alternatively, be accomplished by facsimile or regular mail. As used herein, the term “regular mail” includes first class, or faster, mail delivery, such as express mail, federal express, courier, messenger and the like. Business Controller 2.0 updates product database, at step SF2.6, and at step SF2.7 Business Controller 2.0 transmits a response containing the seller request and conditions of sale.

Reference is now made to FIG. SF3, in which Business Controller 2.0 performs the creation and initial processing of the seller request 1.4. Seller creates seller request 1.4 at step SF3.1, converts it into electronic format, facsimile or regular mail at step SF3.2 and at step SF3.3 transmits it to Business Controller 2.0. At step SF3.4 Business Controller 2.0 checks if the request is acceptable or not. If the request is not accepted then, at step SF3.5, Business Controller 2.0 asks the seller to send the request again or create a new request. At step SF3.4, if Business Controller 2.0 accepts the request then product database 3.9 is updated at step SF3.6. Then Business Controller 2.0 starts the process of evaluation of the product at step SF3.7, and at step SF3.8 Business Controller 2.0 generates a response according to the mode of sale specified in the request by the seller.

In FIG. SF4 there is illustrated the related processes occurring when the seller wants to sell his product to Business Controller 2.0, or the seller wants Business Controller 2.0 to put his product on sale. At step SF4.1, Business Controller 2.0 evaluates seller request and checks whether this is an acceptable request at step SF4.2. If the request is not acceptable, then Business Controller 2.0 sends a rejection notification to seller at step SF4.3 and asks seller to create a new request at step SF4.4. If, at step SF4.2, the request is accepted then Business Controller 2.0 checks the mode of sale at step SF4.5. In the event that the mode of sale in the request is to put the product on open sale, then Business Controller 2.0 puts the product on the selling list, adds a predetermined percentage typically at least about 0.001%, preferably about 0.05% to 1000%, and more preferably about 0.10 to 20% based on the offering sale price of the product or service, and updates respective database at step SF4.6. As used herein, the term “open sale” means sale of the product, by auction, bargaining, or retail or wholesale listing thereof, without active participation by the Business Controller 2.0. At step SF4.7 Business Controller 2.0 checks whether the product is sold or not. If the product is sold then Business Controller 2.0 sends notification to the seller about the deal at step SF4.8 and, at step SF4.10, initiates the payment process for the seller in accordance with the conditions of sale. If the product is not sold, then at step SF4.9, the Business Control 2.0 continues to sell the product until (a) the product is sold, (b) the product is withdrawn by the seller, or (c) the time limit for listing the product has expired. Referring again to step SF4.5, if the mode of sale is bargaining i.e. the seller wants to sell the product to the Bargaining System or to a buyer with active participation by the Business Controller 2.0 at a bargained for price, then Business Controller 2.0 generates a bargain price for the seller, adds a predetermined percentage typically at least about 0.001%, preferably about 0.005% to 1000%, and more preferably about 0.10 to 20% based on the final sale price of the product or service, and updates response database 3.4 and step SF4.11. In the event that the seller accepts the bargain price at step SF4.12, then at step SF4.13 Business Controller 2.0 either initiates the payment process to seller in accordance with the conditions of sale, or actively bargains with prospective buyers to arrive at a mutually agreed upon bargain price for sale of the product and initiates payment to seller as per the conditions of sale. If the seller does not accept the bargain price, then Business Controller 2.0 continues with the bargaining process at step SF4.14.

Referring to FIG. SF5 there is illustrated the inquiry process used by the seller to inquire about the sale of his product. At step SF5.1, seller creates inquiry request, attaches his ID number for authorization and transmits the request to Business Controller 2.0 along with product ID at step SF5.2. Thereafter, at step SF5.3, Business Controller 2.0 checks the sale status of the product ID specified in the inquiry request. If the product has been sold, the Business Controller 2.0 provides details of the sale and the agreed upon terms and conditions of sale. If the product is still listed for sale, then at step SF5.4, Business Controller 2.0 provides information about current and previous bargain offers. Business Controller 2.0 then asks the seller to transmit his comment about the sale status at step SF5.5 which comment may include a revised request to list the product with certain purchase incentives, or at a revised purchase price.

Synchronous Bargaining Embodiment

In one embodiment of the present invention, buyers and sellers requiring continuous interaction with the system establish a synchronous communication channel with the system. Inasmuch as the present invention is based on a bargaining system, real-time system communication is preferred instead of the asynchronous communication protocol. There are various methods that buyers and sellers can use to communicate with the system. Protocols for communications between one buyer and the system and between one seller and the system are described hereinafter in further detail. In the embodiment describing buyer-system communications, the buyer and system exchange a series of buyer requests and bargain responses using a one-to-one synchronous communications channel such as telephone, real-time text messaging, voice recognition and response systems, dynamic web pages, chat rooms on the Internet, wireless communication such as cell phones or Palm Pilots, and the like, or video conferencing. The same mechanism exists for the case of seller-system communications, in which the seller and system exchange seller requests and bargain responses. Buyer can request a synchronous communication channel when making an initial buyer request 1.2, using any of the embodiments of the present invention. If buyer's criteria includes a request for voice communications, Business Controller 2.0 provides software enabling voice actuated computer communication, or assigns an expert to construct a synchronous voice or text-based synchronous communication channel. This mechanism is oftentimes employed for special cases; since Business Controller 2.0 is generally able to process the request and all steps of the bargaining process.

Many synchronous communications channels may be used. For illustrative purposes an online messaging system is described which uses a standard online service to provide a real-time, text-based or voice-based communications link between the buyer and seller, as well as between the buyer or seller and Business Controller 2.0.

Online Bargaining with Buyer

In FIG. BN1, there is illustrated a method by which buyer creates a profile and registers with the system online. Buyer connects to an online service at step BN1.1. This online service could be from any Internet service provider (ISP), such as AOL, CompuServe, Prodigy, IBM, and the like. It will be understood by those skilled in the art that the connection can be a line connection such as a telephone line or cable connection, or a wireless connection, such as that made using a cell phone, Palm Pilot or the like. At step BN1.2 buyer connects to Business Controller 2.0 and submits the profile at step BN1.3. Here buyer provides buyer's name, address, phone number, e-mail address, city, state, country, preferred language and the like, as shown in box BN1.4. Business Controller 2.0 can require the buyer to provide this information in a predefined format. Alternatively, buyer may be required to fill out an online form for this purpose. Business Controller 2.0 updates buyer database 3.5 at step BN1.5 and the buyer becomes registered with the system. At step BN1.6, Business Controller 2.0 generates a unique ID number for the buyer. This ID number can contain a login name and password. This ID number is used by the buyer to get authorization for purchase of products from the system. It also permits buyer to purchase wild card discounts and bonus chances. The system may also award wildcard discounts, or special promotions on specific bargain deals, and/or award such wild card discounts and special promotions randomly or to privileged customers. Buyers are notified of such wild card discount awards by surprise pop-up messages, or by instant messaging, or by means of a “Bargain Guru”. In addition, the system is further configured to award purchase incentives selected from the group consisting of: (a) bonus chances made available upon the purchase of products and/or services, or in response to buyer request for free bonus chances, or to encourage timely payment by regular customers and (b) purchase points provided upon purchase of products and services. The basis for providing purchase points will vary, depending on the price and quantity of product purchased, the referral of new purchasers and other product and service drivers, as may be referenced in the membership agreement.

Buyer connects to Business Controller 2.0 to get information about new and future products. In addition, buyer can view the prices offered by the system. Buyer can make queries about the quality and state of products that are of interest for bargaining. At step BN1.7 Business Controller 2.0 notifies buyer about the completion of the registration process. In another embodiment of the invention, either buyer or seller can surf the Internet bargaining site for a predetermine period of time, preferably ranging from at least about 30 seconds, more preferably from about 1 minute to 10 hours, and still more preferably from 2 to 7 hours, to determine product and service offerings.

In FIG. BN2 there is described an embodiment of this invention wherein the buyer selects a product and creates a buyer request. The system allows the buyer at step BN2.1 to establish an online connection to Business Controller 2.0 via the Internet, using an ISP such as AOL, CompuServe, Prodigy and the like or other conventional online system. Online services act merely as a convenient way for synchronous communications given their capacity to process tens of thousands of simultaneous connections. In another embodiment Business Controller 2.0 process all synchronous communications directly, eliminating the need for online networks. Buyer interface 5.0 displays a screen on video monitor 5.10 that offers a selection of predetermined product areas at step BN2.2, such as Airline Tickets, Real Estate, Cars, Sports Goods, and Antiques and the like, as described in box BN2.3. These product areas are stored in product database 3.9. Buyer selects a category and is presented with a list of products present in that category. Thereafter, buyer is prompted to select one of them at step BN2.4.

Step BN2.4 can consist of several steps that may include further selection of sub-categories related to the product. These categories help the buyer to further refine the criteria of his request. At step BN2.6 buyer finalizes the choice of product. At step BN2.7 Business Controller 2.0 generates a product ID against the criteria submitted by the buyer. Bargain request 1.2 is created at step BN2.8, which includes the buyer's bargain price and, optionally, the payment preference suggested by the buyer such as credit card, EFT, or digital cash as shown at step BN2.9.

In FIG. BN3 there is shown (i) the process used by buyer to make his request to Business Controller 2.0 after selecting the product online; and (ii) how the Business Controller 2.0 initiates the bargain process. At step BN3.1, buyer's request, buyer ID and product ID are combined to buyer request 1.2. This buyer request 1.2 is then transmitted to Business Controller 2.0 at step BN3.2, and at step BN3.3 Business Controller 2.0 stores buyer request 1.2 in bargain request database 3.3. At step BN3.4 Business Controller 2.0 decides whether or not the request can be accepted. If Business Controller 2.0 does not accept the request, then at step BN3.5, Business Controller 2.0 checks the product database for alternative products. If no alternative product is found, then at step BN3.6, Business Controller notifies the buyer about the rejection of the request and stops bargaining. The appropriate reason of rejection is shown to the buyer through buyer interface 5.0 at step BN3.6. The basis for rejection could be (i) that the product may not be available at that time; or (ii) that the product has already been sold; or (iii) that the service is not selling products in that category; or (iv) that the price is below the final bargain price, or (v) that the bargaining chances have been exhausted, or (vi) the time allotted for bargaining has expired. At step BN3.11 Business Controller 2.0 updates its database and stops all transactions related to this process. For cases in which the product is unavailable or has already been sold, or for which the buyer request price is too low, at step BN3.5, Business Controller 2.0 generates a list of products closely meeting the criteria (ie. price, product description and conditions of sale) set forth in buyer's request, but differing therefrom in some minor respect, such as brand name, quality, color, features and the like. Business Controller 2.0 generates this list of products by searching through the product database 3.9. The Business Controller 2.0 so informs buyer at step BF3.12 and at step BN3.13 asks the buyer to accept the alternative product. If buyer does not accept the alternative product, then at step BN3.14 buyer may nevertheless submit a modified request, and at step BN3.15 the bargaining process is continued until a bargain price is mutually arrived at, the alternative product becomes unavailable or one of the parties discontinues the process. If Business Controller 2.0 accepts buyer request 1.2 at step BN3.4 then Business Controller 2.0 generates a response for the buyer in the form of a bargain price acceptance at step BN3.7. This response is transmitted to the buyer at step BN3.8 and Business Controller 2.0 bills the buyer at step BN3.9.

Referring to FIG. BN4, the initial processing of buyer request 1.2 and first response generation by Business Controller 2.0 is illustrated. Buyer request 1.2 is received, stored and processed by Business Controller 2.0 before generating a response. At step BN4.1, buyer request 1.2 is received from the buyer. Once buyer request 1.2 has been received, it is stored in request database 3.5 where it is assigned a unique tracking number.

After being stored at step BN4.1, buyer request may go through a series of processing steps. One step, if necessary, is language translation. There are typically two forms of language translation. In the first translation form a standard language is created in which all buyer request 1.2 must be written. Business Controller 2.0 extracts data from the buyer requests. The second translation form comprises translating to the language most appropriate for the buyers and sellers, and Business Controller 2.0, as described in earlier embodiments. Buyer request 1.2 containing errors will be returned to the buyer for clarification and error removal. In a further processing step, the request is searched for criteria, and if no criteria have been included, buyer request is sent back to the buyer for resubmission. Language translation is not required if the language used meets the preferred language criteria defined by the registration profile of both seller and buyer. The Internet Bargaining System is equipped with language translation software that enables it to communicate with both buyer and seller in a multilingual environment.

Before searching for the product meeting the criteria in product database 3.9, Business Controller 2.0 searches at step BN4.2 for previous requests from the buyer for the same product number that was accepted by the Business Controller 2.0, so that unnecessary bargaining is not performed. If the buyer had already suggested his bargain price earlier but did not proceed at that time, and now wishes to continue, then there is no need to start all over. In this instance, the buyer can be allowed to hold his bargain price for: (i) a limited time, or (ii) an indefinite time, or (iii) until the product is bought by another buyer. Alternatively, the buyer can input the transaction tracking number to retrieve the bargain price previously accepted by the system and kept on hold by buyer.

In the event that the buyer has previously requested a bargain price for that product at step BN4.3, then Business Controller 2.0 will present the buyer with higher bargain prices offered by other buyers at step BN4.5, or provide to buyer additional purchase options, such as (i) average price paid by other buyers, or (ii) the selling price of the product on other web sites (i.e. comparative price quotes). If the product is not available, or a price has not been agreed upon, then Business Controller 2.0 generates a list of products closely meeting the criteria but differing therefrom in some minor respect, such as brand name, quality, color, features and the like, by searching through the product database 3.9 at step BN4.4. The process is thereafter continued in the manner described hereinabove in connection with the portion of the specification involving offline communication with the buyer.

After presenting the buyer with the higher bargain offers by other buyers, Business Controller 2.0 checks at step BN4.6 whether or not the buyer's bargain price revised in light of such higher bargain offers, is valid. If it is, then Business Controller 2.0 asks the buyer to accept the bargain at step BN4.9. When the buyer accepts the offer at step BN4.10, Business Controller 2.0 finalizes the deal by billing the buyer and dispatching the product to the given address at step BN4.12, and sends invoice and shipping details either through an electronic email system or through regular mail. If buyer does not accept, then Business Controller 2.0 continues with the bargain process at step BN4.11 until a successful bargain is arrived at. In the event that the buyer's revised bargain price is not valid, then Business Controller 2.0 generates a new bargain price for the buyer and proceeds with the bargaining at step BN4.7 and BN4.8, and the process is continued as described herein until a bargain price is mutually reached, the product becomes unavailable, or one of the parties discontinues the bargaining process.

In FIG. BN5 there is show the process of online bargaining between buyer and Business Controller 2.0. At step BN5.1 buyer connects to an online service as shown in box BN5.2. A communications channel is opened at step BN5.3 between Business Controller 2.0 and the online service. The communications channel is a direct link such as a circuit switched or packet switched network connection, or it can also be an Internet connection or a wireless connection as described previously. Once this connection has been made, the buyer provides his ID number at step BN5.4 and payment information at step BN5.5. Alternatively, provision of the buyer's ID number and payment information may be deferred until such time as purchase of a product or service is imminent. Payment information can include a credit card account number, bank account number or other payment method as shown in box BN5.6. After the buyer has been authorized to enter the system, he either selects a product from the list of products or he can select by searching through product database 3.9 as described earlier at step BN5.7. Once a product has been selected, Business Controller 2.0 generates bargain responses against the subsequent bargain requests that include bargain price offers at step BN5.8. At step BN5.9 Business Controller 2.0 determines whether the final bargain price is decided or if the buyer wants to exit. If buyer does not accept, then Business Controller 2.0 at step BN5.11 continues with the bargain process until a successful bargain is arrived at. In the event that the buyer's revised bargain price is not successful, then Business Controller 2.0 generates a new bargain price at step 5.8 for the buyer and proceeds with the bargaining process, and the process is continued as described herein until (i) a bargain price is mutually reached, (ii) the buyer exhausts all bargaining time allocated for the product, (iii) buyer exhausts all free chances available at buyer registration or issued thereafter pursuant to the registration agreement, (iv) the buyer is unwilling to request or purchase additional bargaining time or bargain chances, (v) the product becomes unavailable, or (vi) one of the parties discontinues the bargaining process.

If the buyer does not agree on a final bargain price for that product at step BN5.9, then Business Controller 2.0 continues the bargaining process at step 5.10 as previously provided or exits. On the other hand, if a final bargain price is agreed upon, the Business Controller 2.0 starts the billing process at step BN5.11 and the product is dispatched to the buyer and invoice and shipping details are sent to the buyer electronically or through regular mail. This process also initiates the payment process to the seller of that product.

Referring to FIG. BN6 there is described a process of online bargaining in which Business Controller 2.0 bargains with more than one buyer. At step BN6.1, Business Controller 2.0 generates a bargain price for buyer request. If the buyer does not accept the bargain price at step BN6.2, then Business Controller 2.0 asks buyer for another bargain price of his choice at step BN6.3. If the buyer accepts the bargain price at step BN6.2, then at step BN6.4, Business Controller 2.0 checks the presence of more than one buyer bargaining for the same product. If only one buyer exists then that buyer is informed about the request approval at step BN6.5 and then the buyer is billed at step BN6.6. If at step BN6.4, there is more than one buyer bargaining, then Business Controller 2.0 checks for the availability of that product at step BN6.7. In the event that the quantity of product desired is sufficient, then at step BN6.10 Business Controller 2.0 bargains individually with each buyer for sale of the product, as described herein. In the event that the quantity of product desired is limited, then at step BN6.8, Business Controller 2.0 informs the buyers concerning the limited product availability and at step BN6.9 sends a message to all buyers ask them whether they wish (i) to meet or beat the highest price then offered for the product or (ii) to submit a final bargain price for the product. Thereafter, Business Controller 2.0 initiates the billing process for the successful buyer at step BN6.11.

FIG. BN7 describes an embodiment in which a continuous communications channel is established between the buyer and Business Controller 2.0 using a message window. This message window can be a text-based computer “window” displayed on video monitor 5.10 of buyer interface 5.0. The buyer types buyer requests 1.2 directly to message window in a format specified by Business Controller 2.0 that appears on video monitor 5.10. Simultaneously Business Controller 2.0 processes these messages and generates responses for the buyers, which are then displayed on buyer's video monitor 5.10.

At step BN7.1 buyer selects product by entering a message in a message window and inputs buyer request 1.2 through buyer interface 5.0, the buyer and Business Controller 2.0 exchange a plurality of bargain requests and bargain responses at step BN7.2. These requests and responses contain the suitable bargain prices for both of them. If a bargain price has not been agreed at step BN7.3, and buyer has chosen not to pursue the system provided bargaining options defined herein, then buyer exits message window at step BN7.4 without buying the product. If the buyer and Business Controller 2.0 come to agreement on a bargain price, then the buyer leaves the message window at step BN7.5 using a log off procedure where he signals that a successful session has ended. At step BN7.6 all the relevant databases are updated to depict a successful transaction. The buyer account is billed using the various billing methodologies described in the billing embodiment at step BN7.7, and at BN7.8 the product is dispatched to the buyer.

Online Bargaining with Seller

FIG. SN1 describes the method by which the seller registers himself with Business Controller 2.0. At step SN1.1 seller connects to the online service. This online service could be AOL, CompuServe, Prodigy or other conventional online service providers. At step SN1.2 seller connects to Business Controller 2.0 and submits seller's personal profile at step SNI.3. Here seller may be asked to submit such items as name, address, phone number email address, city, state, country and the like, as shown in box SN1.4. This profile could be in a predefined format or seller may be asked to file an online form for this purpose. At step SN1.5 Business Controller 2.0 updates seller database and registers seller. Business Controller 2.0 generates a unique ID for the seller at step SN1.6. This ID number is used to get authorization from the system if the seller wants to communicate or sell another item at some other time. Seller can connect to Business Controller 2.0 using this ID to get information about the status of seller's product sale or any other queries. At step SN1.7 Business Controller 2.0 asks the seller to provide characteristics of the product to be put on sale.

FIG. SN2 illustrates the process by which the seller connects to Business Controller 2.0 and submits product characteristics to be put on sale. At step SN2.1 seller connects to online service, as described earlier. Thereafter seller connects to Business Controller 2.0 at step SN2.2. Here the seller provides his ID number along with the password for authorization at step SN2.3. At step SN2.4 the seller submits the characteristics of seller's product. These characteristics may be submitted using a predefined format specified by the Business Controller 2.0, or he may be asked to fill an online form for this purpose. This form may contain all the necessary details about the product that may be necessary to assess the value of that item by the Business Controller 2.0. The seller can also provide a photograph of the object in electronic format, if required. Product characteristics may contain information about the product, including category, make, model, year, type and the like, as described in box SN2.5. At step SN2.6, the seller specifies the mode of sale that is preferred for seller's product, for example, bargaining or open sale, as specified in box SN2.7.

Seller can specify that the product is to be sold in a limited period of time. This way Business Controller 2.0 can bargain with the interested buyer to come up with an optimum price for the product. One method includes placing the product on auction for purchase by a buyer that submits the highest bid. Another method can include selling the product to Business Controller 2.0 which, in turn, bargains with the seller to give seller his best bargain price range, after adding sales commission, license royalty, or other such transactional fee, and then later sells the product to the buyers. Yet another method can include listing the product through the Business Controller 2.0 and paying a sale commission based on minimal participation by Business Controller 2.0, bargaining directly with a prospective buyer for sale of the product. Still another method can include listing the product through the Business Controller 2.0 which, in turn, bargains with the seller to arrive at a price range for the product and, after adding sales commission, license royalty, or other such transactional fee, bargains directly with the seller to arrive at a final sales price for the product. These represent some of the methods that can be used, but it will be appreciated by those skilled in the art that many different methods or combinations of methods could be used, as well.

At step SN2.8 Business Controller 2.0 updates seller database and product database and generates a response at step SN2.9 according to the mode of sale preferred.

Referring to Fig. SN3, there is described the manner in which Business Controller 2.0 does the initial processing of the seller request 1.4. After the seller submits his request to Business Controller 2.0 at step SN3.1, Business Controller 2.0 determines at step SN3.2 whether the request is acceptable. The request should be in a format specified by Business Controller 2.0. Business Controller 2.0 can specify this format in an electronic form posted on its web page. The seller fills the form and submits it to Business Controller 2.0. Business Controller 2.0 then extracts all the required data and stores it in request database 3.3. In addition, Business Controller 2.0 determines whether the product appointed for sale can in fact be sold through Business Controller 2.0. This determination is made by processing through the Business rules component 2.8 of the Business Controller 2.0. If the request is not acceptable, then at step SN3.3 Business Controller 2.0 asks seller to send another request or modify the previous one. At step SN3.2, if the request is accepted then at step SN3.4 Business Controller 2.0 updates the request database and product database 3.9. Business Controller 2.0 starts the evaluation of the product at step SN3.5. Mode of sale for the request is checked at step SN3.6 and if it is to be put on sale then Business Controller 2.0 puts the product on sale at step SN3.7. If the seller wants to sell the product to the Business Controller 2.0, or sell or list the product through the Business Controller, as described herein, then Business Controller 2.0 generates a response for the seller request at step SN3.8. If the seller accepts the bargain price offered by Business Controller 2.0 at step SN3.9, then at step SN3.10 the product is listed for sale by bargaining. If the seller bargain price offered is not accepted then the seller at step SN3.11 continues the bargaining process until an agreement is reached or the seller decides to exit the system.

In FIG. SN4 there is illustrated the transactions involved when the seller wishes his product to be on open sale. The sale of seller's product may be accomplished by auction, bargaining or at fixed price. The system can be configured to place items on auction or to sell items procured using a procedure involving bids taken from a plurality of buyers, wherein the product is sold to the buyer with the highest bid. At step SN4. 1 seller submits his product to be sold through Business Controller 2.0. Business Controller 2.0 updates the product database at step SN4.2 and puts the product on its selling list at step SN4.3. This process can involve the generation of web pages wherein the product is advertised. The web pages are included in the buyer-searchable database so that buyers can access them. At step SN4.4 Business Controller 2.0 determines whether the product is sold. If the product has not been sold then a determination is made at step SN4.5 whether the time limit for selling the product has expired. If the limit expires then at step SN4.7 Business Controller 2.0 notifies the seller that the product was not sold during the preselected time period. At this time the seller and, or Business Controller 2.0 has the option of (i) extending the time limit, or (ii) checking the unaccepted bargain offers related to the product and choosing whether to accept any one of those bargain offers, or (iii) re-listing the product at a lower price, or (iv) offering additional incentives to the buyer. If the seller elects to proceed on the basis of one of the preceding options, then Business Controller 2.0 proceeds in accordance with the selected option. One of these options would include contacting the buyer that presented the bargain offer which seller has elected to determine whether the buyer is still interested in proceeding. If the buyer is interested, then a bargain price is arrived at; but if the buyer is no longer interested, then the seller is notified and the product is re-listed by Business Controller 2.0 in accordance with the revised request. At step SN4.5 if the time limit is not over then Business Controller 2.0 continues accepting bargain offers from the buyers at step SN4.6. If the product is sold at step SN4.4, then Business Controller 2.0 notifies seller about the deal and the price at which the product has been sold at step SN4.8. At the end of these processes, Business Controller 2.0 initiates the payment process at step SN4.9 in accordance with the agreed upon price and conditions of sale.

FIG. SN5 illustrates the process by which the seller bargains with Business Controller 2.0 to get the best bargain price for the product, sells it to Business Controller 2.0 or sells or lists the product through the Business Controller 2.0 with minimal participation thereby. Therefore, at step SN5.1, the seller connects to Business Controller 2.0. Seller provides an ID number for authorization at step SN5.2. The seller requests Business Controller 2.0 to start bargaining by sending a bargain request to Business Controller 2.0 at step SN5.3 attaching a bargain price range. At step SN5.4 Business Controller 2.0 generates a bargain response for the seller, specifying a more suitable price for the product. At step SN5.5, Business Controller 2.0 determines whether or not the seller accepts that bargain price range. If the seller accepts the price range then at step SN5.7 Business Controller 2.0 either acquires the product from seller and initiates the payment process or lists the product through Business Controller 2.0 and initiates the payment process upon sale of the product. If the seller does not accept the bargain price range at step SN5.5, Business Controller 2.0 asks seller to send another more suitable price range at step SN5.6. This process can continue until (i) the seller's best bargain price range is achieved, or (ii) Business Controller 2.0 stops bargaining after generating a limited number of bargain prices, or (iii) the expiration of time or exhaustion of chances allotted for bargaining with the seller, or (iv) seller elects to list the product on open sale. The best bargain price range will include the final bargain price that Business Controller 2.0 can offer for the product. Business Controller 2.0 can hold that price for a preselected period of time, upon request, if the seller is undecided about the acceptance of the offer. This procedure permits seller to accept the final bargain price at a more convenient time. Seller can also reject the final bargain price of the Business Controller 2.0 if it is not satisfactory.

Referring now to Fig. SN6, there is shown an embodiment in which the seller can inquire about the sale status of the product. At step SN6.1 seller connects to Business Controller 2.0 and provides seller's ID number for authorization at step SN6.2. At this point seller also provides the product ID and requests Business Controller 2.0 to provide seller with the status of sale of the product at step SN6.3. Business Controller 2.0 searches through the database and generates a report specifying the current and previous bargain offers at step SN6.4. At step SN6.5, this report is presented to seller and at step SN6.6 Business Controller 2.0 asks the seller if seller is willing to accept any one of the offers yet made, or reduce the price of the product, or offer additional incentives for sale of the product, or list the product on open sale.

Buyer Bidding Process

In one embodiment of the present invention, a procedure is described in which the buyer selects the products. Additionally, bidding and bargain negotiating procedures are described which allow the buyers to select the most appropriate product of their choice and get the best bargain.

After Business Controller 2.0 has generated the list of related products, the buyer may directly choose one or more products. The buyer might connect to the web page of Business Controller 2.0 to select from the given list of products. Now when the selection of products has been made, the buyer can start bargaining on the total price of the selected products. This way the buyer does not require bargaining on each and every product. The Business Controller 2.0 is responsible for bargaining on the total price of the products. It keeps track of each item's price and processes each item's bargain price individually. This way the buyer is not concerned with the individual price of each product, instead he bargains for a package deal that is more suitable, convenient and cost effective.

In another embodiment, if the seller wants to sell a number of products or a package containing several items, the Business Controller 2.0 then processes each item separately. The bargain price for each item is generated and summed to come up with a bargain price of the whole package. The system is capable of handling an unlimited number of buyers and sellers at the same time depending on the processing power of available hardware.

FIG. BB1 shows a bidding embodiment where the buyer bids for a product. If the bid is greater than the final bargain price then system accepts the bid otherwise rejects the bid request and keeps the product open for bidding. Buyer creates a bid request at step BB1.1 and transmits the request to Business Controller 2.0 at step BB1.2. At step BB1.3 Business Controller 2.0 checks in the bargain database whether the current bid meets the seller or system criteria. If the bid does not meet the seller or system criteria, then Business Controller 2.0 updates the bargain database at step BB1.4 and continues to request a new bargain price until the time allocated for bidding has expired, or buyer's chances are exhausted and buyer is unwilling to purchase additional chances, or the product has been sold or is no longer available for sale, or alternative similar products have not been offered for purchase, as provided herein. In these circumstances, the Business Controller 2.0 notifies the buyer about the previous bids including the highest bid and asks the buyer to bid again at step BB1.5.

In the alternative case, Business Controller 2.0 determines at BB1.3 whether a bid request meets the seller or system criteria. In these circumstances, the Business Controller 2.0 then determines from the bargain database whether this current bid is greater than the final bargain price at step BB1.6. If it is not, then the database is updated at step BB1.7 and Business Controller 2.0 notifies buyer that this bid cannot be accepted and asks the buyer to bid again at step BB1.8. Now if this bid is greater than the final bargain price then Business Controller 2.0 updates the databases at step BB1.9 and the user is notified about the acceptance at step BB1.10.

Referring to FIG. BB2, at step BB2.1 buyer creates buyer request. This request is then sent to Business Controller 2.0 at step BB2.2. At step BB2.3, the Business Controller 2.0 analyzes the buyer request. This analysis can contain procedures to compare the requested bid with the ones previously stored in the database or with the bids made by the same buyer, or provide assistance to the buyer. These procedures can also check whether the current bid is greater than the lowest or final bargain price. It is also possible to determine whether the product requested for is available for selling or not. At step BB2.4 the buyer is informed about the analysis of buyer request. The position of the current bid against comparative quotes is presented to the buyer. At step BB2.5 the Business Controller 2.0 continues the bidding process until the time period or chances allotted for bidding time are over, or the product is sold to one of the bidders, or the product is no longer available. At step BB2.6, Business Controller 2.0 notifies the successful buyer about the bid acceptance at the end of the bidding process.

Another form of bidding procedure is shown in FIG. BB3. At step BB3.1 buyer submits buyer request to Business Controller 2.0. Business Controller 2.0 processes request and updates relevant databases at step BB3.2. At this point, after processing the request, Business Controller 2.0 checks its databases to determine whether the bid request can be accepted or whether it should ask the buyer for a higher bargain price at step BB3.3. If the bid is acceptable then Business Controller 2.0 notifies buyer about the bid acceptance and initiates the billing process at step BB3.4. If the bid is not accepted at step BB3.3 then Business Controller 2.0 at step BB33.5 informs buyer that buyer's bid is either lower than final bargain price or lower than the highest bid yet made, or suggests alternative products 20 having similar features, or offers additional bidding assistance, as provided herein. At step BB3.6, Business Controller 2.0 presents the buyer with additional bidding incentives, such as bidding discounts (e.g. buy now, pay later or by one, get one free, bonus airline miles, free gifts, free shipment of product, product personalization by monograms or initials, and the like), or provides bidding information, including (i) a list of current bids, or (ii) average bids submitted, or (iii) comparative quotes submitted, and (iv) the minimum bargain price, or (v) suggested modification of the bidding price, and asks the user to bid again. At step BB3.7 buyer decides to change his request or increase his bid in order to be successful, thus continuing with the bidding process.

The bidding processes described here can be used with any of the given embodiments. It can use either an asynchronous or synchronous communications embodiment. When the bidding period terminates or the number of permissible bids is exhausted, the process of billing is started and the successful bidder is billed. The payment process follows the billing process where Business Controller 2.0 pays the seller in accordance with the terms and conditions of sale. The above-mentioned processes are carried out using the procedures described hereinabove. The system arranges for the product to be dispatched to the buyer and, together with invoice and shipping details optionally transmits to buyer a questionnaire asking buyer to comment about the bargaining or bidding experience and the service provided.

Billing and Payment Embodiment

FIGS. BP1-BP10 describe an exemplary structure of the billing and payment system for the current invention. Buyers are billed for the product they have successfully bargained for and payment is made to the sellers in accordance with the conditions of sale. Buyer invoicing and seller payment is accomplished using conventional credit card electronic charges, checks, Electronic Fund Transfer (EFT), digital cash, or the like. These payment methods are used herein for illustrative purposes, since there exist many equivalent payment methods, which are commonly known in the art and may also be used to practice the Internet bargaining method of the present invention.

In FIG. BP1, the billing process is initiated at step BP1.1 when Business Controller 2.0 transmits buyer response 1.7 to the buyer that accepted the bargain price. The price and tracking number of buyer request 1.2 is sent to billing database 3.8 at step BP1.2. Several billing methods can be used. The first billing method is payment after delivery, in which the buyer pays before receiving the product. The second can be a credit system, in which the buyer pays at the end of the billing period. Special credit terms can be offered to corporations using the billing system for procurement of products or services. For example, the billing terms could be net 60 days or the like based on the credit worthiness of the company.

In the payment after delivery method, billing processor generates a bill prior to dispatching the product to the buyer. It totals the amount owed by the buyer to the system at step BP1.3. For example, Business Controller 2.0 may require the buyer to prepay a token amount before the deal. The rest of the payment can be made after the product is received. Transaction records and balance information are stored in billing database 3.8. Money deposited with Business Controller 2.0 by each buyer is placed in an escrow account. Rather than actually depositing money with Business Controller 2.0 the buyer might instead be required to evidence the existence of sufficient credit to complete the purchase of the product or service. A credit card on file with Business Controller 2.0 or the payment terms/method is checked before bargain price acceptance notification/response is sent to the buyer. Alternatively, a third party billing system or an outside vender that provides billing services can be employed by the Business Controller 2.0.

If sufficient credit remains in the account then the billing process proceeds. If credit availablity is not sufficient to cover the total price, then the buyer is required to provide another credit or payment method acceptable to Business Controller 2.0. For Electronic Fund Transfers, the buyer's account information is stored in billing database 3.8 enabling Business Controller 2.0 to check the account balance before dispatching the product to the buyer.

In a credit method the billing processor 2.3 searches billing database 3.8 by buyer ID at the end of each billing period and totals the amount owed by each buyer. At step BP1.4 the preferred billing method is retrieved from buyer database 3.5 and the appropriate billing module (i.e. credit card, credit line, debit card, EFT, check, digital cash, electronic cash), is initiated at step BP1.5. In an alternate embodiment, the buyer does not pay for the product unless buyer is satisfied with it. This embodiment allows the buyer to examine the product for a preselected time period before making payment. Upon being satisfied with the product, the buyer sends an authorization for payment to Business Controller 2.0. Alternatively, Business Controller 2.0 automatically initiates the payment process after the preselected time period unless notified by the buyer that the product is unsatisfactory. If the buyer is not satisfied, a rejection message is sent to the Business Controller 2.0 and a product review process is started as described hereinafter in the customer satisfaction embodiment.

The process of paying the seller or vendor begins at step BP2.1 in FIG. BP2. At this point, the price of the product and the tracking number of the seller request 1.4 are sent to payment database 3.7. The ID of seller is extracted from product profile and stored in payment database 3.7. At step BP2.2 payment processor 2.6 searches payment database 3.7 by seller ID and totals the amount owed to the seller. Payment of the seller is effected in accordance with the conditions of sale and the mode of payment specified by the seller, which may contemplate payment after delivery, or by credit or the like. Payment after delivery is carried in accordance with the agreed upon terms and conditions of sale. The payment is transmitted to seller by the Business Controller 2.0 after receipt of payment from the buyer as per the terms and conditions of sale. In the credit method, the seller either establishes an account with the Business Controller 2.0 that maintains a balance for the seller or provides other alternatives, such as a credit card or an account with a third party to be credited. At step BP2.3, the preferred payment method is retrieved from seller database 3.6 and the appropriate payment module is initiated at step BP2.4. This step may be held up until payment has been received from the buyer.

Inasmuch as the buyers and sellers are not in direct contact, payment is made to Business Controller 2.0, in the case of the buyer, and received from Business Controller 2.0, in the case of the seller. The above methods describe a number of ways in which payment may flow from buyer to Business Controller 2.0 and from Business Controller 2.0 to seller. Set forth below are several methods by which Business Controller 2.0 may generate revenues for the provided services.

In one embodiment a flat fee is charged for every successful bargain. This fee is charged to buyer in addition to the price of the purchased product and also to the seller on the sale of his product. There could also be a flat fee that would cover any number of transactions over a given period of time, allowing the buyers and sellers to subscribe to the service. In another embodiment Business Controller 2.0 can charge a premium over the final bargain price of the product. This premium could be charged to either buyer or seller or both, once the deal is finalized.

In one embodiment, advertisers pay to have messages included in buyer request, seller request or WebPages of Business Controller 2.0. Advertising revenues partially or fully offset the cost of delivering the product from seller to buyer in the most time efficient manner. Once the amount owed by the buyer has been calculated, appropriate billing methods are initiated. FIG. BP3 illustrates an exemplary billing procedure using credit cards as a primary transaction tool. Simplicity is the advantage of this system. No bank account is necessary, and no paper transaction is required.

In FIG. BP3, at step BP3.1, Business Controller 2.0 looks up the credit card number of buyer in buyer database 3.5. At step BP3.2, this credit card number is transmitted to billing processor 2.3. Billing processor 2.3 contacts the credit card clearinghouse to get an authorization number at step BP3.3. The billable amount appears on the credit card statement of the buyer at step BP3.4. Now this amount authorization is posted to the account of Business Controller 2.0 by the credit card clearinghouse at step BP3 .5. At step BP3.6, Business Controller 2.0 updates billing database 3.8 to indicate that payment has been made or the Business Controller 2.0 uses a credit line billing procedure of the conventional type.

A similar process occurs when the amount to be paid to the seller has been calculated. In FIG. BP4, at step BP4. 1, Business Controller 2.0 looks up the credit card number of the seller in seller database 3.6. At step BP4.2, this credit card number is transmitted to payment processor 2.6. Thereafter, at step BP4.3 the payment processor contacts the credit card company or clearing house, or issuing bank, to obtain authorization. The sale proceeds are credited to the seller's account at step BP4.4, where it shows up as credit on his monthly bill or invoice. At step BP4.5, Business Controller 2.0 updates the payment database to indicate that payment has been made. At step BP4.6 Business Controller 2.0 transmits the notification of process completion to the seller.

FIGS. BP5 and BP6 illustrate a payment procedure involving standard bank checks. In billing the buyer, Business Controller 2.0 looks up his mailing address at step BP5.1 in buyer database 3.5. This address is transmitted to billing processor 2.3 at step BP5.2. A bill is mailed to the buyer at step BP5.3, and the check is received from the buyer at step BP5.4. At step BP5.5, Business Controller 2.0 updates billing database 3.8 to indicate that payment has been made. Subsequently, in FIG. BP6 at step BP6.1, Business Controller 2.0 looks up the mailing address of the seller in seller database 3.6. This information is transmitted to payment processor 2.6 at step BP6.2. Payment processor 2.6 then automatically cuts a hard copy check, payable to the seller, which check is mailed to the seller at step BP6.3. At step BP6.4, Business Controller 2.0 updates payment database 3.7 to indicate the completion of process and keeps the record on file for inquiry purposes.

Referring now to FIG. BP7 and BP8, there is illustrated a procedure in which funds are transferred via (“EFT”). At step BP7. 1 in FIG. BP7, the bank account number of the buyer is accessed in buyer database 3.5. This account number is transmitted to billing processor 2.3 at step BP7.2, followed by the transfer of funds directly into the account of Business Controller 2.0 at step BP7.3. At step BP7.4, Business Controller 2.0 updates billing database 3.8 to indicate that payment has been made.

Paying the seller is essentially the reverse process. In FIG. BP8, at step BP8.1, Business Controller 2.0 searches seller database 3.6 for the bank account number of the seller. This bank account number is transmitted to payment processor 2.6 at step BP8.2, which transfers the money directly into the account of the seller at step BP8.3. At step BP8.4, payment database 3.7 is updated to indicate that payment has been made, and archives the record for inquiry purposes.

In FIGS. BP9 and BPI0, there are shown commercial transaction procedures using digital cash. For billing the buyer, in FIG. BP9, Business Controller 2.0 accesses the buyer electronic delivery address in buyer database 2.0 at step BP9.1. This address is transmitted to billing processor 3.8 at step BP9.2. At step BP9.3, Business Controller 2.0 updates billing database 3.8 to indicate the payment at step BP9.4. Payment to the seller proceeds in the same way as in FIG. BP9.

After looking for the seller electronic delivery address in seller database 3.6 at step BP10.1, Business Controller 2.0 sends this address to payment processor 2.6 at step BP10.2. This address might be an email address if the digital cash is to be transferred by email, or it could be an IP address capable of accepting an online transfer of digital cash. At step BP10.3, the digital cash is downloaded to the seller and at the step BP10.4, Business Controller 2.0 updates payment database 3.7 to indicate that payment has been made.

Using these digital cash protocols, it is possible for the buyer to include payment along with buyer request 1.2 in email form. A buyer that has bargained successfully with the Business Controller 2.0 can include digital cash along with buyer's confirmation that the product is satisfactory.

Customer Satisfaction Embodiment

Although the previous embodiments describe the delivery of product as the end of the process, it will be understood that the present invention allows for follow-up procedures to ensure that the buyer is satisfied with the product and services provided. These procedures include review of buyer comments by Business Controller 2.0 as well as periodic testing of the products offered for sale by a system assigned expert or by the Business Controller 2.0 itself to verify product acceptability. The following figures describe these procedures.

In FIG. CS1 there is shown a customer satisfaction embodiment, the elements of which include buyer complaint reviewing and follow-up procedures. At step CS1.1, the buyer sends comments concerning the product acceptability to the Business Controller 2.0. Business Controller 2.0 analyzes the comments against product standards and buyer's database at step CS1.2. At step CS1.3 the system checks whether the analysis of the product comments sent by the buyer indicates satisfaction. If satisfaction is indicated, then the buyer or vendor database is updated to indicate that buyer is satisfied with the product at step CS1.4. At step CS1.5, if the product comments are unsatisfactory at the step CS1.3, then product database and seller databases are updated to indicate buyer's dissatisfaction with the product. A notice is issued to the vendor or seller containing advice concerning buyer's dissatisfaction with the product, at step CS1.6. Repeated notices based on buyer dissatisfaction with a product or service may result in temporary or permanent removal of a vendor or seller from the system database.

Referring to FIG. CS2, there is illustrated the handling and processing of comments concerning buyer satisfaction with products received by the buyer. At step CS2.1, the product is sent to the buyer. Thereafter, at step CS2.2, upon receiving the product buyer discovers that the product is unsatisfactory. This dissatisfaction of buyer could be attributable to several causes: (i) it could be caused by manufacturing defects, or (ii) the product does not conform with specifications contained in the buyer request, and the like. At step CS2.3, buyer returns the product to Business Controller 2.0, accompanied with a refund request based on the conditions of sale. The Business Controller 2.0 assigns an expert to analyze the validity of the buyer claim at step CS2.4. At step CS2.5, this assigned expert submits his report to Business Controller 2.0 after due investigation. At step CS2.6, Business Controller 2.0 checks the claim validity in the report. If the buyer claim is valid then Business Controller 2.0 refunds the money or replaces the product in accordance with the conditions of sale at step CS2.7 and updates all relevant databases. If, at step CS2.6, the claim is not valid then Business Controller 2.0 notifies the buyer about the denial or rejection of claim at step CS2.9 and updates its database at step CS2.10. Alternatively, the buyer may call the expert directly using a toll free number, to discuss and resolve issues concerning product dissatisfaction or offer comments and suggestions concerning the product or service.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A computer-based Internet bargaining system, comprising:
a. a processor;
b. a network interface;
c. a memory, data storage device;
d. an operating system;
e. a database management system;
f. a database; and
g. said system having a high bandwidth connection to the Internet.

2. A system as recited by claim 1, being configured to act as a web-server communicating with buyers and sellers using a communication mode selected from the group consisting of on-line, off-line and real-time.

3. A system as recited by claim 1, being further configured to process requests from buyers and/or sellers.

4. A system as recited by claim 1, being further configured to store data related to buyers and sellers, transactions, responses, bargain prices, and bargain deals for use in connection with database operations.

5. A system as recited by claim 1, being further configured to have an interface that provides means enabling buyers and sellers to access the products and/or services available through the system for sale.

6. A system as recited by claim 5, being further configured to enable buyers and sellers to input data related to a bargaining process.

7. A system as recited by claim 1, being further configured to be implemented on a distributed network.

8. A system as recited by claim 7, wherein said distributed network comprises the Internet and said interface comprises a Web browser.

9. A system as recited by 7, wherein said system further comprises a program for:
a. enabling buyers to register by agreeing to the terms and conditions of the system;
b. enabling buyers to submit a buyer profile containing preselected information about said buyers; and
c. enabling buyers to login to the system and bargain for goods and/or services.

10. A system as recited by claim 9, wherein said system program is further configured to issue a unique membership identification and password to said buyers and to sellers registering with the system.

11. A system as recited by claim 1, further configured to register users by:
a. asking for their profile and preselected information about said users;
b. storing said profile and said preselected information in a secure database; and
c. issuing to buyer and seller a unique membership identification number.

12. A system as recited by claim 9, wherein said system program is configured to authenticate the buyer and/or seller to use the service provided by the system program.

13. A system as recited by claim 9, wherein said system program is further configured to let the buyers or sellers register themselves at no cost or for a predetermined fee.

14. A system as recited by claim 1, wherein said system program is configured to provide buyer with preselected product information, including a list comprising products available for purchase through said system, product prices, and relative information concerning products, said preselected product information being provided after buyer logs on to the system by inputting buyer's membership ID and password.

15. A system as recited by claim 1, wherein said system program is further configured to receive from a remote buyer, a purchase request comprising: (a) a purchase offer;
and (b) a payment identifier specifying a financial account from which funds are appointed to be paid for purchase of a product or service under conditions meeting buyer requirements.

16. A system as recited by claim 1, wherein said program is further configured to initiate the use of financial account to effect said payment from said buyer.

17. A system as recited by claim 1, wherein said system program is further configured to receive payment from said buyer through an electronic settlement system and said settlement system comprises electronic fund transfer, digital cash, electronic cash and a credit card system selected from the group consisting of credit card and debit card.

18. A system as recited by claim 9, wherein said purchase offer from said buyer comprises information elements, including product quantity, product quality, purchase date, purchase price, payment terms, date of delivery, pick-up location and delivery location of said product or services.

19. A system as recited by claim 18, wherein said system program is further configured to notify said buyer that said purchase offer is accepted and buyer has entered into a legally binding contract with said system.

20. A system as recited by claim 18, wherein said system program is further configured to generate a bargain price response to said buyer purchase offer and transmit said bargain price response to said buyer.

21. A system as recited by claim 20, wherein said bargain price response includes an expiration date, and notification that said bargain price is revocable by the system at any time prior to said expiration date.

22. A system as recited by claim 18, wherein said system bargain offer includes notification that said offer expires if it is not accepted within a predetermined time period, and that said offer can be withdrawn by the system without notice prior to expiration of said preselected time period.

23. A system as recited by 18, wherein said buyer has a right to withdraw said bargain offer after acceptance by said system, provided that said buyer pays a specified penalty to said system.

24. A system as recited by claim 18, wherein said system program is further configured to notify said buyer that said bargain offer has lapsed in the event that said bargain offer expires without acceptance.

25. A system as recited by claim 18, wherein said system program is further configured to collect payment for the purchase from the buyer.

26. A system as recited by claim 18, wherein said system program is further configured to place payment collected from the buyer in an escrow account.

27. A system as recited by claim 18, wherein said system program is further configured to notify seller about the sale of seller's product.

28. A system as recited by claim 18, wherein said system program is further configured to transfer payment to the seller.

29. A system as recited by claim 1, wherein said system is further configured to communicate with the buyer without identifying the seller.

30. A system as recited by claim 1, being configured to communicate with the seller without identifying the buyer.

31. In a system for electronically making a binding contract between a buyer and a seller, the improvement comprising the steps of;
(a) receiving a purchase offer from said buyer containing a buyer request and a buyer payment identifier specifying a financial account from which funds may be paid for a purchase meeting criteria set by the buyer; and
(b) notifying said buyer concerning acceptance or rejection of said purchase offer.

32. A system as recited by claim 31, being further configured to receive payment through a credit card.

33. A system as recited by claim 31, being further configured to initiate use of said financial account to effect payment of said funds from buyer.

34. A system as recited by claim 31, wherein said purchase comprises plural buyer request elements, including product quantity, product quality, purchase date, purchase price, payment terms, date of delivery, pick-up location and delivery location of said product or services.

35. A system as recited by claim 1 having a processor for processing the sale of a product, comprising:
a. a common port for obtaining a purchase offer for said product from said buyer and a payment identifier from which payment for the product may be made;
b. said processor being configured to present said buyer with a plurality of available products; and
c. said buyer being enabled by said system to bargain for at least one product selection.

36. A system as recited by claim 35, being configured to provide a channel of communication between said buyer and said seller without revealing their identities.

37. A system as recited by claim 35, which provides incentives to the buyer for making said product selection.

38. A system as recited by claim 35, which is operative to bargain for said product selected by said buyer during a bargaining process adapted to arrive at an acceptable bargain price.

39. A system as recited by claim 35, wherein said processor, after accepting said bargain price, notifies said buyer about the acceptance and draws payment for said product from said payment identifier.

40. A system as recited by claim 1 for processing the sale of a package of component items, comprising a communications port for receiving a purchase offer from a buyer containing product requirements for each of said component items of said package and a bargain price for said package.

41. A system as recited by claim 40, wherein said processor is further configured to:
a. disassemble said package purchase offer into a plurality of component items;
b. determine for each of the component items whether a bargain offer can be accepted or rejected; and
c. bind said buyer to purchase said package if the system accepts said bargain price for the package.

42. A system as recited by claim 40, wherein said processor is configured to receive a purchase offer for each component item of said package.

43. A system as recited by claim 40, wherein said processor initiates use of a payment identifier to collect funds upon acceptance of a bargain offer.

44. A system as recited by claim 40, wherein each component item of said package has a price based on the percentage of the market value of said component item to total market value of all component items in said package.

45. A system as recited by claim 40, wherein a bargain offer response for each component item in said package and a bargain price for said package is generated by said system and sent to said buyer with notice that buyer acceptance must be effected during a preselected time period.

46. A system as recited by claim 45, wherein said bargain offer response generated by said system includes a total price, and a portion of said total price is reserved as a margin.

47. A system as recited by claim 45, wherein said processor decreases the price of one or more component items of said package, or decreases the price of said package, thereby generating a new bargain offer response that is more acceptable to the buyer.

48. A system as recited by claim 45, in which said processor decreases the price of at least one component of said package, or decreases the price of said package without disclosing the price reduction of the component items in said package, thereby accruing a new counter bargain offer which is more acceptable to said buyer and said system.

49. A system as recited by claim 45, wherein said buyer is bound to purchase said package of component items if said bargain price is accepted by said system, and said price of said component items is not disclosed to said buyer.

50. A system for using a computer to facilitate a transaction between a buyer and one of a plurality of sellers, comprising:
a. inputting into said computer a purchase offer which includes information about the product;
b. inputting into said computer a bargain offer which includes an offer price;
c. inputting into said computer a payment mode identifier associated with said bargain offer; and
d. transmitting each of said purchase offer, said bargain offer and said payment mode identifier to said system.

51. In a system having a computer which receives a bargain offer containing a price offered by a buyer for a product, the improvement wherein a processor performs steps which comprise:
a. validating said bargain offer;
b. determining availability of said product; and
c. storing information concerning bargain offer validity and said product in a database.

52. A system as recited by claim 50, being operative to generate an acknowledgement response for the bargain offer received from the buyer, said offer being assessed by said system to determine the validity thereof in accordance with the following criteria: (a) said bargain offer for said product has expired; (b) said product is unavailable; and (c) a predetermined amount is not available in the payment mode identifier.

53. A system for processing the sale and purchase of items, comprising:
a. a storage device;
b. a processor;
c. said storage device being operative to store programs for controlling said processor, and said processor being operative with said program to receive bargain offers from said buyer, including conditions for purchase and a payment identifier, thereby defining said bargain offer.

54. A system as recited by claim 53, further configured to receive bargain offers from said sellers, including conditions for sale of said product, details about said product, a seller price for said product and a payment identifier specifying mode of payment.

55. A system as recited by claim 53, wherein said processor has a processing program operative to query each buyer to obtain therefrom a unique member ID and password, for use in identifying a buyer from which a bargain offer is received.

56. A system as recited by claim 53, wherein said processor has a processing program operative to query each seller to obtain therefrom a unique member ID and password, for use in identifying a seller from which a bargain offer is received.

57. A system as recited by claim 53, further configured to verify the legitimacy/authenticity/condition of said product and the pricing of products listed by the seller, said verification comprising the steps of:
a. obtaining issuance of an Authenticity certificate from an authorized appraiser;
b. obtaining a Price evaluation from said authorized appraiser;
c. checking product certification at the time of pick-up or delivery; and
d. checking condition of said product at the time of pickup and/or delivery.

58. A system as recited by claim 57, further configured to permit the product to be evaluated and appraised by an authorized appraiser nominated by the system.

59. A system as recited by claim 57, further configured to permit the seller to pay the cost of evaluation, so that the cost is not included in the price of the product.

60. A system as recited by claim 57, further configured to permit the cost of evaluation to be paid by the system to its nominated appraiser so that the cost is included in the price of the product.

61. A system as recited by claim 57, further configured to (a) initiate legal action against a seller that fails to produce said product at time of pick-up, said legal action seeking redress in the form of legal remedies, including a court order preventing payment to seller; (b) charge seller a predetermined penalty, as specified in said registration agreement; or (c) cancel seller's registration, as specified in said registration agreement

62. A system as recited by claim 57, further configured to provide for agreement between said buyer and said seller at time of registration permitting said system to stop payment to the seller for sale of said product if seller fails to produce said authentication certificate or produces a false certificate at time of pick-up.

63. A system as recited by claim 57, wherein said processor is further operative with said processing program to validate a received bargain offer signal from said buyer and/or seller and thereby determine whether said received offer signal meets predetermined validation criteria.

64. A system as recited by claim 63, wherein said processor is further operative with the program to process said received bargain offer from said buyer and/or seller, only if said step of validation determines that said received bargain offer meets predetermined criteria.

65. A system as recited by claim 63, wherein said processor is further configured to start the bargain process by generating bargain prices for said buyer and said seller continuously, until a point is reached where (a) an acceptable price is arrived at, or (b) said buyer or said seller stop bargaining; or (c) said product becomes unavailable; or (d) said bargain price generated by said system reaches its limit; or (e) said buyer or said seller runs out of bonus chances or does not request additional chances; or (f) said predetermined time period allotted for bargaining has expired.

66. A system as recited by claim 65, wherein said processor is further operative with said program to stop the bargaining process in response to a request from buyer and/or seller without charging any penalty or fees.

67. A system as recited by claim 65, wherein the processor is further operative with the program to accept the bargaining offer containing a price offer by said buyer or said seller after validating that the offer meets predetermined criteria.

68. A system as recited by claim 65, wherein the processor is further operative with the program to process an acceptance received from the buyer after validating that said bargain offer meets predetermined criteria, and store said bargain offer in said database.

69. A system as recited by claim 65, wherein the processor is further operative with the program to transmit a notification to the buyer, which notification indicates that buyer's bargain offer is less than certain minimum predetermined offer criteria and asks said buyer to send another bargain offer, or quit the bargaining process, or to follow a bargaining recommendation provided by a “Bargain Guru”.

70. A system as recited by claim 65, further configured to permit buyer to request free chances, buy more chances at a predetermined chance purchase price, or redeem purchase points to buy more chances to bargain after the system program has stopped bargaining for a particular product or service.

71. A system as recited by claim 70, further configured to permit buyer and/or seller to use at least one bargain chance provided by the system to continue bargaining until all chances issued to buyer and seller have been used or a bargain price is accepted.

72. A system as recited by claim 70, further configured to permit buyer to use one or more bargain chances provided by the system to continue bargaining until all chances issued to buyer have been used, said buyer having an election to (a) request free chances; or (b) to purchase additional chances for a predetermined chance purchase price, or (c) to redeem purchase points applicable toward purchase of additional chances, or (d) to accept the system bargain price, or (e) to follow a purchase recommendation provided by a “Bargain Guru”.

73. A system as recited by claim 70, further configured to indicate to the buyer that a bargain price generated by buyer's bargain, upon being accepted by said system, will remain active, subject to acceptance by said buyer, during a predetermined time period, provided that the product or service appointed for purchase remains available.

74. A system as recited by claim 70, further configured to notify the buyer and/or seller concerning the status of shipment in transit, said notification being provided (a) at the time of sale; and (b) periodically in response to a buyer or seller request after purchase of said product.

75. A system as recited by claim 70, wherein the processor is further operative with the program to initiate use of a payment identifier to collect funds.

76. A system as recited by claim 1, further configured to bargain with other existing systems on behalf of the buyer, said bargain being effected on a no-cost basis or for a fee.

77. A system as recited by claim 1, further configured to issue licenses to other existing systems or customers granting rights to use the claimed system for selling products and/or services.

78. A system as recited by claim 1, operable upon buyer's request to transfer the buyer to a toll free number to continue bargaining for a product.

79. A system as recited by claim 1, further configured to (a) permit buyers to purchase wild card discounts or special promotions from the system, and/or (b) award such wild card discounts or special promotions on special bargain deals, and/or (c) award such wild card discounts or special promotions randomly or to privileged customers, said buyers being notified of such wild card discount or special promotion awards by surprise pop-up messages or by instant messaging, or by means of a “Bargain Guru”.

80. A system as recited by claim 79, further configured so that the buyer can use the wild card discounts or special promotions to enhance bargaining opportunities, by buying bargain chances or obtaining a certain percentage reduction of a final bargain offer, said enhanced bargain opportunities being specified in a wild card discount or special promotion pop-up message, or by instant messaging, or by means of a “Bargain Guru”.

81. A system as recited by claim 79, further configured to provide a graphic display, such as a “Bargometer” or a “Bargainmeter”, adapted to graphically depict a probability for system acceptance of buyer's offer for purchase of the product.

82. A system as recited by claim 79, further configured to award purchase incentives selected from the group consisting of: (a) bonus chances made available upon the purchase of products and/or services, or in response to buyer request for free bonus chances, or to encourage timely payment by regular customers and (b) purchase points provided upon purchase products.

83. A system as recited by claim 79, further configured to track buyer's accumulation of a predetermined number of purchase points, and notify buyer that said accumulated purchase points are applicable to provide additional discounts, offers or enhanced bargaining opportunities, in accordance with said registration agreement.

84. A system as recited by claim 79, configured to provide at least one pop-up surprise message during bargaining, said surprise message according an additional discount on the product, or a special/promotional offer, such as “buy one, get one free”, with respect to said product.

85. A system as recited by claim 1, configured to sell said available products using an on-line retail store sales format.

86. A system as recited by claim 1, configured to place items on auction or to sell items procured using a procedure involving bids taken from a plurality of buyers, wherein the product is sold to the buyer with the highest bid.

87. A system as recited by claim 1, further configured to provide for sale a product procured by the highest bidder in accordance with standard auction procedures, said standard auction procedures being initiated in the event that availability of said product is limited, or said product is in high demand.

88. A system as recited by claim 87, being further configured to permit the bargain sale price to be placed on hold for a predetermined amount of time upon request by the buyer, said holding of bargain sale price being effectuated either with or without a fee which is predetermined at registration.

89. A system as recited by claim 87, further configured to stop sale of the product to the buyer in the event that said buyer responds after the expiration of a predetermined amount of time.

90. A system as recited by claim 87, wherein the system is further configured to permit withdrawal of buyer's bid after acceptance by the system with or without payment of a specified penalty to the system.

91. A system as recited by claim 1, wherein said system effectuates worldwide purchase and/or sale of goods and services through its own website; by franchising of said system; by licensing a business module; and through affiliate programs with other existing business systems or websites.

92. A system as recited by claim 1, configured to buy and/or sell goods and services on a local and regional basis through its own website; by franchising said system; licensing a business module; and through affiliate programs with other existing business systems or websites.

93. A system for bargaining over the Internet, comprising:
a. a processor;
b. a network interface;
c. a memory;
d. a data storage device;
e. an operating system;
f. a database management system
g. a database; and
h. and a high bandwidth connection to the Internet
i. said system being configured to act on behalf of a customer comprised of a buyer or a seller, and perform a bargaining process comprising the steps of:
j. generating a bargain offer proposed by said customer;
k. accepting or rejecting a counter offer proposed by said system for said customer;
l. providing choices available to said customer and assisting said customer with product selection and bidding opportunities to arrive at a best bargain price;
m. guiding said customer throughout said bargaining process using “Bargain Guru” recommendations including comparative quotes, product ratings, alternative products, and pricing assistance.

94. A system as recited by claim 93, further configured to obtain a deal best suited to the buyer through the system by providing said comparative quotes for a particular product appointed for purchase from the system, said comparative quotes being obtained by searching for information or prices published by other extant systems or websites that sell substantially the same product.

95. A system as recited by claim 93, said system being further configured to (a) permit said buyer to resume bargaining for said product upon finding on another website or extant system a price for substantially the same product or services that is lower than the final bargain price, and (b) reduce said bargain price to a value less than or equal to said found price for substantially the same product or services.

96. A system as recited by claim 93, adapted to provide links to a site offering the lowest possible price for a particular product or service, in the event that said system cannot provide substantially the same price or a lower price through its vendors.

97. A system as recited by claim 12, further configured to use cartoon characters to provide bargaining assistance to buyer and seller, said cartoon characters being adapted to provide information from said database using a textual dialogue or voice dialogue.

98. A system as recited by claim 12, wherein said information provided by said cartoon characters includes: (a) major characteristics of said product; (b) bargain price; (c) purchasing strategies; (d) complementary remarks and encouraging comments that congratulate buyer on successful bargains and reinforce buyer's propensity to use said Internet bargaining process for purchase of other products and services; (e) purchasing assistance; (f) bargaining assistance; and (g) product selection assistance.

99. A system as recited by claim 12, wherein said website is provided with a box for comments and feedback from said customers, to indicate location of substantially the same product or service at a cheaper rate or price on other existing systems and websites, and set forth user complaints and compliments regarding the product or service.

100. A system as recited by claim 93, configured to bargain for, auction or purchase a product or service at retail on behalf of system customers from vendors or other websites or from other extant systems, said bargain for, auction or purchase of said product or service being initiated upon buyer's request, and being effectuated at no extra cost to buyer if said product or service is not listed on said system website, or if said product or service is cheaper on said other sites or systems.

101. A system as recited by claim 93, being further configured to designate a human representative for said purpose upon buyer request.

102. A system as recited by claim 93, said system being further configured to charge buyer a predetermined fee for acting on buyer's behalf.

103. A system as recited by claim 93, being further configured to increase the price of the product by adding thereto a fee for bargaining on behalf of a customer.

104. A system as recited by claim 12, further configured to customize said product by (a) gift wrapping, or (b) applying thereto a monogram, or (c) packaging said product with other product(s) and selling it as a combination product package.

105. A system as recited by claim 104, further configured so that other products in the package are offered at no price to thereby provide for purchaser to buy one gift and get one free.

106. A system as recited by claim 105, configured so that each of a plurality of products in said combination product package is from the same vendor.

107. The system in claim 105, further configured such that said other products in said combination product package are from a plurality of different vendors.

108. A system as recited by claim 12, further configured so that, upon declining to purchase a product, a customer is precluded by said system from purchasing substantially the same product for a predetermined period of time.

109. A system as recited by claim 12, further configured to permit said buyer to resume bargaining for substantially the same product that buyer previously declined to purchase, provided that such product is still available for purchase.

110. A system as recited by claim 12, further configured wherein the system may not sell the same product at the price that the buyer declined earlier, whereby buyer is required to repeat the bargaining process.

111. The system in claim 12, where the system is further configured configured to prevent the customer from logging on to said program or bargaining or using customer's existing account if the customer has been found to disobey the terms and conditions of the system that customer agreed to accept at the time of registration.

112. A computer-based interactive program, comprising:
a. a payment processor module;
b. a bargain formulation processor module;
c. a database management module;
d. a network interface module;
e. each of said payment processor, bargain formulation, database management and network interface modules running on an operating system, in coordination with a system, as recited by claim 1; and
f. said program being further configured for attachment thereto of at least one additional module.

113. A computer program as recited by claim 112, configured to run on a web-server communicating with buyers and sellers using a communication mode selected from the group consisting of on-line, off-line and real-time.

114. A computer program as recited by claim 112, being further configured to process requests from buyers and sellers.

115. A computer program as recited by claim 112, being further configured to store data related to buyers and sellers, transactions, responses, bargain prices, and bargain deals for use in connection with database operations.

116. A computer program as recited by claim 112, being further configured to have an interface that provides means enabling buyers and sellers to access the products and/or services available through the system for sale.

117. A computer program as recited by claim 116, being further configured to enable buyers and sellers to input data related to a bargaining process.

118. A computer program as recited by claim 112, being further configured to be implemented on a distributed network.

119. A computer program as recited by claim 118, wherein said distributed network comprises the Internet and said interface comprises a Web browser.

120. A computer program as recited by claim 118, wherein said computer program further comprises a program for enabling buyers to (a) register by agreeing to the terms and conditions of the system (b) submit a buyer profile containing preselected information about said buyers, and (c) login to the system and bargain for goods and/or services.

121. A computer program as recited by claim 120, wherein said computer program is further configured to issue a unique membership identification and password to said buyers and to sellers registering with the system.

122. A computer program as recited by claim 112, further configured to register users by (a) asking for their profile and preselected information about said users; (b) storing said profile and preselected information in a secure database; and (c) issuing to buyer and seller a unique membership identification number.

123. A computer program as recited by claim 120, wherein said computer program is configured to authenticate buyer and/or seller to use services provided by the computer program.

124. A computer program as recited by claim 120, wherein said computer program is further configured to permit buyer or seller registration at no charge or for a predetermined fee.

125. A computer program as recited by claim 112, wherein said system is configured to provide buyer with preselected product information, including a list comprising products available for purchase through said system, product process and relative information concerning products, said preselected product information being provided after buyer logs onto the system by inputting buyer's membership ID and password.

126. A computer program as recited by claim 112, wherein said computer program is further configured to receive from a remote buyer a purchase comprising:
a. a purchase offer; and
b. a payment identifier specifying a financial account from which funds are appointed to be paid for a purchase of a product or service under conditions meeting buyer's requirements.

127. A computer program as recited by claim 112, wherein said computer program is further configured to initiate use of a financial account to effect said payment from said buyer.

128. A computer program as recited by claim 112, wherein said computer program is further configured to receive payment from said buyer through an electronic settlement system and said settlement system comprises electronic fund transfer, digital cash, electronic cash and a credit card system selected from the group consisting of credit card and debit card.

129. A computer program as recited by claim 120, wherein said purchase offer from said buyer comprises information elements, including product quantity, product quality, purchase date, purchase price, payment terms, date of delivery, pickup location and delivery location of said product or services.

130. A computer program as recited by claim 129, wherein said system computer program is further configured to notify buyer that buyer's purchaser offer is accepted and buyer has entered into a legally binding contract with the system.

131. A computer program as recited by claim 129, wherein said computer program is further configured to generate a bargain price response to buyer's purchase offer and transmit said bargain price response to said buyer.

132. A computer program as recited by claim 131, wherein said bargain price response includes an expiration date and notification that said bargain price response is revocable by the system at any time prior to said expiration date.

133. A computer program as recited by claim 131, wherein said system bargain offer includes notification that said offer expires if not accepted within a predetermined time period, and that said offer can be withdrawn by the program without notice prior to expiration of said preselected time period.

134. A computer program as recited by claim 131, wherein buyer has the right to withdraw said bargain offer after acceptance by said system, provided that said buyer pays a specified penalty to said system.

135. A computer program as recited by claim 131, wherein said computer program is further configured to notify buyer that said bargain offer has lapsed in the event that said bargain offer expires without acceptance.

136. A computer program as recited by claim 131, wherein said computer program is further configured to collect payment for said purchase from the buyer.

137. A computer program as recited by claim 131, wherein said computer program is further configured place payment collected from the buyer in an escrow account.

138. A computer program as recited by claim 131, wherein said computer program is further configured to notify seller in the event of a sale of seller's product.

139. A computer program as recited by claim 131, wherein said computer program is further configured to transfer payment to the seller.

140. A computer program as recited by claim 112, wherein said system is further configured to communicate with the buyer without identifying the seller.

141. A computer program as recited by claim 112, being further configured to communicate with the seller without identifying the buyer.

142. In a computer program for electronically making a binding contract between buyer and seller, the improvement comprising the steps of;
a. receiving a purchase offer from the buyer containing a buyer request and a buyer payment identifier specifying a financial account from which funds may be paid for a purchase meeting criteria set by the buyer;
b. notifying said buyer concerning acceptance or rejection of said purchase offer.

143. A computer program as recited by claim 142, wherein said computer program is further configured to receive payment through a credit card.

144. A computer program as recited by claim 142, being further configured to initiate use of said financial account to effect payment of said funds from buyer.

145. A computer program as recited by claim 142, wherein said purchase comprises plural buyer request elements, including product quantity, product quality, purchase date, purchase price, payment terms, date of delivery and location and delivery of said product or services.

146. A computer program as recited by claim 112, having a processor for processing the sale of a product comprising:
a. a common port for obtaining a purchase offer for said product from said buyer;
b. a payment identifier from which payment for such product may be made;
c. a processor configured to present to buyer a plurality of available products; and
d. program bargain means for enabling said buyer to bargain for at least one of said products.

147. A computer program as recited by claim 146, said program being configured to provide a channel of communication between said buyer and said seller without revealing their identities.

148. A computer program as recited by claim 146, said program being configured to provide incentives to the buyer for making said product selection.

149. A computer program as recited by claim 146, which is operative to bargain for said product selected by said buyer during a bargaining process adapted to arrive at an acceptable bargain price.

150. A computer program as recited by claim 146, wherein said processor, after accepting said bargain price, notifies said buyer about the acceptance and draws payment for said product from said payment identifier.

151. A computer program as recited by claim 112, for processing the sale of a package of component items, comprising: a communications port for receiving a purchasse offer from a buyer containing product requirements for each of said component items of said package and a bargain price for said package.

152. A computer program as recited by claim 151, wherein said processor is further configured to: (a) disassemble said package purchase offer into plurality of component items; (b) determine for each of the component items whether a bargain offer can be accepted or rejected; and (c) bind said buyer to purchase the package if the program accepts said bargain price for the package.

153. A computer program as recited by claim 151, wherein said processor is configured to receive a purchase offer for each component item of said package.

154. A computer program as recited by claim 151, wherein said processor initiates use of a payment identifier to collect funds upon acceptance of a bargain offer.

155. A computer program as recited by claim 151, wherein each component item of said package has a price based on the percentage of the market value for said component item to the total market value of all component items in said package.

156. A computer program as recited by claim 151, wherein a bargain offer response for each component item in said package and a bargain price for said package is generated by said program and sent to said buyer with notice that buyer acceptance must be effected during a preselected time period.

157. A computer program as recited by claim 156, wherein said bargain offer response generated by said program includes a total price, and a portion of the total price is reserved as a margin.

158. A computer program as recited by claim 156, wherein said processor decreases the price of one or more component items of said package, or decreases the price of said package, thereby generating a new bargain offer response that is more acceptable to the buyer.

159. A computer program as recited by claim 156, wherein the processor decreases the price of at least one component of said package, or decreases the price of said package without disclosing the price reduction of the component items in said package, thereby accruing a new counter bargain offer which is more acceptable to said buyer and said system.

160. A computer program as recited by claim 156, wherein said buyer is bound to purchase said package of components if said bargain price is accepted by said program, and said price of said component items is not disclosed to said buyer.

161. A computer program for using a computer to facilitate a transaction between a buyer and at least one seller, which comprises:
a. inputting into said computer a purchase offer which includes information about the product and a bargain offer which includes an offer price;
b. inputting into said computer a payment mode identifier associated with the bargain offer; and
c. transmitting said inputted information to said computer program.

162. In a computer program which receives a bargain offer containing a price offered by a buyer for a product, the improvement wherein a processor performs steps which comprise:
(a) validating said bargain offer;
(b) determining availability of said product; and
(c) storing information concerning bargain offer, validity and said product in a data base.

163. A computer program as recited by claim 161, being operative to generate an acknowledgement responsefor a bargain offer received from said buyer, said bargain offer being assessed by said system to determine the validity thereof in accordance with the following criteria:
(a) said bargain offer for said product has expired; (b) said product is unavailable; and
(c) a predetermined amount is not available in the payment mode identifier.

164. A computer program for processing the sale and purchase of items, comprising:
a. a storage device;
b. a processor;
c. said storage device being operative to store programs for controlling said processor;
d. said processor being operative with said program to receive bargain offers from said buyer; and
e. said bargain offers including a condition for purchase of said product and a payment identifier thereby defining the bargain offer.

165. A computer program as recited by claim 164, further configured to receive bargain offers from a plurality of sellers, said bargain offers including:
a. conditions for sale of the product;
b. details about the product;
c. a seller price for the product; and
d. a payment identifier specifying mode of payment.

166. A computer program as recited by claim 164, wherein said processor has a processing program operative to query each buyer to obtain therefrom a unique member ID and password, for use in identifying a buyer from which a bargain offer is received.

167. A computer program as recited by claim 164, wherein said processor has a processing program operative to query each seller to obtain therefrom a unique member ID and password, for use in identifying a seller from which a bargain offer is received.

168. A computer program as recited by claim 164, said processor program being further configured to verify legitimacy/authenticity/condition of said product or service and the pricing of products or services listed by the seller, said verification being carried out by a process comprising the steps of:
a. issuing an authenticity certificate from an authorized appraiser;
b. issuing a price evaluation from said appraiser;
c. checking product certification at time of pick-up or delivery; and
d. checking condition of said product at time of pick-up and/or delivery.

169. A computer program as recited by claim 168, further configured permit the product to be evaluated and appraised by an authorized appraiser nominated by the system.

170. A computer program as recited by claim 168, further configured to permit the seller to pay the cost of evaluation, so that the cost is not included in the price of the product.

171. A computer program as recited by claim 168, further configured to permit the cost of evaluation to be paid by the system to its nominated appraiser so that the cost is included in the price of the product.

172. A computer program as recited by claim 168, further configured to (a) initiate legal action against a seller that fails to produce said product at time of pick-up, said legal action seeking redress in the form of legal remedies, including a court order preventing payment to seller; (b) charge seller a predetermined penalty, as specified in said registration agreement; or (c) cancel seller's registration, as specified in said registration agreement

173. A computer program as recited by claim 168, further configured to provide for agreement between buyer and said seller at time of registration, permitting said system to stop payment to the seller for sale of said product if seller fails to produce said authentication certificate or produces a false certificate at time of pick-up.

174. A computer program as recited by claim 168, wherein said processor is further operative with said processing program to validate a received bargain offer signal from said buyer and/or seller thereby determine whether said received offer signal meets predetermined validation criteria.

175. A computer program as recited by claim 174, wherein said processor is further operative with said processor program to process said received bargain offer from said buyer and/or seller, if said step of validation determines that said received bargain offer meets predetermined criteria.

176. A computer program as recited by claim 174, wherein said processor is further configured to start said bargain process by generating bargain prices for said buyer and said seller continuously, until a point is reached where (a) an acceptable price is arrived at; or (b) said buyer or said seller stops bargaining; or (c) said product becomes unavailable; or (d) said bargain price generated by said system reaches its limit; or (e) said buyer or said seller runs out of bonus chances or does not request additional chances; or (f) said predetermined time period allotted for bargaining has expired.

177. A computer program as recited by claim 176, wherein said processor is further operative with said processing program to stop the bargaining process in response to a request of the buyer and/or seller without charging any penalty or fees.

178. A computer program as recited by claim 176, wherein said processor is further operative with said processing program to accept a bargaining offer containing seller's price offer after validating that said bargaining offer meets predetermined criteria.

179. A computer program as recited by claim 176, said processor being further operative with said processing program to process an acceptance received from the buyer after validating that a bargain offer meets predetermined criteria, storing said bargain offer in said database.

180. A computer program as recited by claim 176, said processor being further operative with said program to transmit a notification to the buyer indicating that buyer's bargain offer is less then certain minimum predetermined offer criteria and asking the buyer to submit another bargain offer, or quit the process, or to follow a bargaining recommendation provided by a “Bargain Guru”.

181. A computer program as recited by claim 176, further configured to permit buyer to (a) request free chances, or (b) buy more chances for at a predetermined chance purchase price, or (c) redeem purchase points to buy more chances to bargain after the system program has stopped bargaining for a particular product or service.

182. The computer program in claim 181, further configured to permit buyer and/or seller use at least one bargain chance provided by the program to continue bargaining until all chances issued to buyer or seller have been used or until a bargain price is accepted.

183. A computer program as recited by claim 181, further configured to permit buyer to use one or more bargain chances provided by the program to continue bargaining until all chances issued to buyer have been used; said buyer having an election to (a) request free chances; or (b) purchase additional chances for a predetermined chance purchase price; or (c) to redeem purchase points applicable towards purchase of additional chances; or (d) to accept the system bargain price; or (e) to follow a purchase recommendation provided by a “Bargain Guru.

184. A computer program as recited by claim 181, further configured to indicate to the buyer that the bargain price generated by buyer's bargain offer will remain active, subject to acceptance by said buyer during a predetermined time period, provided that the product or service appointed for purchase remains available.

185. A computer program as recited by claim 181, further configured to notify the buyer and/or seller about the state of shipment in transit, said notification being provided (a) at the time of sale; or (b) periodically, in response to a buyer or seller request after purchase of said product.

186. A computer program as recited by claim 181, wherein said processor is further operative with said program to initiate use of a payment identifier to collect funds.

187. A computer program as recited by claim 112, further configured to bargain with other existing systems on behalf of the buyer, said bargain being effected on a no cost basis or for a fee.

188. A computer program as recited by claim 112, further configured to issue licenses to other extant systems or customers granting rights to use an Internet bargaining program for selling products and/or services.

189. A computer program as recited by claim 112, further operative, at buyer request, to transfer buyer to a toll free number to continue bargaining for a selected product.

190. A computer program as recited by claim 112, further configured to (a) permit buyers to purchase wild card discounts or special promotions from the system and/or (b) award such wild card discounts or special promotions on special bargain deals, and/or (c) award such wild card discounts or special promotions randomly or to privileged customers, said buyers being notified of such wild card discount or special promotion awards by surprise pop-up messages, or by instant messaging, or by means of a “bargain Guru”.

191. A computer program as recited by claim 190, further configured so that the buyer can use said wild card discounts or special promotions to enhance bargaining opportunities, buy buying bargain chances or obtaining a certain percentage reduction off a final bargain offer, said enhanced bargain opportunities being specified in a wild card discount or a special promotion pop-up message, or by instant messaging, or by means of a “Bargain Guru”.

192. A computer program as recited by claim 190, further configured to provide a graphic display, such as a “Bargometer” or “Bargainmeter”, adapted to graphically depict a probability for system acceptance of buyer's offer for purchase of the product.

193. A computer program as recited by claim 190, further configured to award purchase incentives selected from the group consisting of: (a) bonus chances made available upon purchase of products and/or services or in response to buyer's request for free bonus chances, or to encourage timely payment by regular customers; and (b) purchase points provided upon purchase of products.

194. A computer program as recited by claim 190, further configured to track buyers accumulation of a predetermined number of purchase points and notify buyer that said accumulated purchase points are applicable to provide additional purchase discounts, offers, or enhanced bargaining opportunities, in accordance with said registration agreement.

195. A computer program as recited by claim 190, further configured to provide at least one pop-up surprise special message during bargaining, said surprise message according an additional discount on the product, or a special/promotional offer, such as“buy one, get one free”, with respect to said product.

196. A computer program as recited by claim 112, further configured to sell the available products using an on-line retail store sales format.

197. A computer program as recited by claim 112, further configured to place items on auction; or to sell items procured using a procedure involving bids taken from a plurality of buyers, wherein the product is sold to the buyer with the highest bid.

198. A computer program as recited by claim 112, further configured to provide for sale of product procured by the highest bidder in accordance with standard auction procedures, said standard auction procedures being initiated in the event that availability of said product is limited, or said product is in high demand.

199. A computer program as recited by claim 198, being further configured to permit the bargain sale price to be placed on hold for a predetermined amount of time upon request of the buyer said holding of bargain sale price being effectuated either with or without a fee which is predetermined at registration.

200. A computer program as recited by claim 198, further configured to stop sale of the product to the buyer in the event that said buyer responds after the expiration of a predetermined amount of time.

201. A computer program as recited by claim 198, wherein the computer program is further configured to permit withdrawal of buyer's bid after acceptance by the program upon payment of a specified penalty to the system.

202. A computer program as recited by claim 112, wherein said program effectuates worldwide purchase and/or sale of goods and services through its own website using the Internet; by franchising of said system; by licensing of a business module; and through affiliated programs with other existing business systems or websites.

203. A computer program as recited by claim 112, wherein said program is configured to purchase and/or sell goods and services on a local and regional basis, said purchase or sale of goods or services being accomplished: (a) over the Internet using said program's website; (b) by franchising the program; (c) by licensing the business module; and (d) through affiliate programs with other extant business systems or websites.

204. A computer program, comprising:
a. a payment processor module;
b. a billing processor module;
c. an encoding/Decoding processor module;
d. a bargain formulation processor module;
e. a database management module;
f. a database connection module;
g. a commission calculation and processing module,
h. a system and business rules module
i. a network interface module;
j. said computer program running on an operating system in conjunction with the program recited by claim 112, and being further configured to have additional modules attached thereto when and if required, and to act on behalf of a customer comprised of a buyer or a seller, to perform a bargaining process comprising the steps of:
k. generating a bargain offer proposed by said customer;
l. accepting or rejecting a counter offer proposed by the program for the customer;
m. providing choices available to said customer and assisting said customer with product selection and bidding opportunities to arrive at a best bargain price;
n. guiding said customer throughout said bargain process using 37 Bargain Guru” recommendations, including comparative quotes, product ratings, alternative products, and pricing assistance.

205. A computer program as recited by claim 204, further configured to obtain a deal best suited to the buyer through the processing program by providing said comparative quotes for a particular appointed for purchase from the program, said comparative quotes being obtained by searching for information or prices from different extant systems or websites that sell substantially the same product.

206. A computer program as recited by claim 204, said system being further configured to (a) permit said buyer to resume bargaining for the product upon finding on another website or extant program a price for substantially the same product or services that is lower than the final bargain price, and (b) reduce said bargain price to a value less than or equal to said found price for substantially the same product or services.

207. A computer program as recited by claim 204, adapted to provide links to a site that is offering the lowest possible price for a particular product or service, in the event that said Internet bargaining program cannot provide substantially the same price or a lower price through its vendors.

208. A computer program as recited by claim 125, further configured to use cartoon characters to provide bargaining assistance to buyer and seller, said cartoon characters being adapted to provide information from said database using a textual dialogue or voice dialogue.

209. A computer program as recited by claim 125, wherein said information provided by said cartoon characters includes: (a) major characteristics of said product; (b) bargain price; (c) purchasing strategies; and (d) complementary remarks and encouraging comments that congratulate buyer on successful bargains and reinforce buyer's propensity to use said Internet bargaining process for purchase of other products and services, (e) purchasing assistance, (f) bargaining assistance, and (g) product selection assistance.

210. A computer program as recited by claim 125, further configured wherein said website is provided with a suggestion box for comments and feedback from said customers, indicate location of substantially the same product or service at a cheaper rate or price on other existing systems and websites, and set forth user complaints and complements regarding the product or service.

211. A computer program as recited by claim 204, further configured to bargain for, auction or purchase a product or service at retail on behalf of system customers from vendors or other websites or any other existing systems, said bargained for, auction or purchase of said product or service being initiated upon buyer's request and being effected at no extra cost to buyer if said product and/or service is not listed on said system website, or said product or service is cheaper on said other sites or systems.

212. A computer program as recited by claim 204, further configured to designate a human representative for said purpose upon buyer's request.

213. A computer program as recited by claim 204, further configured so that the program charges the buyer a predetermined fee for acting on buyer's behalf.

214. A computer program as recited by claim 204, the program is further configured to increase the price of the product by adding thereto a fee for bargaining on behalf of a customer.

215. A computer program as recited by claim 125, the program being further configured to customize the product by gift wrapping or applying a monogram, or by packaging the product with other product(s) and selling it as a combination product package.

216. A computer program as recited by claim 215, further configured so that other products of said package are sold at no cost to thereby provide for purchaser to buy one gift and get one free.

217. A program as recited by claim 216, further configured so that each of a plurality of products in the combination product package is from the same vendor.

218. A computer program as recited by claim 216, configured so that said other products in said combination product package are from a plurality of different vendors.

219. A computer program as recited by claim 125, further configured so that upon declining to purchase a product, a customer is precluded by said system from purchasing substantially the same product for a predetermined period of time

220. A computer program as recited by claim 125, further configured to permit the buyer to resume bargaining for substantially the same product that buyer previously declined to purchase, provided that such product is still available for purchase.

221. A computer program as recited by claim 125, further configured so that the program may not sell the same product at the price that the buyer declined earlier, whereby buyer is required to repeat the bargaining process.

222. A computer program as recited by claim 125, further configured to prevent the customer from logging on to said program or bargaining or using customer's existing account if the customer has been found to disobey the terms and conditions of the system that customer agreed to accept at the time of registration.

223. A computer-based interactive method for using a system as recited by claim 1, and being governed by a program, as recited by claim 112, said method being configured to permit more modules to be attached when and if required, to consummate a binding contract between the system and the buyer and/or the system and the seller and/or between the buyer and seller through bargaining.

224. A method as recited by claim 223, configured to run on a web-server communicating with the buyers and sellers using a communication mode selected from the group consisting of on-line, off-line and in real-time.

225. A method as recited by claim 223, further comprising the step of processing requests from buyers and/or sellers.

226. A method as recited by claim 223, further comprising the step of storing data related to buyers, sellers, transactions, responses, bargain prices, and bargain deals for use in connection with database operations.

227. A method as recited by claim 223, further comprising the step of creating an interface that enables buyers and sellers to access the products and/or services available to the system for sale.

228. A method as recited by claim 227, further comprising the step of enabling buyers and sellers to input data related to a bargaining process.

229. A method as recited by claim 227, wherein said method steps are carried out on a distributed network.

230. A method as recited by claim 229, wherein said distributed network is the Internet and said interface comprises a Web browser.

231. A method in as recited by claim 229, wherein said method further comprises the steps of:
a. enabling buyers to register by agreeing to the terms and conditions of the system;
b. enabling buyers to submit a buyer profile containing preselected information about said buyers;
c. enabling buyers to log-in to the system and bargain for goods and/or services.

232. A method as recited by claim 231, wherein said method comprises the step of issuing a unique membership identification and password to said buyers or sellers at time of registration.

233. A method as recited by claim 223, wherein user registration comprises the steps of:
a. asking for a user's profile and preselected information about said users;
b. storing said profile and said preselected information in a secure database; and
c. issuing to each user a unique membership identification number.

234. A method as recited by claim 231, comprising the step of authenticating buyer and/or seller to use a service provided by the system.

235. A method as recited by claim 231, further comprising the step of effecting registration of buyers or sellers, said registration being carried out individually by buyers and sellers, and being effected at no cost or for a predetermined fee.

236. A method as recited by 223, comprising the step of providing buyers with preselected product information, including a list comprising products available for purchase through said system, product prices and relative information concerning products, said step of providing preselected product information being carried out after buyer logs on to the system by inputting buyer's membership id and password.

237. A method as recited by claim 223, further comprising the step of receiving from a remote buyer a purchase request comprising (a) a purchase offer; and (b) a payment identifier specifying a financial account from which funds are appointed to be paid for purchase of a product or service under conditions meeting buyer requirements.

238. A method as recited by 223, further comprising the step of initiating the use of a financial account to effect the payment from the buyer.

239. A method as recited by claim 223, further comprising the step of receiving payment from the buyer through an electronic settlement system and said settlement system comprises electronic fund transfer, digital cash, electronic cash and a credit card system selected from the group consisting of credit card and debit card.

240. A method as recited by claim 231, further comprising the step of receiving from said buyer a purchaser offer including product quantity, product quality, purchase date, purchase price, payment terms, date of delivery, pick-up location and delivery location of said product or services.

241. A method is recited by 240, further comprising the step of notifying buyer that buyer's purchaser offer is accepted and that buyer has entered into a legally binding contract with the system.

242. A method as recited by claim 240, further comprising the steps of:
a. generating a bargain price in response to the purchase offer by the buyer; and
b. transmitting said bargain price to the buyer.

243. A method as recited by claim 242, said bargain price including an expiration date and being revocable by the program at any time prior to that date.

244. A method as recited by claim 240, wherein the system bargain offer expires if not accepted within a predetermined time period and can be withdrawn by the program without notice prior to that time.

245. A method as recited by claim 240, further comprising the step of informing seller that buyer has the right to withdraw buyer's bargain offer after acceptance by the program provided buyer pays a specified penalty to the system.

246. A method as recited by claim 240, further comprising the step of notifying the buyer that the bargain offer has lapsed in the event that the bargain offer expires without acceptance.

247. A method as recited by claim 240, further comprising the step of collecting payment from said buyer for purchase of said product.

248. A method as recited by claim 240, further comprising the step of directing payment collected from the buyer to an escrow account.

249. A method as recited by claim 240, further comprising the step of notifying seller concerning the event of sale of a product or service.

250. A method as recited by claim 240, further comprising the step of transferring payment to the seller.

251. A method as recited by claim 223, further comprising the step of communicating with a buyer without identifying a seller.

252. A method as recited by claim 223, further comprising the step of communicating with a seller without identifying a buyer.

253. A method for electronically making a binding contract between a buyer and a seller comprising the steps of:
a. receiving a purchase offer from said buyer containing buyer's requests and a payment identifier specifying the financial account from which funds may be paid for a purchase meeting criteria set by said buyer; and
b. notifying said buyer of the event of acceptance or rejection.

254. A method as recited by claim 253, further comprising the step of receiving payment for a product or service through a credit card.

255. A method as recited by claim 253, further comprising the step of accessing said financial account to extract therefrom said payment from buyer.

256. A method as recited by claim 253, further comprising the step of receiving a purchase offer from the buyer consisting of product quantity, product quality, purchase date, purchase price, payment terms, date of delivery, pick-up location, and delivery location of said products or services.

257. A method for processing the sale of a product purchased using the computer based Internet bargaining system recited by claim 1, comprising the steps of:
a. obtaining a purchase offer for the product from the buyer and a payment identifier from which the payment for the product may be made;
b. presenting buyer with a plurality of available products; and
c. bargaining with buyer for at least one product selection from said products.

258. A method as recited by claim 257, further comprising the step of providing a channel of communication between said buyer and said seller without revealing their identities.

259. A method as recited by claim 257, further comprising the step of providing incentives to the buyer for making a product selection.

260. A method as recited by claim 257, further comprising the steps of:
a. bargaining for said product selection; and
b. arriving at an acceptable price.

261. A method as recited by claim 260, further comprising the steps of:
a. notifying said buyer of the event of acceptance of said price; and
b. drawing payment for said product selection from said payment identifier.

262. A method for processing the sale of a package of component items purchased using an Internet bargaining system as recited by claim 223, further comprising the step of receiving, through a communications port, a purchase offer from a customer containing purchase requirements and a bargain price.

263. A method as recited by claim 262, further comprising the steps of:
a. dissembling said package purchaser offer into a plurality of component bargain offers;
b. determining whether each of said component bargain offers can be accepted or rejected;
c. binding the buyer to purchase the package, in the event that said component bargain offers can be accepted, by accepting a bargain price for said package.

264. A method as recited by claim 263, further comprising the step of receiving a purchase offer for each component item of said package.

265. A method as recited by claim 263, further comprising the step using said payment identifier to collect funds upon acceptance of said bargain offer.

266. A method as recited by claim 263, further comprising the step of basing a price for each component on a percentage of said component's market value to a market value arrived at by summing all components in said package.

267. A method as recited by claim 263, further comprising the steps of:
a. generating a bargain offer for each component in said package and a bargain price for all components in said package; and
b. sending said bargain offer to the buyer with notice that said bargain offer remains valid for a preselected time period.

268. A method as recited by claim 267, further comprising the step of providing in said bargain offer a total price for said package, a portion of said total price being reserved as margin.

269. A method as recited by claim 267, further comprising the step of generating a new bargain offer having an increased prospect for buyer acceptance, said new bargain offer being characterized by a decreased price for said package, or of one or more components thereof.

270. A method as recited by claim 267, further comprising the step of decreasing the price of said package, or of one or more components thereof, to arrive at a counter bargain offer having an increased prospect for acceptance by said buyer.

271. A method as recited by claim 267, further comprising the step of binding said buyer to purchase the package of components upon acceptance of said bargain price by said program, said price for each of said components of said package remaining undisclosed to the buyer.

272. A method for using a computer to facilitate a transaction between a buyer and a seller, comprising the steps of:
a. inputting into a computer a purchase offer which includes information about the product and a bargain offer which includes an offer price;
b. inputting into a computer a payment mode identifier including information associated with said purchase offer;
c. transmitting said inputted purchase offer and payment mode identifier to said buyer and said seller.

273. A method of using a computer to receive a bargain offer containing the price offered by a buyer for a product, comprising the steps of:
a. validating said bargain offer;
b. determining availability of said product; and
c. storing information derived from steps “a” and “b” in a database.

274. A method as recited by claim 272, further comprising the step of generating an acknowledgement response for a bargain offer received from a buyer, said acknowledgement response being arrived at by determining the validity of the bargain offer in accordance with the following validation criteria: (a) whether the bargain offer for the product has expired; (b) whether said product is available; and (c) whether a predetermined dollar amount is available in the payment mode identifier.

275. A method for processing the sale and purchase of a product or service using a storage device, a processor and a program operative to control said processor, comprising the steps of:
a. storing said program in said storage device;
b. opening said program;
c. operating said processor to receive a buyer request for purchase of said product or service and a payment identifier, defining a bargain offer.

276. A method as recited by claim 275, further comprising the step of receiving a bargain offer from a seller including (a) conditions for sale of said product or service,
(b) details about the product or service, (c) a seller price for the product or service, and
(d) a payment identifier specifying an account to which funds may be paid.

277. A method as recited by claim 275, further comprising the step of using said processor to identify the buyer from which said bargain offer is received on the basis of buyer provided information, including buyer's ID and password.

278. A method as recited by claim 275, further comprising the step of using said processor and said program to identify the seller.

279. A method as recited by claim 275, wherein said program to verifies the legitimacy/authenticity/condition of said product and the pricing of products being listed by the seller, said verification being accomplished by a method comprising the steps of:
a. issuing an authenticity certificate from an authorized appraiser;
b. evaluating the price arrived at by said appraiser;
c. checking said certification at the time of pick-up or delivery of said product;
d. checking the condition of the product at the time of delivery.

280. A method as recited by claim 279, further comprising the step of using said program to identify and nominate said authorized appraiser.

281. A method as recited by claim 279, further comprising the step of requiring seller to pay the cost of said evaluation and excluding said cost from the price of the product.

282. A method as recited by claim 279, further comprising the steps of:
a. paying the cost of evaluation to said nominated appraiser; and
b. including said cost in the price of the product.

283. A method as recited by claim 279, further comprising at least one of the following steps, to which seller has agreed during registration:
a. initiating legal action against the seller in the event that the seller does not produce the product at time of delivery;
b. preventing payment to the seller;
c. imposing on seller a predetermined penalty; and
d. canceling seller's registration.

284. A method as recited by claim 279, further comprising the step of stopping payment to the seller for the sale of the product if seller fails to produce said authentication certificate, or produces a false certificate, at time of delivery, as agreed to by seller during registration.

285. A method as recited by claim 279, further comprising the step of validating the received bargain offer signal from the buyer and/or seller to determine whether said received bargain offer signal meets predetermined validation criteria.

286. A method as recited by claim 285, further comprising the step of processing the received bargain offer from the buyer and/or seller solely in the event of a determination during said validation step that the received bargain offer meets predetermined criteria.

287. A method as recited by claim 285, further comprising the step of initiating the bargain process by generating bargain prices for the buyer, said generation of bargain prices continuing until occurrence of one of the following events: (a) an acceptable price is arrived at; or (b) said buyer or said seller stops bargaining; or (c) said product becomes unavailable; or (d) said bargain price generated by said system reaches its limit; or (e) said buyer or said seller runs out of bonus chances or does not request additional chances; or (f) said predetermined time period allotted for bargaining has expired.

288. A method as recited by claim 287, further comprising the step of stopping said bargaining process upon request of the buyer and/or seller without charging any penalty or fees.

289. A method as recited by claim 287, further comprising the step of accepting the bargaining offer containing buyer's price offer after validating that said offer meets predetermined criteria.

290. A method as recited by claim 287, further comprising the steps of:
a. validating that the bargain offer meets predetermined criteria;
b. processing the acceptance received from the buyer;
c. storing said acceptance in said database.

291. A method as recited by claim 287, further comprising the steps of:
a. notifying the buyer that buyer's bargain offer fell short of minimum predetermined offer criteria; and
b. requesting that buyer send another bargain offer or quit the bargaining process; or to follow a bargaining recommendation provided by a “Bargain Guru”.

292. A method as recited by claim 287, further comprising the step of permitting buyer to request free chances, or buy additional chances for a predetermined chance purchase amount, or redeem purchase points to purchase additional chances to bargain after the system program has stopped bargaining with buyer and seller.

293. A method as recited by claim 292, further comprising the step of permitting buyer and/or seller to use at least one bargain chance to continue bargaining until buyer and/or seller run out of chances or accept a program proposed bargain price.

294. A method as recited by claim 292, further comprising the step of permitting buyer to use program provided bargain chances to continue bargaining until said chances are exhausted or buyer requests free chances or buys more chances for a predetermined chance purchase price or redeems purchase points to buy more chances, or accepts a program proposed bargain price, or follows a purchase recommendation provided by a “Bargain Guru”.

295. A method as recited by claim 292, further comprising the steps of indicating to the buyer that the bargain price generated by the buyer's bargain offer will remain active and acceptable for a predetermined time period provided that the product or service remains available.

296. A method as recited by claim 292, further comprising the step of notifying the buyer and/or seller concerning the status of shipment in transit, said notifying step being carried out after completion of a purchase transaction, or in response to a buyer or seller inquiry.

297. A method as recited by claim 292, further comprising the step of initiating use of a payment identifier to collect funds.

298. A method as recited by claim 223, further comprising the step of bargaining or trading with additional extant systems on behalf of the buyer, said bargaining or trading step being carried out at no cost or for a predetermined fee.

299. A method as recited by claim 223, further comprising the step of issuing at least one license to at least one other extant system or to at least one other customer, authorizing use of the program for sale of products and/or services.

300. A method as recited by claim 223, further comprising the step of transferring said buyer to a toll free number to continue bargaining for said selected product, upon request of said buyer.

301. A method as recited by claim 223, further comprising the step of permitting a buyer (a) to purchase wild card discounts or special promotions from said program; and/or (b) to be awarded said wild card discounts or special promotions by said program on special bargain deals; and/or (c) to receive said wild card discounts or special promotions randomly; and/or (d) to be accorded said wild card discounts or special promotion awards by surprise pop-up messages, or by instant messaging, or by means of a “Bargain Guru”.

302. A method as recited by claim 301, further comprising the step of permitting buyer to use the wild card discounts or special promotions to buy bargain chances or get a preselected percentage reduction from the final bargain offer in accordance with specifications contained in the wild card discount or special promotion pop-up message, or by instant messaging, or by means of a “Bargain Guru.

303. A method as recited by claim 301, further comprising the step of using a Bargometer or Bargainmeter to graphically depict a probability for system acceptance of buyer's offer for purchase of the product.

304. A method as recited by claim 301, further comprising the steps of:
a. awarding points selected from the group consisting of bonus points available on the purchase of products and/or services, free points available upon request or free points obtainable y payment of a fee to a regular customer on timely basis, and
b. providing purchase points, obtainable upon the purchase of products.

305. A method as recited by claim 301, further comprising the step of permitting buyer to accumulate a preselected number of points, and to use these points to get additional discounts or offers or enhanced bargaining opportunities in accordance with said registration agreement.

306. A method as recited by claim 301, further comprising the step of providing at least one pop-up surprise message during bargaining, said surprise message according (a) an additional discount on the product; (b) a special/promotional offer, such as “buy one, get one free”, with respect to said product.

307. A method as recited by claim 223, further comprising the step of selling available products using an on-line retail store sales format.

308. A method as recited by claim 223, further comprising the step of selling items procured using a procedure involving bids taken from a plurality of buyers, wherein the product is sold to the buyer that submits the highest bid.

309. A method as recited by claim 223, further comprising the steps of:
a. determining whether a product for which a bid is submitted has limited availability or is in high demand; and
b. procuring said product using a procedure involving bids taken from a plurality of buyers, wherein the product is sold to the buyer with the highest bid.

310. A method as recited by claim 309, further comprising the steps of placing said bid price on hold for a predetermined time at the request of a buyer who is the highest bidder, said price holding step being carried out at no cost or for a predetermined fee.

311. A method as recited by claim 309, further comprising the step of stopping sale of said product in the event that, said bidder responds after expiration of a predetermined time.

312. A method as recited by claim 309, further comprising the step of permitting the buyer to withdraw a bid after acceptance by said program provided buyer pays a specified penalty to the system.

313. A method as recited by claim 223, further comprising the step of buying and/or selling goods and services on a worldwide basis through (a) said program's website, using the Internet, and/or (b) franchising said program, and/or (c) licensing the business module, and/or (d) affiliate programs with other existing business systems or websites.

314. A method as recited by claim 223, further comprising the step of buying and/or selling goods and services on a local and regional basis through (a) said program's website, using the Internet, and/or (b) franchising said program, and/or (c) licensing the business module, and/or (d) affiliate programs with other existing business systems or websites.

315. A method of using the Internet bargaining system in claim 1, said system running the program recited by claim 112 having at least one additional module attached thereto for consummating a binding contract between the system and a customer comprised of a buyer or a seller through bargaining, and for acting on behalf of the customer to perform a bargaining process comprising the steps of:
a. generating a bargain offer proposed by said customer;
b. accepting or rejecting a counter offer proposed to the program for the product;
c. consulting with the customer throughout the bargaining process to obtain customer consent and customer preferences; and
d. electing from among choices available to the customer on customer's behalf, to optimally use customer's available resources to arrive at a final bargain price.

316. A method as recited by claim 315, further comprising the steps of:
a. searching for information or prices from different existing systems or websites that are selling substantially the same product;
b. providing to a customer comparative quotes of a specific product appointed for purchase through said Internet bargaining system.

317. A method as recited by claim 315, further comprising the steps of:
a. countering the final bargain price to seek a bargain price adjustment based on a customer found price, from another website or existing system, which has been substantiated to be lower than the final bargain price; and
b. further bargaining on customer's behalf for a bargain price adjustment that results in a price equal to or less than the found price for substantially the same product or service.

318. A method as recited by claim 223, further comprising the step of providing links to a site that offers the lowest possible price for a particular product or service in the event that the said program cannot provide a lower price for such product or service through its vendors.

319. A method as recited by claim 318, further comprising the step using cartoon characters to assist people in bargaining through the program, the cartoon characters providing information from a database using a textual dialogue or voice dialogue.

320. A method as recited by claim 318, further comprising the step of providing information using cartoon characters, such information including (a) major characteristics of the product, (b) bargain price, (c) purchasing strategies, (d) complementary remarks and encouraging comments that congratulate buyer for concluding successful bargains, (e) purchasing assistance, (f) bargaining assistance, and (g) product selection assistance.

321. A method as recited by claim 318, further comprising the step providing on said website a box for comments and feedback from customers that find substantially the same product or service at cheaper rates on another existing system or website, and which provides a receptacle for customer complaints and compliments regarding the product or service.

322. A method as recited by claim 223, further comprising the step of procuring said product or service on behalf of a customer at the customer's request and with or without additional cost by a procurement process including bidding at auction and purchasing at retail from another vendor, website or extant system, in the event that the product and/or service is not listed on the system website or if it is less expensive on said other website or extant system.

323. A method as recited by claim 223, further comprising the step of designating a human representative for said procurement purpose.

324. A method as recited by claim 223, further comprising the step of charging the customer a predetermined fee for initiating said procurement process.

325. A method as recited by claim 223, further comprising the step of adding additional costs incurred for conducting said procurement process to the price of the product or service.

326. A method as recited by claim 223, further comprising the step of customizing the product by gift wrapping or applying a monogram or by packaging the product with other product(s) and selling it as a product package.

327. A method as recited by claim 326, further comprising the step of providing other products in the package at no cost by giving them away as gifts or awarding them in connection a purchase program in which buyer purchases one product and gets one free.

328. A program as recited by claim 327, further configured so that other products in said package are procured from the same vendor.

329. A method as recited by claim 327, further comprising the step of procuring other products in the package from different vendors.

330. A method as recited by claim 223, further comprising the step of preventing a customer from bargaining for a predetermined amount of time to procure substantially the same product that customer declined to purchase.

331. A method as recited by claim 223, further comprising the step of permitting the buyer to bargain for substantially the same product that buyer declined to purchase, said permission being granted after expiration of a predetermined time period, provided that the product is still available.

332. A method as recited by claim 223, further comprising the step of preventing the system from selling to buyer substantially the same product at a price that the buyer has previously declined, thereby causing buyer to repeat the bargaining process ab initio.

333. A method as recited by claim 223, further comprising the step of preventing customer from logging on to the program or bargaining or using an extant account if the customer has been found to have disobeyed the terms and conditions of the registration agreement that the customer agreed to accept at the time of registration.

334. An apparatus for conducting the sale of a product through bargaining, comprising:
a. a processor;
b. a network interface
c. a memory;
d. a data storage device;
e. an operating system;
f. a database management system;
g. a database;
h. the program recited by claim 112; and
i. a high bandwidth connection to the Internet.

335. An apparatus as recited by claim 334, wherein said processor is further operative with said program to function as a web-server communicating with buyers and sellers using a communication mode selected from the group consisting of on-line, off-line and real-time.

336. An apparatus as recited by claim 334, wherein said processor is further operative with the program to process a plurality of requests from buyers and/or sellers.

337. An apparatus as recited by claim 334, further configured to store in said database all data related to buyers, sellers, transactions, responses, bargain prices, and bargain deals for use in connection with database operations.

338. An apparatus as recited by claim 334, further configured to provide an interface means enabling buyers and sellers to access the products and/or services available through the system for sale, said interface comprising a Web-browser.

339. An apparatus as recited by claim 334, wherein the processor is further operative with the program to enable buyers and sellers to input data related to the bargain process.

340. An apparatus as recited by claim 334, wherein said processor is further operative with said program to be implemented on a distributed network.

341. An apparatus as recited by claim 340, wherein the said distributed network comprises the Internet and said interface comprises a Web browser.

342. An apparatus as recited by claim 340, wherein the processor cooperates with said program to (a) enable buyers to register by agreeing to the terms and conditions of the system; (b) enable buyers to submit a buyer profile containing preselected information about said buyers; and (c) enable buyers to login to the system and bargain for goods and/or services.

343. An apparatus as recited by claim 342, wherein the processor is further operative with the program to issue a unique membership identification and password to a buyer or a seller registering with the system.

344. An apparatus as recited by claim 334, wherein the processor is further operative with the program to register a seller by asking for seller information, storing it in a secure database and issuing to a seller a unique membership identification number and password.

345. An apparatus as recited by claim 342, wherein the processor is further operative with the program to authenticate the buyer and/or seller to use a service provided by the system program.

346. An apparatus as recited by claim 342, wherein the processor is further operative with the program to permit a buyer or a seller register at no cost or for a predetermined fee.

347. An apparatus as recited by claim 334, wherein the processor is further operative with the program to provide buyer with preselected product information, including a list of products available for purchase through the system, product prices and relative information concerning products, said preselected product information being provided after buyer logs on to the system by inputting buyer's membership ID and password.

348. An apparatus as recited by claim 334, wherein the processor is further operative with the program to receive from a remote buyer a purchase request comprising (a) a purchase offer, and (b) a payment identifier specifying a financial account from which funds are appointed to be paid for purchase of a product or service under conditions meeting buyer requirements.

349. An apparatus as recited by claim 334, wherein the processor is further operative with the program to initiate the use of a financial account to effect payment from the buyer.

350. An apparatus as recited by claim 334, wherein the processor is further operative with the program to receive payment from the buyer through an electronic settlement system, and said settlement system comprises electronic fund transfer, digital cash, electronic cash and a credit card system selected from the group consisting of credit card and debit card

351. An apparatus as recited by claim 342, wherein the processor is further operative with the program to receive a purchaser offer from the buyer comprising information elements including product quantity, product quality, purchase date, purchase price, payment terms, date of delivery, pick-up location and delivery location of said product or services.

352. An apparatus as recited by claim 351, wherein the processor is further operative with the program to notify the buyer that said purchaser offer is accepted and buyer has entered into a legally binding contract with the system.

353. An apparatus as recited by claim 351, wherein the processor is further operative with the program (a) to generate a bargain price in response to a purchase offer by the buyer, and (b) to transmit said bargain price to the buyer.

354. An apparatus as recited by claim 353, wherein said bargain price response includes an expiration date and notification that said bargain price is revocable by the system at any time prior to said expiration date.

355. An apparatus as recited by claim 351, wherein the system bargain offer includes notification that said offer expires if it is not accepted within a predetermined time period, and that said offer can be withdrawn by the system without notice prior to expiration of said preselected time period.

356. An apparatus as recited by claim 351, wherein said processor is further operative with said program to accord buyer the right to withdraw said bargain offer after acceptance by the system provided that the buyer pays a specified penalty to the system.

357. An apparatus as recited by claim 351, wherein the processor is further operative with the program to notify the buyer that the bargain offer has lapped if the bargain offer expires without acceptance.

358. An apparatus as recited by claim 351, wherein the processor is further operative with the program to collect payment for the purchase from the buyer.

359. An apparatus as recited by claim 351, wherein the processor is further operative with the program to place payment collected from the buyer in an escrow account.

360. An apparatus as recited by claim 351, wherein the processor is further operative with the program to notify seller about the sale of seller's product.

361. An apparatus as recited by claim 351, wherein the processor is further operative with the program to transfer payment to the seller.

362. An apparatus as recited by claim 334, wherein the processor is further operative with the program to communicate with the buyer without identifying the seller.

363. An apparatus as recited by claim 334, further configured to communicate with the seller without identifying the buyer.

364. An apparatus for electronically making a binding contract between a buyer and a seller having a processor, a network interface, a memory, a data storage device, an operating system, a database management system, a database, a program as recited by claim 222, and a high bandwidth connection to the Internet; the process comprising the steps of:
a. receiving a purchase offer from the buyer containing a buyer request;
b. said purchase order containing a payment identifier specifying the financial account from which funds may be paid for a purchase meeting criteria set by the buyer; and
c. notifying the buyer concerning acceptance or rejection of said purchase offer.

365. An apparatus as recited by claim 364, wherein the processor is further operative with the program to receive payment through a credit card.

366. An apparatus as recited by claim 364, wherein the processor is further operative with the program to initiate the use of a financial account for effecting payment of said funds from buyer.

367. An apparatus as recited by claim 364, wherein the processor is further operative with the program to receive a purchase offer from the buyer comprising plural buyer request elements, including product quantity, product quality, purchase price, purchase date, payment terms, date of delivery, pick-up location and delivery location of said product or services.

368. An apparatus for processing the sale of a product which comprises a processor, a network interface, a memory, a data storage device, an operating system, a database management system, a database, the program recited by claim 112, a high bandwidth connection to the Internet, a common port for obtaining a purchase offer for the product from the buyer and a payment identifier from which payment for the product may be made, the processor being further configured to present the buyer with a plurality of available products and the buyer being enabled by said system to bargain for at least one product selection.

369. An apparatus as recited by claim 368, where the processor is further operative with the program to provide a channel of communication between said buyer and said seller without revealing their identities.

370. An apparatus as recited by claim 368, where the processor is further operative with the program to provide incentives to the buyer for making said product selection.

371. An apparatus as recited by claim 368, where the processor further comprises means operative with the program to bargain for the product selected by the buyer during a bargaining process adapted to arrive at an acceptable bargain price.

372. An apparatus as recited by claim 368, where the processor further comprises means operative with the program for (a) accepting the bargain price; (b) notifying the buyer about the acceptance; and (c) drawing payment for said product from the payment identifier.

373. An apparatus for processing the sale of a package of component items, comprising: a processor, a network interface, a memory, a data storage device an operating system, a database management system, a database, the program in claim 112, a high speed bandwidth connection to the Internet, and a communications port to receive a purchase offer from the customer containing his requirements for each of said component items of said package, and a bargain price for said package.

374. An apparatus as recited by claim 373, wherein the processor further comprises means operative with the program to deconstruct a package purchase offer into a plurality of component items and to determine whether each of the component items of said package purchase offer can be accepted or rejected and bind the buyer to purchase the package if the system accepts said bargain price for the package.

375. An apparatus as recited by claim 373, wherein the processor further comprises means operative with the program to receive a purchase offer for each component in the package.

376. An apparatus as recited by claim 373, wherein the processor further comprises means operative with the program for initiating the use of a payment identifier to collect funds, upon acceptance of a bargain offer.

377. An apparatus as recited by claim 373, wherein the processor further comprises means operative with the program to calculate a price for each component based on the percentage of the market value of the component to the market value of all component items in said package.

378. An apparatus as recited by claim 373, wherein the bargain offer for each component in the package and the bargain price for the whole package is generated by the system and sent to the buyer with notice that buyer acceptance must be effected during a preselected time period.

379. An apparatus as recited by claim 378, wherein the processor further comprises means operative with the program so that the bargain offer response generated by the system includes the total price for the product or service, a portion of the total price being reserved as margin.

380. An apparatus as recited by claim 378, wherein the processor further comprises means operative with the program to cause the processor to decrease the price of at least one component of the package, or the whole package, to thereby generate a new bargain offer response having increased acceptability to the buyer.

381. An apparatus as recited by claim 378, wherein the processor further comprises means operative with the program for decreasing the price of at least one component of the package, or decreases the price of said package, without disclosing the price reduction of the component items in the package, thereby arriving at a new counter bargain offer having increased propensity for acceptance by the buyer and the system.

382. An apparatus as recited by claim 378, wherein the processor further comprises means operative with the program for binding buyer to purchase the package of components if the bargain price is accepted by the system and the price of the component items is not disclose to the buyer.

383. An apparatus for facilitating a transaction between a buyer and at least one seller, the apparatus having a processor, a network interface, a memory, a data storage device, an operating system, a database management system, a database, the program in claim 112, and a high bandwidth connection to the Internet, and the transaction comprising the steps of: (a) inputting into computer a purchase offer which includes information about the product and a bargain offer which includes an offer price, (b) inputting into a computer the payment mode identifier associated with the bargain offer, and (c) transmitting each of said purchase offer, said bargain offer and said payment mode identifier to said system.

384. An apparatus having a processor, a network interface, a memory, a data storage device, an operating system, a database management system, a database, the program in claim 112, and a high bandwidth connection to the Internet, said apparatus being adapted to receive a bargain offer containing the price offered by the buyer for the product and to perform the steps which comprise: (a) validating the offer, (b) determining availability of the product, and (c) storing information concerning bargain offer validity and said product in said database.

385. An apparatus as recited by claim 383, said processor being further operative with said program to receive a bargain offer from a buyer, and generate an acknowledgement response upon validating the offer, said validation being carried out by a process comprising the steps of:
a. determining whether the bargain offer for the product has expired;
b. determining whether the product is available; and
c. determining whether a predetermined dollar amount is available in said payment mode identifier.

386. An apparatus having a processor, a network interface, a memory, a data storage device, an operating system, a database management system, a database, the program recited by claim 112, and a high bandwidth connection to the Internet, said apparatus being used for processing the sale and purchase of items and said processor being further operative with said program to receive a bargain offer from the buyer, including (a) conditions for purchase of a product or service, and (b) a payment identifier, thereby defining said bargain offer.

387. An apparatus as recited by claim 386, wherein the processor is further operative with the program to receive a bargain offer from the seller including conditions for sale of the product, details about the product, a seller price for the product and a payment identifier specifying mode of payment.

388. An apparatus as recited by claim 386, wherein the processor is further operative with the program to identify the buyer from which the bargain offer is received by asking the buyer for a member ID and password.

389. An apparatus as recited by claim 386, wherein the processor is further operative with the program to query each seller to obtain therefrom a unique member ID and password for use in identifying a seller from which a bargain offer is received.

390. An apparatus as recited by claim 386, wherein the processor is further operative with the program to verify the legitimacy/authenticity/condition of the product, and the pricing of the product being listed by the seller, said verification being accomplished by verification means, which comprise:
a. means for issuing an authenticity certificate from an authorized appraiser;
b. means for evaluating product price based on input from said authorized appraiser;
c. means for checking said certification at the time of pick-up or delivery; and
d. means for checking the condition of the product appointed for inspection at said time of pick-up or delivery.

391. An apparatus as recited by claim 390, said processor being further operative with said program to effect the evaluation and appraisal of said product based on input by an authorized appraiser nominated by said system.

392. An apparatus as recited by claim 390, said processor being further operative with said program to effect payment by seller of costs for the evaluation, said evaluation costs being excluded from product price.

393. An apparatus as recited by claim 390, said processor being further operative with said program to effect payment by said system of costs for the evaluation to its nominated appraiser, said evaluation cost being included in product price.

394. An apparatus as recited by claim 390, further comprising:
a. means for initiating legal action or for imposing a penalty against a seller that fails to produce a product at the time of pick-up;
b. means for preventing payment of said seller;
c. means for charging a predetermined penalty against said seller;
d. means for blacklisting said seller;
e. means for canceling said seller's registration in accordance with seller's registration agreement.

395. An apparatus as recited by claim 390, wherein the processor is further operative with the program to stop payment to the seller for sale of the product if seller fails to produce an authentication certificate or produces a false certificate at time of pick-up.

396. An apparatus as recited by claim 390, wherein the processor is further operative with the program to validate the received bargain offer signal from the buyer and/or seller, thereby determining whether the received offer signal meets predetermined validation criteria.

397. An apparatus as recited by claim 396, wherein the processor is further operative with the program to process the received bargain offer from the buyer and/or seller, in response to a determination during validation that said received bargain offer meets predetermined criteria.

398. An apparatus as recited by claim 396, wherein the processor is further operative with the program to initiate the bargain process, said processor having means for continuously generating bargain prices for the buyer, until a point is reached where either an acceptable price is arrived at, or the buyer stops bargaining, or the product becomes unavailable, or the bargain price generated by the system reaches a preselected limit, or said buyer or said seller runs out of bonus chances or does not request additional chances, or said predetermined time period allotted for bargaining has expired.

399. An apparatus as recited by claim 398, wherein the processor comprises means operative with the program to stop the bargaining process in response to a request from the buyer and/or seller without charging a penalty or a fee.

400. An apparatus as recited by claim 398, wherein the processor further comprises means operative with the program to accept the bargaining offer containing buyer's price offer after validating that the offer meets predetermined criteria.

401. An apparatus as recited by claim 398, the processor further comprising means operative with the program for processing an acceptance received from the buyer after validating that the bargain offer meet predetermined criteria, storing the validation offer in a database.

402. An apparatus as recited by claim 398, wherein the processor further comprises means operative with the program to (a) transmit a notification to the buyer indicating that his bargain offer is less than certain minimum predetermined offer criteria; (b) request buyer to send another bargain offer; or (c) quit the bargaining process; or (d) to follow a bargaining recommendation provided by a “Bargain Guru”.

403. An apparatus as recited by claim 398, wherein the processor further comprises means operative with the program to permit buyer to (a) request free chances, or (b) buy more chances at a predetermined chance purchase price, or (c) redeem purchase points to buy more chances to bargain after the system program has stopped bargaining for a particular product or service.

404. An apparatus as recited by claim 403, wherein the processor further comprises means operative with the program to permit buyer and/or seller to use at least one bargain chance provided by the system to continue bargaining until all chances issued to the buyer and seller have been used or a bargain price is accepted.

405. An apparatus as recited by claim 403, wherein the processor further comprises means operative with the program for permitting buyer to use at least one bargain chance provided by the system to continue bargaining until all chances provided by the system have been used, said buyer having an election to (a) request free chances or (b) to purchase additional chances for a predetermined chance purchase price, or (c) to redeem purchase points applicable toward purchase of additional chances; or (d) to accept the system bargain price; or (e) to follow a purchase recommendation provided by a “Bargain Guru”.

406. An apparatus as recited by claim 403, wherein the processor further comprises means operative with the program for indicating to the buyer that, so long as the product or service is still available, the bargain price generated by the buyer's bargain offer will remain active and acceptable for a predetermined time period.

407. An apparatus as recited by claim 403, wherein the processor further comprises means operative with the program to periodically notify the buyer and/or seller concerning the status of shipment in transit said notification being provided (a) after completion of a transaction, and (b) periodically, in response to a buyer or seller request after purchase of said product.

408. An apparatus as recited by claim 403, wherein the processor further comprises means operative with the program for initiating the use of a payment identifier to collect funds.

409. An apparatus as recited by claim 334, wherein the processor further comprises means operative with the program for bargaining or trading with other extant systems, said bargaining or trading being conducted on behalf of the buyer and being carried out at no cost, for a predetermined fee.

410. An apparatus as recited by claim 334, wherein the processor further comprises means operative with the program for issuing licenses to other extant systems or customers to use the system for selling their products and/or services.

411. An apparatus as recited by claim 334, wherein the processor further comprises means operative with the program for transferring the buyer to a toll free number to continue bargaining for the selected product, said transfer being initiated upon request of the buyer.

412. An apparatus as recited by claim 334, wherein the processor further comprises means operative with the program for permitting buyers to obtain wild card discounts or special promotions from the system using a procedure comprising: (a) purchase of wild cards or special promotions containing said discounts; (b) receipt of system awarded wild cards or special promotions containing said discounts for participating in special bargain deals; (c) receipt of randomly awarded system wild cards or special promotions; and (d) receipt of wild cards or special promotions awarded to privileged customers by surprise pop-up messages or by instant messaging, or by means of a “Bargain Guru”.

413. An apparatus as recited by clam 412, wherein the processor further comprises means operative with the program for permitting the buyer to use said wild card discounts or special promotions to buy bargain chances or to obtain a preselected percentage reduction from the final bargain offer as specified in a wild card discount or special promotion pop-up message or by instant messaging, or by means of a “Bargain Guru”.

414. An apparatus as recited by claim 412, wherein the processor further comprises means operative with the program to provide a graphic display such as a “Bargometer” or a “Bargainmeter” adapted to graphically depict a probability for system acceptance of buyer's offer for purchase of the product.

415. An apparatus as recited by claim 412, wherein the processor further comprises means operative with the program to award purchase incentives selected from the group consisting of: (a) bonus chances, made available on the purchase of products and/or services or in response to buyer's request for free bonus chances or to encourage timely payment by customers; (b) purchase points, provided in consideration of the purchase of products.

416. An apparatus as recited by claim 412, wherein the processor further comprises means operative with the program to permit buyer to accumulate a certain predetermined number of points, and to use the accumulated points to obtain additional discounts, offers or enhanced bargaining opportunities, in accordance with said registration agreement.

417. An apparatus as recited by claim 412, wherein the processor further comprises means operative with the program for (a) providing at least one pop-up surprise special message during bargaining, said surprise message according an additional discount on the product or a special/promotional offer, such as “buy one, get one free”, with respect to said product.

418. An apparatus as recited by claim 334, wherein the processor further comprises means operative with the program for selling available products using an on-line, retail sales format.

419. An apparatus as recited by claim 334, further configured to place items on auction or to sell items by procured using a procedure involving bids taken from a plurality of buyer, wherein the product is sold to the buyer with the highest bid.

420. An apparatus as recited by claim 334, wherein the processor further comprises means operative with the program for selling items procured using a procedure involving bids taken from a plurality of buyers, wherein the product is sold to the buyer that submits the highest bid.

421. An apparatus as recited by claim 420, wherein the processor further comprises means operative with the program to place the price on hold for a predetermined amount of time upon the request of a buyer, said holding of bargain sale price being effectuated either with or without a fee.

422. An apparatus as recited by claim 420, wherein the processor further comprises means operative with the program to prevent the product from being sold in the event that said bidder responds to said system after expiration of a predetermined time.

423. An apparatus as recited by claim 420, wherein the processor further comprises means operative with the program for permitting the buyer to withdraw a bid after acceptance by the system with or without payment of a specified penalty to the system.

424. An apparatus as recited by claim 334, wherein the processor further comprises means operative with the program for purchasing and/or selling goods and services on a worldwide basis, said purchase or sale being accomplished: (a) through the system's own Internet website; or (b) by franchising the system; or (c) by licensing the business module; or (d) through affiliate programs with other extant business systems or websites.

425. An apparatus as recited by claim 334, wherein the processor further comprises means operative with the program for purchasing and/or selling goods and services on a local and regional basis, said sale being accomplished: (a) through the system's own Internet website; or (b) by franchising the system; or (c) by licensing the business module; or (d) through affiliate programs with other extant business systems or websites.

426. An apparatus comprising: a processor, a network interface, a memory, a data storage device, an operating system, a database management system, a database, the program recited in claim 112, and a high bandwidth connection to the Internet, said apparatus configured to act on behalf of a customer comprised of a buyer or a seller and perform a bargaining process comprising the steps of:
a. generating a bargain offer proposed by said customer;
b. accepting or rejecting a counter offer proposed to the program for the product;
c. consulting with the customer throughout the bargaining process to obtain customer consent and customer preferences; and
d. electing from among choices available to the customer on customer's behalf, to optimally use customer's available resources to arrive at a final bargain price.

427. An apparatus as recited by claim 426, wherein the processor comprises means operative with the program to provide comparative quotes of a product appointed for purchase by a buyer to obtain a preferred deal for said buyer, said means for providing said comparative quotes including means for (i) locating information or prices from different extant systems or websites that sell substantially the same product, and (ii) providing to a customer comparative quotes of a specific product appointed for purchase through said Internet Bargaining system.

428. An apparatus as recited by claim 427, wherein the processor comprises means operative with the program for (a) countering the final bargain price to seek a bargain price adjustment based on a customer found price, from another website or existing system, which has been substantiated to be lower than the final bargain price; and (b) further bargaining on a customer's behalf for a bargain price adjustment that results in a price equal to or less than the found price for substantially the same product or service.

429. An apparatus as recited by claim 334, wherein the processor comprises means operative with the program for providing links to a site that offers a lower price for a particular product or service, in the event that the said system cannot provide substantially the same price or a lower price through its vendors.

430. An apparatus as recited by claim 334, wherein the processor comprises means operative with the program for using cartoon characters to assist people with bargaining, said cartoon characters being adapted to provide information from the database using a textual dialogue or a voice dialogue.

431. An apparatus as recited by claim 334, wherein the processor comprises means operative with the program for organizing the information provided by the said cartoon characters into categories, comprising: (a) major characteristics of the product, (b) bargain price, (c) purchasing strategies that can be useful for the buyer, (d) complementary remarks for the buyer to congratulate buyer upon completion of a successful bargain and encourage buyer to participate in additional bargains, (e) purchasing assistance, (f) bargaining assistance, and (g) product selection assistance.

432. An apparatus as recited by claim 334, wherein the processor comprises means operative with the program for providing a website having a box for comments and feedback from customers, said box including a plurality of feedback categories, including: (a) whether customers find the same product at decreased rates on other extant systems and websites, (b) customer complaints, and (c) customer compliments.

433. An apparatus as recited by claim 427, wherein the processor comprises means operative with the program for the purpose of procuring a product or service on behalf of a customer at no extra cost if the product or service is not listed on the system website or if it is offered on said other extant system or website at a lower price, said product procurement being carried out by (a) bargaining for the product or service; or (b) purchasing product at auction; or (c) purchasing the product or service at retail from vendors or other websites or other extant systems at buyer's request.

434. An apparatus as recited by claim 427, wherein the processor comprises means operative with the program for designating a human representative for said product procurement purpose.

435. An apparatus as recited by claim 427, wherein the processor comprises means operative with the program for charging the customer a predetermined fee for procuring said product on customer's behalf.

436. An apparatus as recited by claim 427, wherein the processor comprises means operative with the program for adding said fee to the price of the product for bargaining on behalf of a customer.

437. An apparatus as recited by claim 334, wherein the processor comprises means operative with the program for customizing the product by (a) gift-wrapping; or (b) applying a monogram to said product; or (c) combining the product with other product(s) and selling a package composed of the combined products.

438. An apparatus as recited by claim 437 wherein the processor comprises means operative with the program for awarding the other products in the package (a) as gifts, or (b) on a purchase basis wherein for each product purchased, one of the other products is awarded at no cost.

439. An apparatus as recited by claim 334, wherein the processor comprises means operative with the program for combining in said package a plurality of products and services, each of which originate from the same vendor.

440. An apparatus as recited by claim 334 where the processor comprises means operative with the program for combining in said package a plurality of products and services, said products and services originating from a plurality of different vendors.

441. An apparatus as recited by claim 334, wherein the processor comprises means operative with the program for preventing a customer from bargaining for a product during a predetermined time period following a decision by said customer declining purchase of substantially the same product.

442. An apparatus as recited by claim 439, wherein the processor comprises means operative with the program for permitting a customer to bargain for a product that said customer has declined to purchase, said permission being granted after expiration of a predetermined time period, provided that substantially the same product is available.

443. An apparatus as recited by claim 334, wherein the processor comprises means operative with the program for preventing sale to a buyer of substantially the same product at a price previously declined by that buyer, to thereby cause said buyer to repeat the bargaining process.

444. An apparatus as recited by claim 334, wherein the processor comprises means operative with the program for preventing a customer from logging on to the system or bargaining or using an existing account if said customer has been blacklisted, or found to have disobeyed terms and conditions of the system that customer agreed to accept at the time of registration.

445. A system as recited by claim 9, wherein said program is adapted to enable a customer to browse a listing or details concerning available products without registering with the system.

446. A system as recited by claim 15, wherein said program is further configured to permit said customer to bargain for a product or service without using a payment identifier.

447. A system as recited by claim 15, wherein said program is further configured to require submission of a customer's authentication upon acceptance of customer's bargain offer by said system.

448. A system as recited by claim 19, wherein said program is further configured to notify the seller that said purchase offer is accepted and buyer has entered into a legally binding contract with said system.

449. A system as recited by claim 29, configured to communicate with each of buyer and seller and to communicate to each the identity of the other with or without charging a fee.

450. A system as recited by claim 31, further configured to receive a purchase offer that is not coupled or linked to a payment identifier.

451. A system as recited by claim 39, wherein said processor notifies said buyer about the acceptance and holds the product for a predetermined time period without requiring a payment identifier.

452. A system as recited by claim 451, wherein said product is held without guarantee of its availability.

453. A system as recited by claim 39, wherein said product is held without guarantee of its availability.

454. A system as recited by claim 50, wherein said payment mode identifier, though inputted, is not applied to prevent system functions.

455. A system as recited by claim 57, wherein said verification of legitimacy/authenticity/condition of said products and product pricing are not applicable to prevent product sales; products are sold on an “as is” basis; and such sales are consummated by said system without assuming responsibility therefor.

456. A system as recited by claim 58, wherein said appraiser is selected from said list by said buyer or said seller.

457. A system as recited by claim 58, wherein at least one appraiser on said list is nominated by said buyer or said seller.

458. A system as recited by claim 92, wherein said seller is a member selected from the group consisting of manufacturer, retailer, distributor, wholesaler and sole vendor.
